(19) United States
(12) Patent Application Publication
(10) Pub. No.: US 2026/0243898 A1
(43) Pub. Date: Aug. 20, 2026

(54) THREE DIMENSIONAL GENERATIVE PRE-TRAINED TRANSFORMER FOR SUBSURFACE IMAGING AND DISPLAY AND METHODS OF USE

(71) Applicants: Jerry Nims, Sandy Springs, GA (US); William M. Karszes, Hilton Head, SC (US); Samuel Pol, Lawrenceville, GA (US)

(72) Inventors: Jerry Nims, Sandy Springs, GA (US); William M. Karszes, Hilton Head, SC (US); Samuel Pol, Lawrenceville, GA (US)

(21) Appl. No.: 19/564,415

(22) Filed: Mar. 12, 2026

Related U.S. Application Data
(63) Continuation-in-part of application No. 19/545,662, filed on Feb. 20, 2026.
(60) Provisional application No. 63/760,748, filed on Feb. 20, 2025.
(60) Provisional application No. 63/774,423, filed on Mar. 19, 2025.
(60) Provisional application No. 63/817,810, filed on Jun. 4, 2025.
(60) Provisional application No. 63/872,587, filed on Aug. 29, 2025.
(60) Provisional application No. 63/931,953, filed on Dec. 5, 2025.

(51) Int. Cl. G01S 17/87; G01S 7/51; G01S 15/89; G01S 17/894; G06N 3/0455; G06N 3/0475

(52) U.S. Cl. CPC G01S 17/87; G01S 7/51; G01S 15/8993; G01S 17/894; G06N 3/0455; G06N 3/0475

(57) ABSTRACT

A system and method for subsurface imaging and display employ a three-dimensional generative pre-trained transformer to simulate 3D images of environments below a surface, such as internal biology, underground formations (including sink holes), or underwater terrains. The system comprises a processor executing instructions stored in memory, coupled with a subsurface image capture module featuring wave generating devices and sensors affixed to a vehicle. It captures a series of digital image datasets with coordinate reference data, generates a coordinated digital model, determines a depth map, and identifies key subject points. This enables accurate 3D simulation and viewing compatible with the human visual system, mitigating vergence-accommodation conflicts for glasses-free display, while facilitating applications in health diagnostics, geological hazard detection, and environmental monitoring.

### CROSS-REFERENCE TO RELATED APPLICATIONS

To the full extent permitted by law, the present United States Non-Provisional Patent Application claims priority to and the full benefit of, U.S. Provisional Patent Application No. 63/774,423 filed on Mar. 19, 2025 entitled “AI Three Dimensional Generative Pre-trained Transformer for Healthcare Images and Methods of Use”; U.S. Provisional Patent Application No. 63/817,810 filed on Jun. 4, 2025 entitled “AI Three Dimensional Generative Pre-trained Transformer for Sub terrain, Sink Hole Images and Methods of Use”; U.S. Provisional Patent Application No. 63/931,953 filed on Dec. 5, 2025 entitled “AI Three Dimensional Generative Pre-Trained Transformer for Sub Terrain, Sink Hole Images and Methods of Use”; and is a Continuation in Part of U.S. application Ser. No. 19/545,662 filed on Feb. 20, 2026 entitled “Three Dimensional Generative Pre-trained Transformer and Methods of Use”, which claims the full benefit of U.S. Provisional Patent Application No. 63/760,748 filed on Feb. 20, 2025 entitled “AI Three Dimensional Generative Pre-Trained Transformer and Methods of Use” and U.S. Provisional Patent Application No. 63/872,587 filed on Aug. 29, 2025 entitled “AI Three Dimensional Generative Pre-Trained Transformer and Methods of Use”; and is related to U.S. application Ser. No. 19/007,331 filed on Dec. 31, 2024 entitled “SINGLE 2D IMAGE CAPTURE SYSTEM, PROCESSING & DISPLAY OF 3D DIGITAL IMAGE”; U.S. application Ser. No. 18/922,152 filed on Oct. 21, 2024 entitled “SINGLE 2D IMAGE CAPTURE SYSTEM, PROCESSING & DISPLAY OF 3D DIGITAL IMAGE”; U.S. application Ser. No. 18/790,734 filed on Jul. 31, 2024 entitled “SINGLE 2D IMAGE CAPTURE SYSTEM, PROCESSING & DISPLAY OF 3D DIGITAL IMAGE”; U.S. application Ser. No. 19/006,527 filed on Dec. 31, 2024 entitled “SINGLE 2D DIGITAL IMAGE CAPTURE SYSTEM, FRAME SPEED, AND SIMULATING 3D DIGITAL IMAGE SEQUENCE”; U.S. application Ser. No. 18/927,204 filed on Oct. 25, 2024 entitled “2D DIGITAL IMAGE CAPTURE SYSTEM, FRAME SPEED, AND SIMULATING 3D DIGITAL IMAGE SEQUENCE”; U.S. application Ser. No. 18/884,487 filed on Sep. 13, 2024 entitled “2D DIGITAL IMAGE CAPTURE SYSTEM, FRAME SPEED, AND SIMULATING 3D DIGITAL IMAGE SEQUENCE”; U.S. application Ser. No. 18/887,980 filed on Sep. 17, 2024 entitled “SUBSURFACE IMAGING AND DISPLAY OF 3D DIGITAL IMAGE AND 3D IMAGE SEQUENCE”. The foregoing are incorporated herein by reference in their entirety.

### FIELD OF THE DISCLOSURE

The present disclosure is directed to 2D and 3D model image capture from imaging diagnostic tools, simulating display of a 3D or multi-dimensional image sequence, and viewing 3D or multi-dimensional image.

### BACKGROUND

The human visual system (HVS) relies on two dimensional images to interpret three dimensional fields of view. By utilizing the mechanisms with the HIVS we create images/scenes that are compatible with the HVS.

Mismatches between the point at which the eyes must converge and the distance to which they must focus when viewing a 3D image have negative consequences. While 3D imagery has proven popular and useful for movies, digital advertising, many other applications may be utilized if viewers are enabled to view 3D images without wearing specialized glasses or a headset, which is a well-known problem. Misalignment in these systems results in jumping images, out of focus, or fuzzy features when viewing the digital multidimensional images. The viewing of these images can lead to headaches and nausea.

In natural viewing, images arrive at the eyes with varying binocular disparity, so that as viewers look from one point in the visual scene to another, they must adjust their eyes' vergence. The distance at which the lines of sight intersect is the vergence distance. Failure to converge at that distance results in double images. The viewer also adjusts the focal power of the lens in each eye (i.e., accommodates) appropriately for the fixated part of the scene. The distance to which the eye must be focused is the accommodative distance. Failure to accommodate to that distance results in blurred images. Vergence and accommodation responses are coupled in the brain, specifically, changes in vergence drive changes in accommodation and changes in accommodation drive changes in vergence. Such coupling is advantageous in natural viewing because vergence and accommodative distances are nearly always identical.

In 3D images, images have varying binocular disparity thereby stimulating changes in vergence as happens in natural viewing. But the accommodative distance remains fixed at the display distance from the viewer, so the natural correlation between vergence and accommodative distance is disrupted, leading to the so-called vergence-accommodation conflict and mitigating the same. The conflict causes several problems. Firstly, differing disparity and focus information cause perceptual depth distortions. Secondly, viewers experience difficulties in simultaneously fusing and focusing on key subject within the image. Finally, attempting to adjust vergence and accommodation separately causes visual discomfort and fatigue in viewers.

Perception of depth is based on a variety of cues, with binocular disparity and motion parallax generally providing more precise depth information than pictorial cues. Binocular disparity and motion parallax provide two independent quantitative cues for depth perception. Binocular disparity refers to the difference in position between the two retinal image projections of a point in 3D space.

Conventional stereoscopic displays forces viewers to try to decouple these processes, because while they must dynamically vary vergence angle to view objects at different stereoscopic distances, they must keep accommodation at a fixed distance or else the entire display will slip out of focus. This decoupling generates eye fatigue and compromises image quality when viewing such displays.

Recently, a subset of photographers is utilizing 1980s cameras such as NIMSLO and NASHIKA 35 mm analog film cameras or digital camera moved between a plurality of points to take multiple frames of a scene, develop the film of the multiple frames from the analog camera, upload images into image software, such as PHOTOSHOP, and arrange images to create a wiggle gram, moving GIF effect.

X-ray image quality has changed little since Tesla built his x-ray prototype in 1896.

Sink hole monitoring has changed little since development of hydrological and topographical maps and monitoring changes over time.

Monocular Depth Estimation enables the conversion of 2D images into 3D depth maps from a single RGB image, without the need for multiple cameras or specialized equipment like depth sensors. Current image manipulation tools, such as MIDAS estimate the depth of scenes captured in photographs or videos. By analyzing the visual cues within a single image, they attempt to predict how far or close objects are from the camera's viewpoint, creating a grayscale image where pixel intensity corresponds to depth—brighter areas denote objects closer to the camera, and darker areas indicate objects further away. While these tools provides good results, the accuracy can vary based on the complexity of the scene or the quality of the input image.

A disadvantage with conventional image depth tools the objects in a scene may be incorrectly layered front to back when brightness and darkness levels are incorrectly assigned to objects in a scene resulting in inaccurate 3D image generation from depth maps.

A disadvantage with conventional image depth tools is the objects in a scene may be assigned incorrect key subject, foreground, and background cues creating a grayscale image where pixel intensity incorrectly corresponds to depth.

A disadvantage in the domain of computer vision and artificial intelligence, monocular depth estimation involves inferring 3D depth information from a solitary 2D RGB image, circumventing the need for stereo cameras or depth sensors. Conventional methods often exhibit limitations in accuracy due to insufficient training data, inadequate handling of multi-view disparities, or lack of robust loss functions.

Therefore, it is readily apparent that there is a recognizable unmet need for a system having a 2D digital image and 3D model capture system of from subsurface imaging capture tools, image manipulation application, Three Dimensional Generative Pre-trained Transformer to generate ground truth depth map, display of 3D digital image or sequence of images on a display of 3D or digital multi-dimensional image that may be configured to address at least some aspects of the problems discussed above.

### SUMMARY

Briefly described, in an example embodiment, the present disclosure may overcome the above-mentioned disadvantages and may meet the recognized need for an imaging diagnostic tool to capture a plurality of datasets, including layered image information, density of scanned material, substructure, subsurface elements, other characteristics and the like, including a smart device having a memory device for storing an instruction, a processor in communication with the memory and configured to execute the instruction, one or more wave generating devices and one or more sensors, antenna, or capture devices in communication with the processor and each capture device configured to capture its dataset of the layered information, the plurality of wave generating devices and capture devices may be stationary or affixed to the vehicle, the vehicle traverses the terrain or ocean in a designated pattern, processing steps to configure datasets, image manipulation techniques, and a display configured to display a simulated multidimensional digital dataset or image sequence and/or a multidimensional digital dataset or image.

Three Dimensional Generative Pre-trained Transformer and methods of use to provide a secure three-dimensional (3D) imaging system and method utilizing an artificial intelligence (AI) Three Dimensional Generative Pre-trained Transformer (3DGPT) for generating high-accuracy 3D depth maps from single 2D RGB images via monocular depth estimation. The Three Dimensional Generative Pre-trained Transformer trained on proprietary datasets comprising paired RGB images and ground truth depth maps having key subjects, foreground objects, and background elements, true data points the 3DGPT employs an encoder-decoder neural network with optimized loss functions to produce 3D images integrated with Micro Optical Materials (MOMs) featuring lenticular lenses and microstructures for parallax effects. The system may also include a display having Micro Optical Materials (MOMs) featuring lenticular lenses and microstructures for parallax effects formed as a multi-layer display stack with thin-film transistor (TFT) and color filter (CF) components bonded by optically clear adhesives.

It is an object of the disclosure herein to provide high-accuracy monocular depth estimation from a single 2D RGB image, overcoming limitations of existing tools like MIDAS by correctly assigning brightness and darkness levels to objects, thereby preventing incorrect layering in complex scenes and enabling precise 3D image generation.

It is an object of the disclosure herein to leverage proprietary datasets with ground truth images, legacy 3D formats (e.g., Nimslo, Nidek medical), topographical, geological, hydrological, ground penetrating, subsurface data, and synthetic data for training, resulting in robust performance across diverse environments such as security printing, mobile devices, medical imaging, and earth observation.

It is an object of the disclosure herein to enable zero-shot cross-dataset transfer by mixing multiple datasets during training, improving generalization and state-of-the-art results on unseen data, as demonstrated through novel loss functions invariant to depth range, scale, and biases.

Accordingly, a feature of the system and methods of use is its ability to capture a plurality of datasets of an animal or human using image diagnostic tools, such as an magnetic resonance imaging (MRI) uses magnetic fields and radio waves to create detailed images of organs and tissues in the body, x-ray (X-Ray) uses ionizing radiation to produce images of the structures inside the body, such as bones, computerized tomography (CT) and computerized axial tomography (CT/CAT) uses a series of x-rays to create a series of cross-sections of the body including bones, blood vessels, and soft tissue, positron emission tomography (PET) uses radioactive drugs (tracers) and a scanning machine to show your tissues and organs are functioning, bone densitometry (DEXA), Fluoroscopy, ultrasound uses high-frequency sound waves to produce images of organs and substructures within the body, land, ocean and the like.

Accordingly, a feature of the system and methods of use is its ability to capture a plurality of datasets of substructure, mineral, oil, and gas deposits using image diagnostic tools, such as ultrasound uses high-frequency sound waves, seismic waves, ultrasound waves, or radar waves generated by said one or more wave generating devices focused into the subsurface to produce images of substructure, substructure of ocean, underground utilities such as concrete, asphalt, metals, pipes, cables or masonry, mineral, oil, and gas deposits therein and ground-penetrating radar (GPR) that uses radar pulses in the microwave band (UHF/VHF frequencies) of the radio spectrum focused into the subsurface to produce images of substructure, substructure of ocean, underground utilities such as concrete, asphalt, metals, pipes, cables or masonry, mineral, oil, and gas deposits therein.

Accordingly, a feature of the system and methods of use is its ability to capture a plurality of datasets of subsurface using topographical, geological, hydrological, ground penetrating, and subsurface data and images to analyze and predict sink hole identification, monitor changes, and create sink hole prediction models.

Accordingly, a feature of the system and methods of use is its ability to utilize image manipulation techniques to convert input 2D source images into multi-dimensional/multi-spectral image sequence. The output image follows the rule of a “key subject point” maintained within an optimum parallax to maintain a clear and sharp into multi-dimensional/multi-spectral image sequence.

Accordingly, a feature of the system and methods of use is the ability to integrate viewing devices or other viewing functionality into the display, such as barrier screen (black line), lenticular, arced, curved, trapezoid, parabolic, overlays, waveguides, black line and the like with an integrated LCD layer in an LED or OLED, LCD, OLED, and combinations thereof or other viewing devices.

Another feature of the digital multi-dimensional image platform based system and methods of use is the ability to produce digital multi-dimensional images that can be viewed on viewing screens, such as mobile and stationary phones, smart phones (including iPhone), tablets, computers, laptops, monitors and other displays and/or special output devices, directly without 3D glasses or a headset.

A feature of the present invention is the ability to create multidimensional digital images and multidimensional digital image sequences for subsurface or below surface viewing of animals, plants, insects, microorganisms, cells, molecules, sub particles, humans, and the like to produce 3D images of organs and substructures within the body for improved diagnostic, new patient information with added security and encryption capabilities.

A feature of the present invention is the ability to create multidimensional digital images and multidimensional digital image sequences for subsurface or below surface viewing of earth, soil, and oceans to produce images of substructure and subsurface of ocean, underground utilities such as concrete, asphalt, metals, pipes, cables or masonry, mineral, oil, and gas deposits therein and the like.

A feature of the present invention is the ability to create multidimensional digital images and multidimensional digital image sequences for subsurface or below surface viewing of sink holes to analyze and predict sink hole identification, monitor changes, and create sink hole prediction models for insurance liability and accurate property insurance quotes, real estate appraiser, real estate developers, building engineers, general contractors, and the like.

A feature of the present disclosure is the ability to create a 3D model, point cloud, or mesh of the subsurface using layers or slices of the subsurface captured using one or more wave generating devices and one or more sensors, antenna, cameras, or capture devices capturing a subsurface dataset.

A feature of the present disclosure is the ability to generate stereo pairs of images from two viewing points along an arc or line of 3D model of the subsurface for viewing a multidimensional digital image.

A feature of the present disclosure is the ability to generate stereo pairs of images from a single image capture of the subsurface for viewing and generate a multidimensional digital image.

A feature of the present disclosure is the ability to generate a plurality of images from different viewing points along an arc or line of 3D model of the subsurface for viewing a multidimensional digital image sequence.

A feature of the present disclosure is the ability to overcome the above defects via another important parameter to determine the convergence point or key subject point, since the viewing of an image that has not been aligned to a key subject point causes confusion to the human visual system and results in blur and double images.

A feature of the present disclosure is the ability to select the convergence point or key subject point anywhere within an area of interest (AOI) between a closer plane and far or back plane, manual mode user selection.

A feature of the present disclosure is the ability to overcome the above defects via another important parameter to determine Circle of Comfort (CoC), since the viewing of an image that has not been aligned to the Circle of Comfort (CoC) causes confusion to the human visual system and results in blur and double images.

A feature of the present disclosure is the ability to overcome the above defects via another important parameter to determine Circle of Comfort (CoC) fused with Horopter arc or points and Panum area, since the viewing of an image that has not been aligned to the Circle of Comfort (CoC) fused with Horopter arc or points and Panum area causes confusion to the human visual system and results in blur and double images.

A feature of the present disclosure is the ability to overcome the above defects via another important parameter to determine gray scale depth map, the system interpolates intermediate points based on the assigned points (closest point, key subject point, and furthest point) in a subsurface dataset or scene, the system assigns values to those intermediate points and renders the sum to a gray scale depth map, wherein an auto mode key subject point may be selected as a midpoint thereof. The gray scale map to generate volumetric parallax using values assigned to the different points (closest point, key subject point, and furthest point) in a subsurface dataset or scene. This modality also allows volumetric parallax or rounding to be assigned to singular objects within a subsurface dataset or scene.

A feature of the present disclosure is its ability to measure depth or z-axis of objects or elements of objects and/or make comparisons based on known sizes of objects in a subsurface dataset or scene.

A feature of the present disclosure is its ability to utilize a key subject algorithm to manually or automatically select the key subject in a plurality of images of a subsurface dataset or scene displayed on a display and produce multidimensional digital image or multidimensional digital image sequence for viewing on a display.

A feature of the present disclosure is its ability to utilize an image alignment, horizontal image translation, or edit algorithm to manually or automatically horizontally align the plurality of images of a subsurface dataset or scene about a key subject for display.

A feature of the feature of the present disclosure is its ability to utilize an image translation algorithm to align the key subject point of two images or datasets of a subsurface for display.

A feature of the feature of the present disclosure is its ability to generate DIFYS (Differential Image Format) is a specific technique for obtaining multi-view of a subsurface dataset or scene and creating a series of image that creates depth without glasses or any other viewing aides. The system utilizes horizontal image translation along with a form of motion parallax to create 3D viewing. DIFYS are created by having different view of a single subsurface dataset or scene flipped by the observer's eyes. The views are captured by motion of one or more wave generating devices and one or more sensors, antenna, or capture devices capturing a subsurface dataset or scene with each of the devices within the array viewing at a different position.

In accordance with a first aspect of the present disclosure of simulating a 3D image or sequence of image from subsurface dataset, wherein a first proximal plane and a second distal plane is identified within each image frame in the sequence, and wherein each observation point maintains substantially the same first proximal image plane for each image frame; determining a depth estimate for the first proximal and second distal plane within each image frame in the sequence, aligning the first proximal plane of each image frame in the sequence and shifting the second distal plane of each subsequent image frame in the sequence based on the depth estimate of the second distal plane for each image frame, to produce a modified image frame and displaying the modified image frame or displaying sequentially.

The present disclosure varies the focus of objects at different planes in a displayed subsurface dataset or scene to match vergence and stereoscopic retinal disparity demands to better simulate natural viewing conditions. By adjusting the focus of key objects in a subsurface dataset or scene to match their stereoscopic retinal disparity, the cues to ocular accommodation and vergence are brought into agreement. As in natural vision, the viewer brings different objects into focus by shifting accommodation. As the mismatch between accommodation and vergence is decreased, natural viewing conditions are better simulated, and eye fatigue is decreased.

The present disclosure may be utilized to determine three or more planes for each image frame in the sequence.

Furthermore, it is preferred that the planes have different depth estimates.

In addition, it is preferred that each respective plane is shifted based on the difference between the depth estimate of the respective plane and the first proximal plane.

Preferably, the first, proximal plane of each modified image frame is aligned such that the first proximal plane is positioned at the same pixel space.

It is also preferred that the first plane comprises a key subject point.

Preferably, the planes comprise at least one foreground plane.

In addition, it is preferred that the planes comprise at least one background plane.

Preferably, the sequential observation points lie on a straight line.

In accordance with a second aspect of the present invention there is a non-transitory computer readable storage medium storing instructions, the instructions when executed by a processor causing the processor to perform the method according to the second aspect of the present invention.

A feature of the present disclosure is its ability to produce subsurface DIF (Dimensional Image Format) is an image format that allows viewing subsurface imagery sourced from for example DICOM files in 3D or stereoscopic without the need for glasses or headgear. The subsurface DIF presents a structured parallax view of the Z dimension or depth in a subsurface image.

The DIF results in an animated format that can be viewed on the desktops, tablets, laptops and other digital display devices.

A feature of the present disclosure is its ability to produce stereo pairs built in to the output sequence for true 3D using a barrier screen display for example. The approximate 1° separation between frames allows a variety of imaging distances and volumetric sizes to be rendered to stereo pairs. This allows stereo imaging of small areas such as the sinus cavity or cable fiber to larger areas including a full torso scan or oil and gas deposits.

A feature of the present disclosure includes an AI Three Dimensional Generative Pre-trained Transformer (3DGPT) model trained on proprietary datasets comprising paired RGB images and depth maps, featuring distinct elements like Key Subject, Foreground, and Background for accurate 3D reconstruction.

A feature of the present disclosure includes a method for creating the 3DGPT, including steps for data selection (ground truth images), preparation (normalization, augmentation, ETL processes), architecture selection (U-Net or ResNet with attention mechanisms), loss function incorporation, training, evaluation, optimization, and deployment.

A feature of the present disclosure includes a 3D display stack structure comprising: MOM layer with microstructures (e.g., lenticular lenses and diffraction gratings.

A feature of the present disclosure includes a 3D display stack structure comprising: thin-film transistor (TFT) glass layer for pixel control; TFT polarizer for light filtering; color filter (CF) glass layer with RGB sub-pixels; CF polarizer for light modulation; MOM layer with microstructures (e.g., lenticular lenses and diffraction gratings); liquid optically clear adhesive (LOCA) for bonding TFT and CF layers; optically clear adhesive (OCA) for bonding MOM and protective layers; and a protective/display layer for stereoscopic visualization.

A feature of the present disclosure includes an incorporation of advanced neural network components, such as multi-scale supervision and reprojection losses for multi-view consistency, ensuring high-fidelity grayscale depth maps suitable for 3D mesh generation, generative infill, and parallax shifting.

A feature of the present disclosure includes optical calculations for MOM design, including acceptance angle (α), radius of curvature (R≈0.52), refractive index (n′=1.52), thickness (t), height (h), width (w), and focal length (f), to manipulate light for enhanced 3D effects and security.

A feature of the present disclosure includes system compatibility with stereoscopic-enabled tablets or digital displays, enabling output of AI-generated 3D images with embedded security patterns for applications in 3D reconstruction, augmented reality, autonomous navigation, visual effects in film, object detection and segmentation, and anti-counterfeit products.

A feature of the present disclosure includes a data pipeline for handling structured and unstructured sources (e.g., databases, APIs, cloud storage), with preprocessing techniques like scaling, cropping, flipping, and color jittering to maintain dataset consistency.

A feature of the present disclosure includes an artificial intelligence system with a processor and memory storing the proprietary dataset, configured to receive a single RGB image, apply an encoder-decoder network to extract depth cues, and output a 3D image with parallax shift and security embeddings.

A feature of the present disclosure includes MOM material Features: selecting a substrate with predetermined optical properties, patterning said substrate with microstructures configured to manipulate light in a unique manner, desired optical effects like diffraction, refraction, or reflection, arranged in a pattern that is non-repeating or pseudo-random to enhance security.

A feature of the present disclosure includes MOM material Features: integrating a security feature into MOM by: embedding covert markers or overt visual cues within the 3D image, such as: micro-text or nano-text visible only under specific lighting conditions; color-shift effects that are verifiable through specialized viewing devices; encoding data within the microstructure patterns of the MOM, where: the encoded data could include serial numbers, timestamps, or unique identifiers; the data is retrievable only with proprietary decoding methods or under specific illumination; (d) fabricating the MOM with the integrated security features by: using lithography or another high-precision manufacturing technique to apply the designed microstructures to the substrate; aligning the fabricated MOM with the 3D image to ensure the security features are correctly displayed or concealed; wherein the method provides a novel security-enhanced MOM and 3D image system, characterized by its use of AI for 3D image generation tailored to the specific optical characteristics of the MOM, thereby creating a product with high security integrity and visual complexity that is difficult to counterfeit.

A feature of the present disclosure is to predict and map sinkhole susceptibility using multimodal geospatial AI, convert hazard fields into volumetric 3D risk visualizations with uncertainty overlays, predict subsurface cavity growth and collapse probability forecast, translate sinkhole hazards into infrastructure vulnerability assessments with 3D corridor visualization, 3D sinkhole detection & risk mapping for planners and engineers.

A feature of the present disclosure includes a computational engine for a sinkhole inspection platform having probability distributions for collapse events and to deliver a parametric insurance risk-intelligence platform or model to enable sink hole insurance based on actual governing dynamics of topological and subterrain reconstruction, void pathways, government data, and load-bearing structure instead of historical data to automate insurance underwriting and payouts without subjective loss.

A feature of the present disclosure includes sinkhole data, including but not limited to: (a) Satellite imagery and remote sensing data, including optical, radar, and multispectral data used for terrain analysis; (b) Ground penetrating radar (GPR) data, including subsurface imaging and profiling results; (c) LiDAR (Light Detection and Ranging) data, including point clouds, digital elevation models (DEMs), and surface topography scans, LiDAR/DEM derivatives, remote sensing, spatial transformers; (d) Topographical data, including maps, surveys, and elevation datasets; (e) Hydrological data, including groundwater flow models, aquifer mappings, water table measurements, groundwater-Karst Dynamics, and related hydrogeological analyses; (f) Statewide sinkhole susceptibility maps, USGS, USACE, and NOAA and the like and translate outputs into TreisD 3D hazard products using glasses-free 3D telepresence viewer, and collapse forecasts.

In an exemplary embodiment a system for subsurface imaging and display of a subsurface below a surface, having a memory device storing instructions, a processor in communication with the memory device, the processor configured to execute the instructions, a subsurface image capture module in communication with the processor, the subsurface image capture module having one or more wave generating devices and one or more sensors affixed to a vehicle, configured to capture a series of digital image datasets of the subsurface below the surface, each the digital image dataset including coordinate reference data, and a Three Dimensional Generative Pre-trained Transformer (3DGPT) model configured to receive a single two-dimensional (2D) RGB image from the series of digital image datasets and generate a 3D depth map via monocular depth estimation, wherein the 3DGPT model comprises an encoder-decoder neural network trained on proprietary datasets including paired RGB images and ground truth depth maps with at least one of a key subject, a foreground, and a background element, wherein the processor executes instructions to generate a digital model of the series of digital image datasets while maintaining the coordinate reference data, determine the 3D depth map of the digital model using the 3DGPT model, and identify a key subject point in the digital model, wherein the digital image datasets are selected from the group consisting of satellite, ground penetrating radar, LIDAR, topographical, hydrological, sinkhole susceptibility maps, USGS, USACE, and NOAA data and combinations thereof.

In another exemplary embodiment of a method for subsurface imaging and display of a subsurface below a surface, having capturing, via a subsurface image capture module affixed to a vehicle and including one or more wave generating devices and one or more sensors, a series of digital image datasets of the subsurface below the surface, each the digital image dataset including coordinate reference data, receiving, by a Three Dimensional Generative Pre-trained Transformer (3DGPT) model, a single two-dimensional (2D) RGB image from the series of digital image datasets generating, by the 3DGPT model via monocular depth estimation, a 3D depth map, wherein the 3DGPT model comprises an encoder-decoder neural network trained on proprietary datasets including paired RGB images and ground truth depth maps with at least one of a key subject, a foreground, and a background element, generating a digital model of the series of digital image datasets while maintaining the coordinate reference data, determining the 3D depth map of the digital model using the 3DGPT model, and identifying a key subject point in the digital model, wherein the digital image datasets are selected from the group consisting of satellite, ground penetrating radar, LIDAR, topographical, hydrological, sinkhole susceptibility maps, USGS, USACE, and NOAA data and combinations thereof.

These and other features of the smart device having one or more wave generating devices and one or more sensors, antenna, or capture devices, image manipulation application, & display of simulated 3D digital image sequence or 3D image will become more apparent to one skilled in the art from the prior Summary and following Brief Description of the Drawings, Detailed Description of exemplary embodiments thereof, and claims when read in light of the accompanying Drawings or Figures.

### BRIEF DESCRIPTION OF THE DRAWINGS

The present disclosure will be better understood by reading the Detailed Description of the Preferred and Selected Alternate Embodiments with reference to the accompanying drawing Figures, in which like reference numerals denote similar structure and refer to like elements throughout, and in which:

FIG. 1A illustrates a 2D rendering of an image based upon a change in orientation of an observer relative to a display;

FIG. 1B illustrates a 2D rendering of an image with binocular disparity as a result of the horizontal separation parallax of the left and right eyes;

FIG. 2A is an illustration of a cross-section view of the structure of the human eyeball;

FIG. 2B is a graph relating density of rods and cones to the position of the fovea;

FIG. 3 is a top view illustration of an observer's field of view;

FIG. 4A1 is a diagram identifying exemplary human body innards lying beneath the subsurface of the skin;

FIG. 4A2 is a diagram identifying an image slice of an exemplary human body innards lying beneath the subsurface of the skin;

FIG. 4A3 is a diagram identifying an exemplary reconstruction of the image slices into a model or mesh of an exemplary human body innards lying beneath the subsurface of the skin;

FIG. 4A4 is a diagram identifying an ultrasound image of a preborn baby in utero;

FIG. 4B is a diagram identifying radio wave or sound wave image of subsurface of the ground;

FIG. 4C is a diagram identifying sonar, sound, or ultrasound wave of an exemplary image of terrain of the subsurface of a water area;

FIG. 5 is a top view illustration identifying planes of a scene and a circle of comfort in scale with FIG. 4;

FIG. 6 is a block diagram of a computer system of the present disclosure;

FIG. 7 is a block diagram of a communications system implemented by the computer system in FIG. 6;

FIG. 8A is a diagram of an exemplary embodiment of one or more wave generating devices and one or more sensors, antenna, camera, or capture devices to capture image, file, dataset of human body innards;

FIG. 8B is a diagram of an exemplary embodiment of a ground traversing vehicle with one or more wave generating devices and one or more sensors, antenna, camera, or capture devices positioned thereon to capture image, file, dataset of sub terrain or subsurface of scene;

FIG. 8C1 is a diagram of an exemplary embodiment of a ground vehicle-automobile with capture device(s) positioned thereon, one or more wave generating devices and one or more sensors, antenna, camera, or capture devices positioned thereon to capture image, file, dataset of sub terrain or subsurface of scene;

FIG. 8C2 is a diagram of an exemplary embodiment of a cavern navigation device or rover with capture device(s) positioned thereon, one or more wave generating devices and one or more sensors, antenna, camera, or capture devices positioned thereon to capture image, file, dataset of sub terrain or subterrain scene;

FIG. 8C3 is a diagram of an exemplary embodiment of a cavern recorder or monitor device with capture device(s) positioned thereon, one or more wave generating devices and one or more sensors, antenna, camera, or capture devices positioned thereon to tether therein and capture image, file, dataset of sub terrain or subterrain scene;

FIG. 8D1 is an exemplary embodiment of a flow diagram of a method of capturing and modifying capture image, file, dataset of terrain of scene for viewing as a multidimensional image(s) sequence and/or multidimensional image(s) utilizing capture devices shown in FIGS. 8A-8C;

FIG. 8D2 is a chart of an exemplary embodiment of recommended intervals between frames for different body parts;

FIG. 8D3 is a diagram of an exemplary embodiment of recommended intervals between frames for different body parts;

FIG. 9 is a diagram of an exemplary embodiment of human eye spacing the intraocular or interpupillary distance width, the distance between an average human's pupils;

FIG. 10 is a top view illustration identifying planes of a scene and a circle of comfort in scale with right triangles defining positioning of capture devices on lens plane;

FIG. 10A is a top view illustration of an exemplary embodiment identifying right triangles to calculate the radius of the Circle of Comfort of FIG. 10;

FIG. 10B is a top view illustration of an exemplary embodiment identifying right triangles to calculate linear positioning of capture devices on lens plane of FIG. 10;

FIG. 10C is a top view illustration of an exemplary embodiment identifying right triangles to calculate the optimum distance of backplane of FIG. 10;

FIG. 11 is a diagram illustration of an exemplary embodiment of a geometrical shift of a point between two images (frames), such as in FIG. 11A according to select embodiments of the instant disclosure;

FIG. 11A is a front top view illustration of an exemplary embodiment of four images of a scene captured utilizing capture devices shown in FIGS. 8A-8D and aligned about a key subject point;

FIG. 11B is a front view illustration of an exemplary embodiment of four images of a scene captured utilizing capture devices shown in FIGS. 8A-8D and aligned about a key subject point;

FIG. 12 is an exemplary embodiment of a flow diagram of a method of generating a multidimensional image(s)/sequence captured utilizing capture devices shown in FIGS. 8A-8C;

FIG. 12A is block diagram of an exemplary embodiment of a Large Vision Model (LVM) AI Three Dimensional Generative Pre-trained Transformer according to select embodiments of the disclosure;

FIG. 12B is flowchart diagram of an exemplary embodiment of steps of generating a Large Vision Model (LVM) AI Three Dimensional Generative Pre-trained according to select embodiments of the disclosure;

FIG. 12C is a picture of a Scene with various gray scale depth maps of the Scene according to select embodiments of the disclosure;

FIG. 13A is a top view illustration of an exemplary embodiment of a display with user interactive content to select photography options of computer system;

FIG. 13B is a front view of a single camera device to capture a single RGB image, according to select embodiments of the disclosure;

FIG. 14A is a top view illustration identifying two frames captured utilizing capture devices shown in FIGS. 8A-8D showing key subject aligned as shown in FIG. 11B and near plane object offset between two frames;

FIG. 14B is a top view illustration of an exemplary embodiment of left and right eye virtual depth via object offset between two frames of FIG. 14A;

FIG. 15A1 is a cross-section diagram of an exemplary embodiment of a display stack according to select embodiments of the instant disclosure;

FIG. 15A2 is an alternative cross-section diagram of an exemplary embodiment of a display stack according to select embodiments of the instant disclosure;

FIG. 15B is a cross-section diagram of an exemplary embodiment of an arced or curved shaped lens according to select embodiments of the instant disclosure, tracing RGB light there through;

FIG. 15C is a cross-section diagram of a prototype embodiment of a trapezoid shaped lens according to select embodiments of the instant disclosure, tracing RGB light there through;

FIG. 15D is a cross-section diagram of an exemplary embodiment of a dome shaped lens according to select embodiments of the instant disclosure, tracing RGB light there through;

FIG. 15E is a cross-sectional view of a lenticular lens profile, according to select embodiments of the disclosure;

FIG. 16A is a diagram illustration of an exemplary embodiment of a pixel interphase processing of images (frames), such as in FIG. 8A according to select embodiments of the instant disclosure;

FIG. 16B is a top view illustration of an exemplary embodiment of a display of computer system running an application; and

FIG. 17 is a top view illustration of an exemplary embodiment of viewing a multidimensional digital image on display with the image within the Circle of Comfort, proximate Horopter arc or points, within Panum area, and viewed from viewing distance.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

In describing the exemplary embodiments of the present disclosure, as illustrated in figures specific terminology is employed for the sake of clarity. The present disclosure, however, is not intended to be limited to the specific terminology so selected, and it is to be understood that each specific element includes all technical equivalents that operate in a similar manner to accomplish similar functions. The claimed invention may, however, be embodied in many different forms and should not be construed to be limited to the embodiments set forth herein. The examples set forth herein are non-limiting examples and are merely examples among other possible examples.

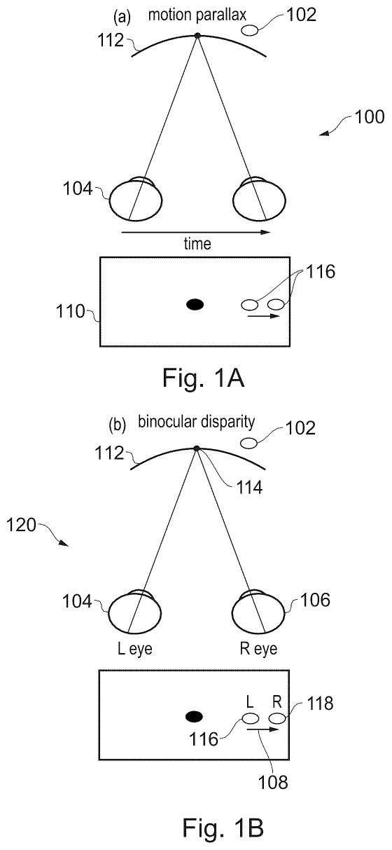

Perception of depth is based on a variety of cues, with binocular disparity and motion parallax generally providing more precise depth information than pictorial cues. Binocular disparity and motion parallax provide two independent quantitative cues for depth perception. Binocular disparity refers to the difference in position between the two retinal image projections of a point in 3D space. As illustrated in FIGS. 1A and 1, the robust precepts of depth that are obtained when viewing an object 102 in an image scene 110 demonstrates that the brain can compute depth from binocular disparity cues alone. In binocular vision, the Horopter 112 is the locus of points in space that have the same disparity as the fixation point 114. Objects lying on a horizontal line passing through the fixation point 114 results in a single image, while objects a reasonable distance from this line result in two images 116, 118.

Classical motion parallax is dependent upon two eye functions. One is the tracking of the eye to the motion (eyeball moves to fix motion on a single spot) and the second is smooth motion difference leading to parallax or binocular disparity. Classical motion parallax is when the observer is stationary and the scene around the observer is translating or the opposite where the scene is stationary, and the observer translates across the scene.

By using two images 116, 118 of the same object 102 obtained from slightly different angles, it is possible to triangulate the distance to the object 102 with a high degree of accuracy. Each eye views a slightly different angle of the object 102 seen by the left eye 104 and right eye 106. This happens because of the horizontal separation parallax of the eyes. If an object is far away, the disparity 108 of that image 110 falling on both retinas will be small. If the object is close or near, the disparity 108 of that image 110 falling on both retinas will be large.

Motion parallax 120 refers to the relative image motion (between objects at different depths) that results from translation of the observer 104. Isolated from binocular and pictorial depth cues, motion parallax 120 can also provide precise depth perception, provided that it is accompanied by ancillary signals that specify the change in eye orientation relative to the visual scene 110. As illustrated, as eye orientation 104 changes, the apparent relative motion of the object 102 against a background gives hints about its relative distance. If the object 102 is far away, the object 102 appears stationary. If the object 102 is close or near, the object 102 appears to move more quickly.

In order to see the object 102 in close proximity and fuse the image on both retinas into one object, the optical axes of both eyes 104, 106 converge on the object 102. The muscular action changing the focal length of the eye lens so as to place a focused image on the fovea of the retina is called accommodation. Both the muscular action and the lack of focus of adjacent depths provide additional information to the brain that can be used to sense depth. Image sharpness is an ambiguous depth cue. However, by changing the focused plane (looking closer and/or further than the object 102), the ambiguities are resolved.

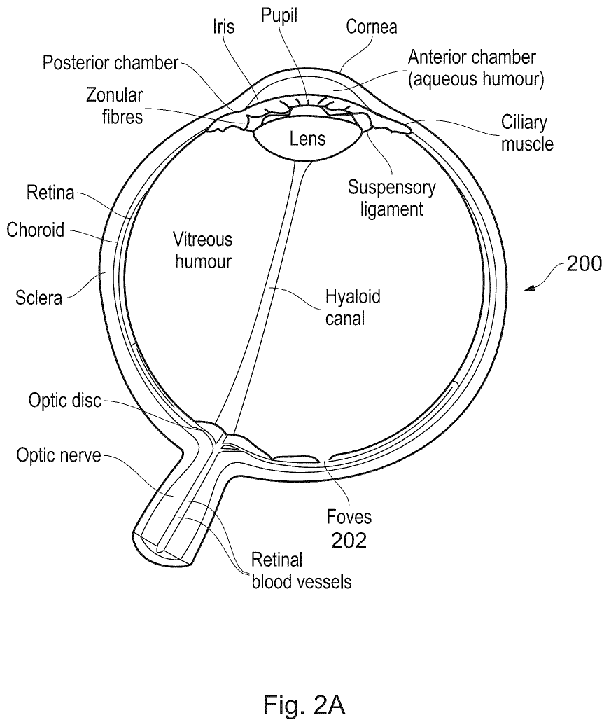

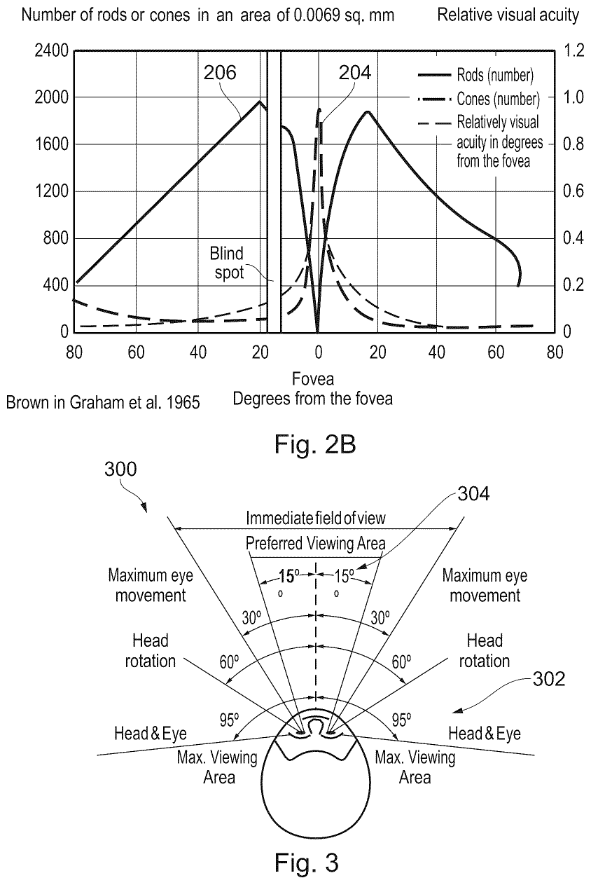

FIGS. 2A and 2B show the anatomy of the eye 200 and a graphical representation of the distribution of rods and cones, respectively. The fovea 202 is responsible for sharp central vision (also referred to as foveal vision), which is necessary where visual detail is of primary importance. The fovea 202 is the depression in the inner retinal surface 205, about 1.5 mm wide and is made up entirely of cones 204 specialized for maximum visual acuity. Rods 206 are low intensity receptors that receive information in grey scale and are important to peripheral vision, while cones 204 are high intensity receptors that receive information in color vision. The importance of the fovea 202 will be understood more clearly with reference to FIG. 2B, which shows the distribution of cones 204 and rods 206 in the eye 200. As shown, a large proportion of cones 204, providing the highest visual acuity, lie within a 1.5° angle around the center of the fovea 202.

The importance of the fovea 202 will be understood more clearly with reference to FIG. 2B, which shows the distribution of cones 204 and rods 206 in the eye 200. As shown, a large proportion of cones 204, providing the highest visual acuity, lie within a 1.5° angle around the center of the fovea 202.

FIG. 3 illustrates a typical field of view 300 of the human visual system (HVS). As shown, the fovea 202 sees only the central 1.5° (degrees) of the visual field 302, with the preferred field of view 304 lying within ±15° (degrees) of the center of the fovea 202. Focusing an object on the fovea, therefore, depends on the linear size of the object 102, the viewing angle and the viewing distance. A large object 102 viewed in close proximity will have a large viewing angle falling outside the foveal vision, while a small object 102 viewed at a distance will have a small viewing angle falling within the foveal vision. An object 102 that falls within the foveal vision will be produced in the mind's eye with high visual acuity. However, under natural viewing conditions, viewers do not just passively perceive. Instead, they dynamically scan the visual scene 110 by shifting their eye fixation and focus between objects at different viewing distances. In doing so, the oculomotor processes of accommodation and vergence (the angle between lines of sight of the left eye 104 and right eye 106) must be shifted synchronously to place new objects in sharp focus in the center of each retina. Accordingly, nature has reflexively linked accommodation and vergence, such that a change in one process automatically drives a matching change in the other.

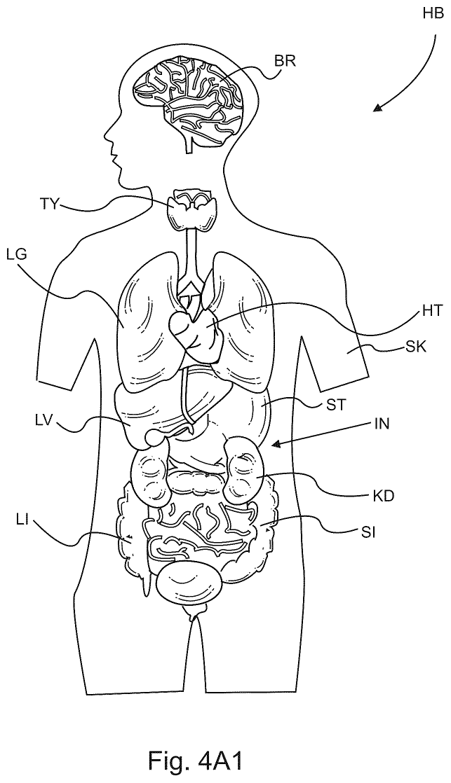

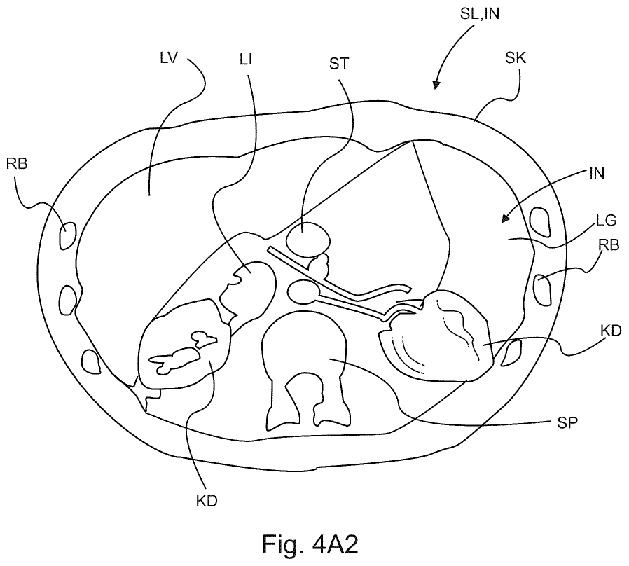

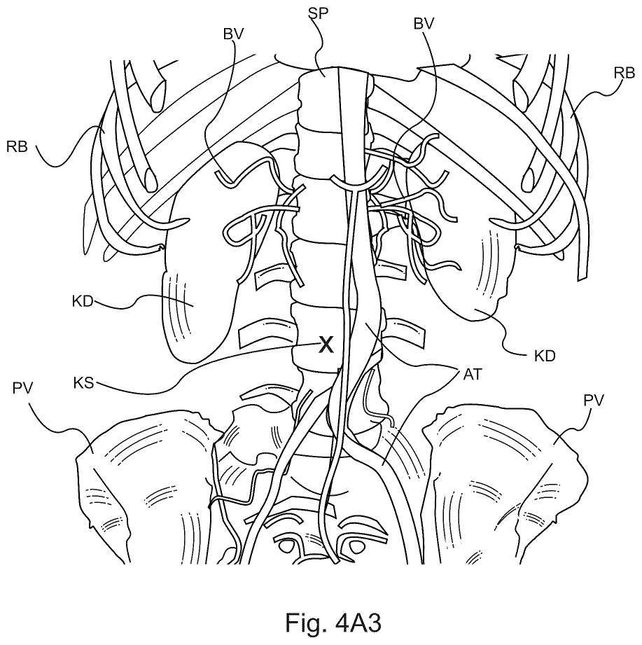

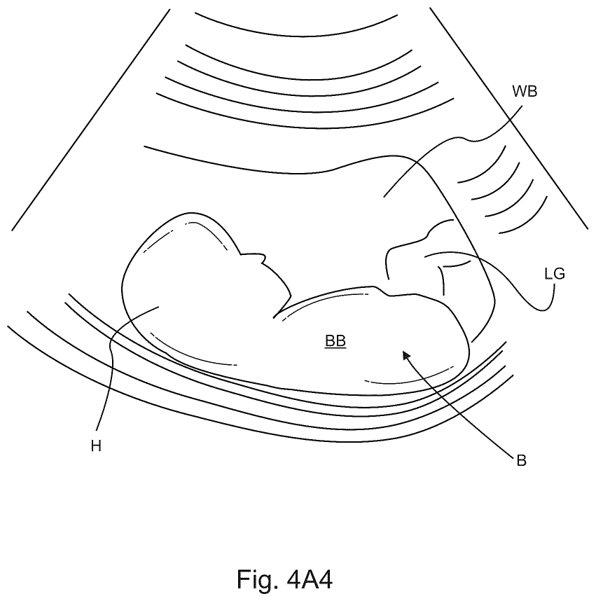

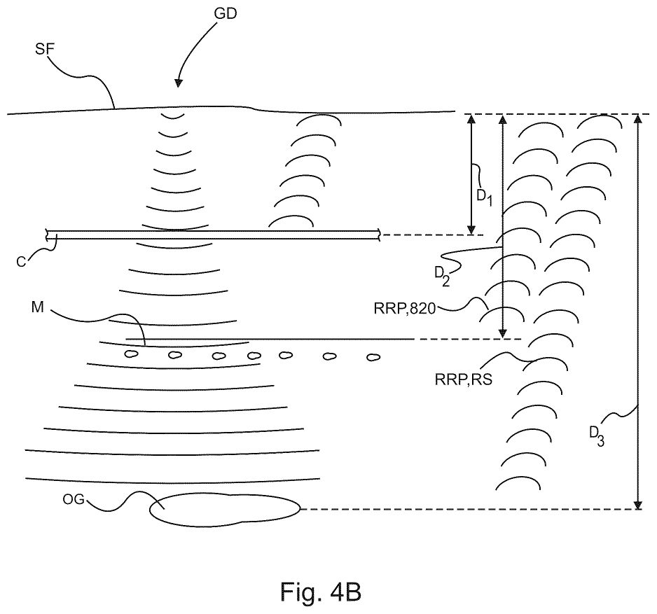

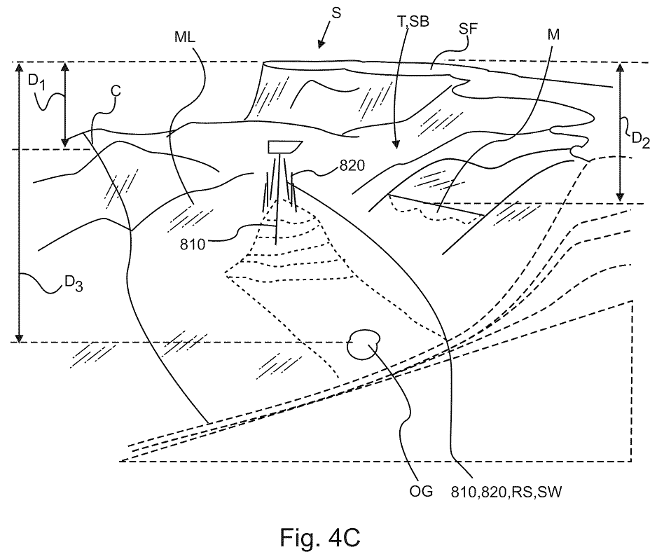

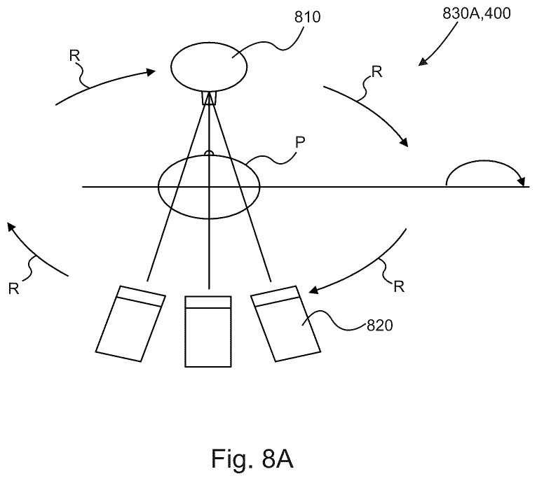

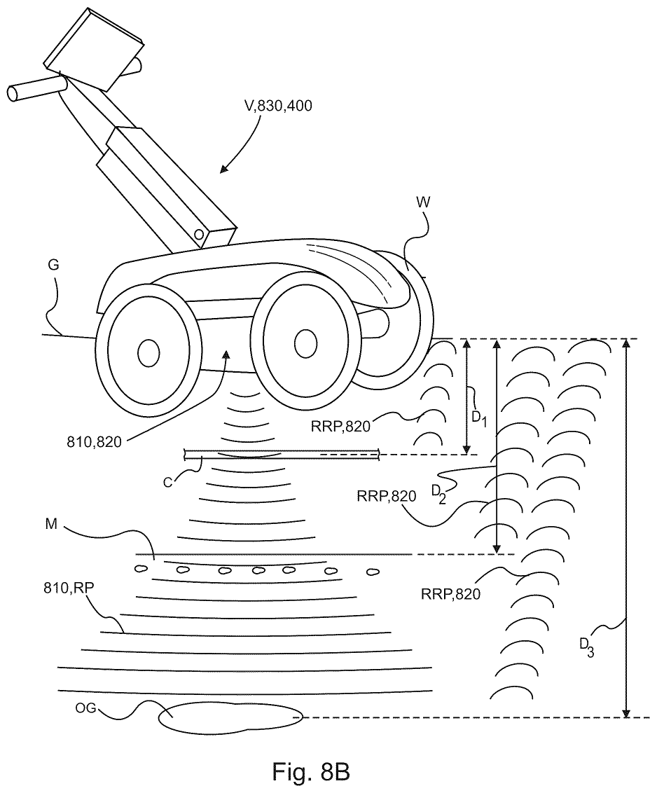

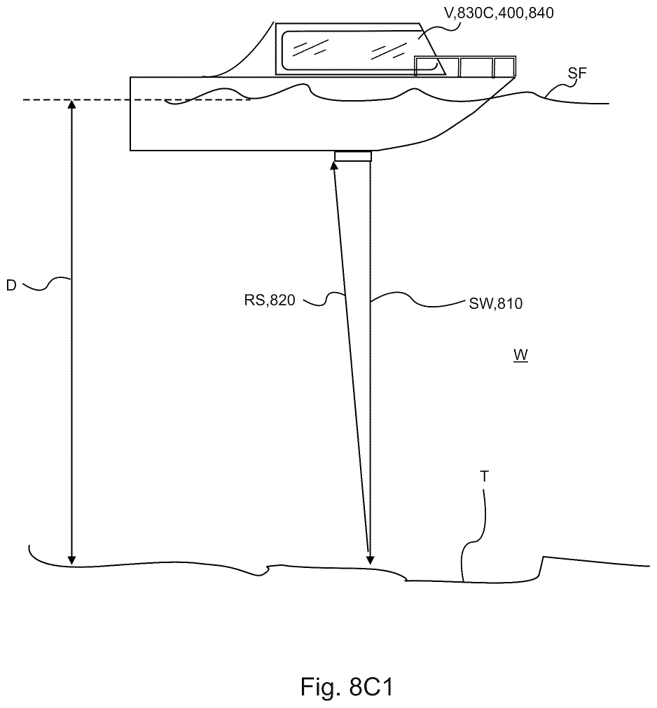

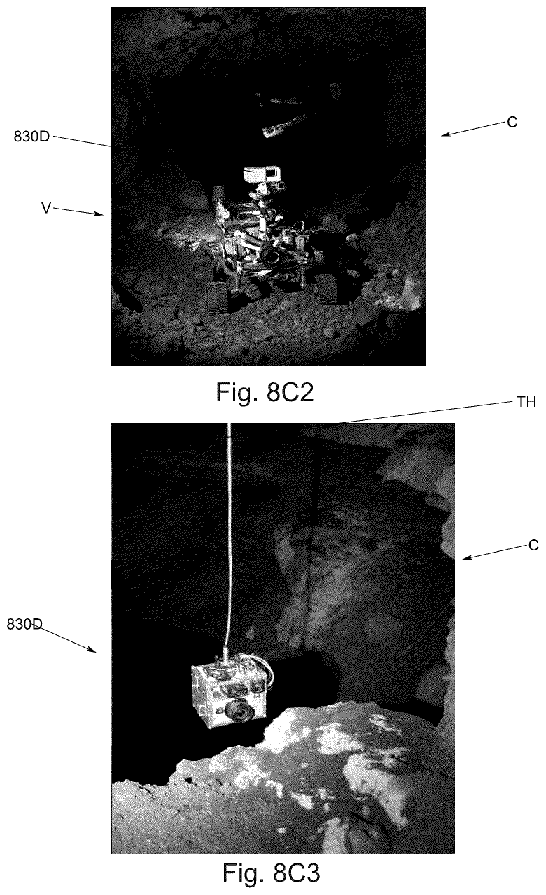

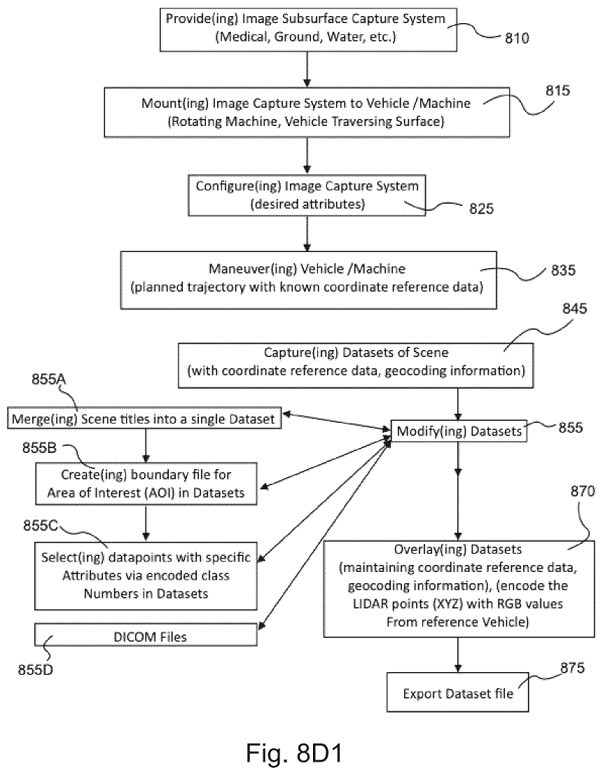

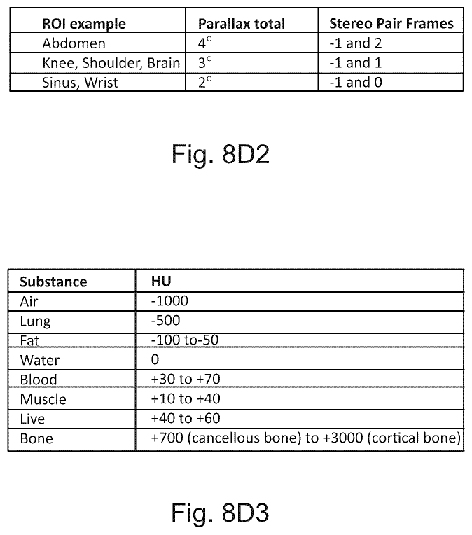

FIGS. 4A1 (human), 4A2 (slice SL) and 4A3 (model MD) illustrates a representative view of a subsurface SB image dataset, slice and model (series of slices) or diagram identifying human body HB innards IN lying beneath the subsurface of the skin SK, a diagram identifying an image slice SL of human body HB innards IN lying beneath the subsurface of the skin, and a diagram identifying a reconstruction of the image slices into a model or mesh MD of human body HB innards IN lying beneath the subsurface of the skin SK to be captured by capture device(s), such as capture module 830A in FIG. 8A. Human body HB innards IN lying beneath the subsurface of the skin SK may include but not limited to body B, head H, organs, such as brain BR, Thyroid TY, lung LG, heart HT, skin SK (outer covering or surface), liver LV, stomach ST, kidney KD, large intestine LI, small intestine SI, spine SP, bone (pelvis PV), artery AT, blood vessels BV, muscle, tendon, and other human body parts (subsurface or internal biology).

It is contemplated herein that Key Subject KS on a z-axis depth between near plane NP and far plane FP as set forth herein may be utilized or selected from any of the points, parts or elements in the paragraph above, such as internal biology.

FIG. 4A4 illustrates a representative view of a subsurface SB image dataset or diagram identifying an ultrasound image of a preborn baby BB in mother's womb WB showing head H, limbs, such as leg LG (internal biology).

It is contemplated herein that Key Subject KS on a z-axis depth between near plane NP and far plane FP as set forth herein may be utilized or selected from any of the points, parts or elements in the paragraph above, such as internal biology.

FIG. 4B illustrates a representative view of a diagram identifying subsurface SB image dataset or diagram identifying below ground or beneath the surface SF of the ground GD such as the depth location and subsurface SB coordinates of for example cable C, mineral M, oil and gas OG deposits beneath the surface SF (points beneath the surface of the ground).

It is contemplated herein that Key Subject KS on a z-axis depth between near plane NP and far plane FP as set forth herein may be utilized or selected from any of the points, parts or elements in the paragraph above, such as points beneath the surface of the ground GD.

It is contemplated herein that ground may be other than the earth or soil, such as buildings and other structures, piles or containers of material or crops or batches and the like.

FIG. 4C illustrates a representative view of a diagram identifying subsurface SB image dataset or diagram identifying underwater or beneath the surface SF of the water such as the depth D location and surface coordinates terrain T of scene S for example cable C, marine life ML, mineral M, oil and gas OG deposits beneath the surface SF.

It is contemplated herein that Key Subject KS on a z-axis depth between near plane NP and far plane FP as set forth herein may be utilized or selected from any of the points, parts or elements in the paragraph above, such as points beneath the surface SF of water W.

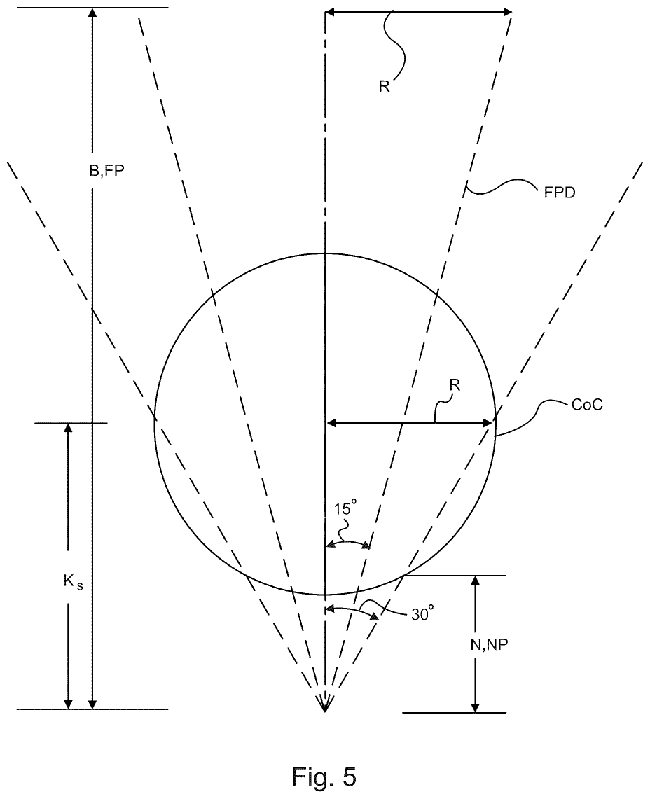

FIG. 5 illustrates a Circle of Comfort (CoC) in scale with FIGS. 4.1 and 3.1. Defining the Circle of Comfort (CoC) as the circle formed by passing the diameter of the circle along the perpendicular to Key Subject plane KSP (in scale with FIG. 4) with a width determined by the 30 degree radials of FIG. 3) from the center point on the lens plane, image capture module 830. (R is the radius of Circle of Comfort (CoC).)

Conventional stereoscopic displays forces viewers to try to decouple these processes, because while they must dynamically vary vergence angle to view objects at different stereoscopic distances, they must keep accommodation at a fixed distance or else the entire display will slip out of focus. This decoupling generates eye fatigue and compromises image quality when viewing such displays.

In order to understand the present disclosure certain variables, need to be defined. The object field is the entire image being composed. The “key subject point” is defined as the point where the scene converges, i.e., the point in the depth of field that always remains in focus and has no parallax differential in the key subject point. The foreground and background points are the closest point and furthest point from the viewer, respectively. The depth of field is the depth or distance created within the object field (depicted distance from foreground to background). The principal axis is the line perpendicular to the scene passing through the key subject point. The parallax or binocular disparity is the difference in the position of any point in the first and last image after the key subject alignment. In digital composition, the key subject point displacement from the principal axis between frames is always maintained as a whole integer number of pixels from the principal axis. The total parallax is the summation of the absolute value of the displacement of the key subject point from the principal axis in the closest frame and the absolute value of the displacement of the key subject point from the principal axis in the furthest frame.

When capturing images herein, applicant refers to depth of field or circle of confusion and circle of comfort is referred to when viewing image on the viewing device.

U.S. Pat. Nos. 9,992,473, 10,033,990, and 10,178,247 are incorporated herein by reference in their entirety.

Creating depth perception using motion parallax is known. However, in order to maximize depth while maintaining a pleasing viewing experience, a systematic approach is introduced. The system combines factors of the human visual system with image capture procedures to produce a realistic depth experience on any 2D viewing device.

The technique introduces the Circle of Comfort (CoC) that prescribe the location of the image capture system relative to the scene S. The Circle of Comfort (CoC) relative to the Key Subject KS (point of convergence, focal point) sets the optimum near plane NP and far plane FP, i.e., controls the parallax of the scene S.

The system was developed so any capture device such as iPhone, camera or video camera can be used to capture the scene. Similarly, the captured images can be combined and viewed on any digital output device such as smart phone, tablet, monitor, TV, laptop, computer screen, or other like displays.

As will be appreciated by one of skill in the art, the present disclosure may be embodied as a method, data processing system, or computer program product. Accordingly, the present disclosure may take the form of an entirely hardware embodiment, entirely software embodiment or an embodiment combining software and hardware aspects. Furthermore, the present disclosure may take the form of a computer program product on a computer-readable storage medium having computer-readable program code means embodied in the medium. Any suitable computer readable medium may be utilized, including hard disks, ROM, RAM, CD-ROMs, electrical, optical, magnetic storage devices and the like.

The present disclosure is described below with reference to flowchart illustrations of methods, apparatus (systems) and computer program products according to embodiments of the present disclosure. It will be understood that each block or step of the flowchart illustrations, and combinations of blocks or steps in the flowchart illustrations, can be implemented by computer program instructions or operations. These computer program instructions or operations may be loaded onto a general purpose computer, special purpose computer, or other programmable data processing apparatus to produce a machine, such that the instructions or operations, which execute on the computer or other programmable data processing apparatus, create means for implementing the functions specified in the flowchart block or blocks/step or steps.

These computer program instructions or operations may also be stored in a computer-usable memory that can direct a computer or other programmable data processing apparatus to function in a particular manner, such that the instructions or operations stored in the computer-usable memory produce an article of manufacture including instruction means which implement the function specified in the flowchart block or blocks/step or steps. The computer program instructions or operations may also be loaded onto a computer or other programmable data processing apparatus (processor) to cause a series of operational steps to be performed on the computer or other programmable apparatus (processor) to produce a computer implemented process such that the instructions or operations which execute on the computer or other programmable apparatus (processor) provide steps for implementing the functions specified in the flowchart block or blocks/step or steps.

Accordingly, blocks or steps of the flowchart illustrations support combinations of means for performing the specified functions, combinations of steps for performing the specified functions, and program instruction means for performing the specified functions. It should also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions or operations.

Computer programming for implementing the present disclosure may be written in various programming languages, database languages, and the like. However, it is understood that other source or object oriented programming languages, and other conventional programming language may be utilized without departing from the spirit and intent of the present disclosure.

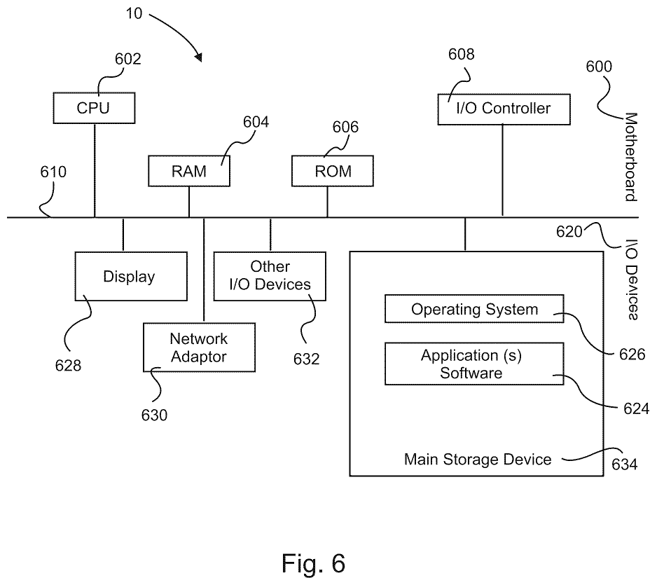

Referring now to FIG. 6, there is illustrated a block diagram of a computer system 10 that provides a suitable environment for implementing embodiments of the present disclosure. The computer architecture shown in FIG. 6 is divided into two parts—motherboard 600 and the input/output (I/O) devices 620. Motherboard 600 preferably includes subsystems or processor to execute instructions such as central processing unit (CPU) 602, a memory device, such as random access memory (RAM) 604 for storing instructions, input/output (I/O) controller 608, and a memory device such as read-only memory (ROM) 606, also known as firmware, which are interconnected by bus 10. A basic input output system (BIOS) containing the basic routines that help to transfer information between elements within the subsystems of the computer is preferably stored in ROM 606, or operably disposed in RAM 604. Computer system 10 further preferably includes I/O devices 620, such as main storage device 634 for storing operating system 626 and executes as instruction via application program(s) 624, and display 628 for visual output, and other I/O devices 632 as appropriate. Main storage device 634 preferably is connected to CPU 602 through a main storage controller (represented as 608) connected to bus 610. Network adapter 630 allows the computer system to send and receive data through communication devices or any other network adapter capable of transmitting and receiving data over a communications link that is either a wired, optical, or wireless data pathway. It is recognized herein that central processing unit (CPU) 602 performs instructions, operations or commands stored in ROM 606 or RAM 604.

It is contemplated herein that computer system 10 may include smart devices, such as smart phone, iPhone, android phone (Google, Samsung, or other manufactures), tablets, desktops, laptops, digital image capture devices, and other computing devices with two or more digital image capture devices and/or 3D display 608 (smart device).

It is further contemplated herein that display 608 may be configured as a foldable display or multi-foldable display capable of unfolding into a larger display surface area.

Many other devices or subsystems or other I/O devices 632 may be connected in a similar manner, including but not limited to, devices such as microphone, speakers, flash drive, CD-ROM player, DVD player, printer, main storage device 634, such as hard drive, and/or modem each connected via an I/O adapter. Also, although preferred, it is not necessary for all of the devices shown in FIG. 6 to be present to practice the present disclosure, as discussed below. Furthermore, the devices and subsystems may be interconnected in different configurations from that shown in FIG. 6, or may be based on optical or gate arrays, or some combination of these elements that is capable of responding to and executing instructions or operations. The operation of a computer system such as that shown in FIG. 6 is readily known in the art and is not discussed in further detail in this application, so as not to overcomplicate the present discussion.

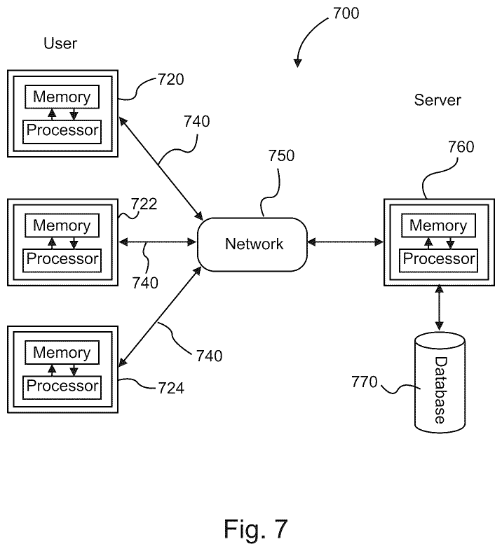

Referring now to FIG. 7, there is illustrated a diagram depicting an exemplary communication system 700 in which concepts consistent with the present disclosure may be implemented. Examples of each element within the communication system 700 of FIG. 7 are broadly described above with respect to FIG. 6. In particular, the server system 760 and user system 720 have attributes similar to computer system 10 of FIG. 6 and illustrate one possible implementation of computer system 10. Communication system 700 preferably includes one or more user systems 720, 722, 724 (It is contemplated herein that computer system 10 may include smart devices, such as smart phone, iPhone, android phone (Google, Samsung, or other manufactures), tablets, desktops, laptops, cameras, and other computing devices with display 628 (smart device)), one or more server system 760, and network 750, which could be, for example, the Internet, public network, private network or cloud. User systems 720-724 each preferably includes a computer-readable medium, such as random access memory, coupled to a processor. The processor, CPU 702, executes program instructions or operations (application software 624) stored in memory 604, 606. Communication system 700 typically includes one or more user system 720. For example, user system 720 may include one or more general-purpose computers (e.g., personal computers), one or more special purpose computers (e.g., devices specifically programmed to communicate with each other and/or the server system 760), a workstation, a server, a device, a digital assistant or a “smart” cellular telephone or pager, a digital camera, a component, other equipment, or some combination of these elements that is capable of responding to and executing instructions or operations.

Similar to user system 720, server system 760 preferably includes a computer-readable medium, such as random access memory, coupled to a processor. The processor executes program instructions stored in memory. Server system 760 may also include a number of additional external or internal devices, such as, without limitation, a mouse, a CD-ROM, a keyboard, a display, a storage device and other attributes similar to computer system 10 of FIG. 6. Server system 760 may additionally include a secondary storage element, such as database 770 for storage of data and information. Server system 760, although depicted as a single computer system, may be implemented as a network of computer processors. Memory in server system 760 contains one or more executable steps, program(s), algorithm(s), or application(s) 624 (shown in FIG. 6). For example, the server system 760 may include a web server, information server, application server, one or more general-purpose computers (e.g., personal computers), one or more special purpose computers (e.g., devices specifically programmed to communicate with each other), a workstation or other equipment, or some combination of these elements that is capable of responding to and executing instructions or operations.

Communications system 700 is capable of delivering and exchanging data (including three-dimensional 3D image files) between user systems 720 and a server system 760 through communications link 740 and/or network 750. Through user system 720, users can preferably communicate data over network 750 with each other user system 720, 722, 724, and with other systems and devices, such as server system 760, to electronically transmit, store, print and/or view multidimensional digital master image(s). Communications link 740 typically includes network 750 making a direct or indirect communication between the user system 720 and the server system 760, irrespective of physical separation. Examples of a network 750 include the Internet, cloud, analog or digital wired and wireless networks, radio, television, cable, satellite, and/or any other delivery mechanism for carrying and/or transmitting data or other information, such as to electronically transmit, store, print and/or view multidimensional digital master image(s). The communications link 740 may include, for example, a wired, wireless, cable, optical or satellite communication system or other pathway.

Referring again to FIGS. 2A, 5, and 14B for best results and simplified math, the distance or degrees of angle between the capture of successive images or frames of the scene S is fixed to match the average separation of the human left and right eyes in order to maintain constant binocular disparity. In addition, the distance to key subject KS is chosen such that the captured image of the key subject is sized to fall within the foveal vision of the observer in order to produce high visual acuity of the key subject and to maintain a vergence angle equal to or less than the preferred viewing angle of fifteen degrees (15) and more specifically one and a half degrees (1.5).

FIGS. 8A-8C disclose different subsurface image capture modules 830 subsurface imaging diagnostic imaging tools for capturing a plurality of datasets of substructure with coordinate reference data: 1) subsurface or below surface images of animals, plants, insects, microorganisms, cells, molecules, sub particles, humans, and the like (internal biology) to produce multi-dimensional image sequence and/or multi-dimensional images of internal structures, such as organs, bone, tissue, vascular and other substructures or elements within the body for improved imaging and diagnostic; 2) substructure, mineral, oil, and gas deposits to produce multi-dimensional image sequence and/or multi-dimensional images of deposits; 3) substructure of ocean to produce multi-dimensional image sequence and/or multi-dimensional images of topography of terrain T of scene S, marine life ML, and deposits, 4) substructure of underground utilities such as concrete, asphalt, metals, pipes, cables or masonry along with coordinate reference data or geocoding information of the vehicle 400 (vehicle may include device to traverse, lowered, rotate, or the like) relative to the terrain T of scene S, such as FIG. 4.

As described above, the sense of depth of a stereoscopic image varies depending on the distance between capture module 830 and the key subject Ks, known as the image capturing distance or KS. The sense of depth is also controlled by the vergence angle and the distance between the capture of each successive image by the camera which effects binocular disparity.

In photography the Circle of Confusion defines the area of a scene S that is captured in focus. Thus, the near plane NP, key subject plane KSP and the far plane FP are in focus. Areas outside this circle are blurred.

Referring now to FIG. 8A, by way of example, and not limitation, there is illustrated subsurface image capture module 830A an image/diagnostic tool to capture internal or subsurface image files, datasets, or slices SL of the specimen or scene (internal biology), such as patient P (or animals, plants, insects, microorganisms, cells, molecules, sub particles, humans, and the like) via machine 400 to provide rotation or movement of capture module 830A about specimen with coordinate reference data, such as patient P, such as a magnetic resonance imaging (MRI) having elements that rotate R, such as one or more wave generating devices 810 and one or more sensors, antenna, or capture devices 820, around a specimen or patient P uses magnetic fields and radio waves to capture detailed subsurface image files, datasets, or slices SL of the specimen, such as detailed images of organs and tissues in the body, as shown in FIGS. 4A1, 4A2, and 4A3; x-ray (X-Ray) 830A having elements that rotate R, such as one or more wave generating devices 810 and one or more sensors, antenna, or capture devices 820, around a specimen uses ionizing radiation to capture detailed subsurface SB image files, datasets, or slices SL of the specimen, such as images of the structures inside the body, such as bones, as shown in FIGS. 4A1, 4A2, and 4A3; computerized tomography (CT) and computerized axial tomography (CT/CAT) 830A having elements that rotate R, such as one or more wave generating devices 810 and one or more sensors, antenna, or capture devices 820, around a specimen uses a series of x-rays to capture detailed image files, datasets, or slices SL of the specimen, a series of cross-sections of the body including bones, blood vessels, and soft tissue as shown in FIGS. 4A1, 4A2, and 4A3; positron emission tomography (PET) having elements that rotate R, such as one or more wave generating devices 810 and one or more sensors, antenna, or capture devices 820, around a specimen uses radioactive drugs (tracers) and a scanning machine to capture detailed image files, datasets, or slices SL of the specimen, such as images of the structures inside the body, such as tissues and organs are functioning as shown in FIGS. 4A1, 4A2, and 4A3; bone densitometry (DEXA) 830A having elements, such as one or more wave generating devices 810 and one or more sensors, antenna, or capture devices 820; Fluoroscopy having elements, such as one or more wave generating devices 810 and one or more sensors, antenna, or capture devices 820, ultrasound 830A having elements, such as one or more wave generating devices 810 and one or more sensors, antenna, or capture devices 820 uses high-frequency sound waves to capture detailed image files, datasets, or slices SL of the specimen, such as images of organs and substructures within the internal biology and the like as shown in FIG. 4A4 and detect geocoding data or position of one or more wave generating devices 810 and one or more sensors, antenna, or capture devices 820 relative to internal biology.

It is recognized herein that capture module 830A produces detailed image files, datasets, or slices SL of the specimen in an industry standard format of a Digital Imaging and Communications in Medicine (DICOIM) file format standard for the communication and management of medical imaging information that includes a set of slices SL of the specimen ranging from

Referring now to FIG. 8B, by way of example, and not limitation, there is illustrated subsurface image capture module 830B integrated with a vehicle V an image/diagnostic tool to capture subsurface image files, datasets, or slices SL of the specimen, such as earth or specific ground area sub-surfaces (ground area), including but not limited to, investigate underground utilities such as concrete, asphalt, metals, pipes, cables or masonry, such as ground-penetrating radar (GPR) 830B having one or more wave generating devices 810 and one or more sensors, antenna, or capture devices 820 to generate radar pulses RP 810 microwave band (UHF/VHF frequencies) of the radio spectrum which reflect radar pulses RRP 820 off different subsurface materials, to capture detailed subsurface image files, datasets, or slices SL of the specimen, such as images of subsurface SB including but not limited to investigate underground utilities such as concrete, asphalt, metals, pipes, cables C or masonry; and ultrasound, seismic waves, ultrasound waves, or radar waves 830B having elements, such as one or more wave generating devices 810 and one or more sensors, antenna, or capture devices 820 uses high-frequency sound waves S which reflect high-frequency sound waves RS 820 off different subsurface materials to capture detailed image files, datasets, or slices SL of the specimen, such as images of underground utilities such as concrete, asphalt, metals, pipes, cables C or masonry, substructure, mineral M, oil, and gas OG deposits and the like, such as shown in FIG. 4B. For example, transmitted and returned pulses measure the depth of material items, such as underground utilities in concrete, asphalt, metals, pipes, cables C or masonry and substructure, mineral M, oil, and gas OG deposits and the like beneath the surface SF in the subsurface SB.

Depth of material items D, such as underground utilities in concrete, asphalt, metals, pipes, cables C or masonry and substructure, mineral M, oil, and gas OG deposits and the like beneath the surface SF in the subsurface SB is measured as a function of

$$D = 1 / 2 * v * t$$

where ‘v’ is radar pulses RP 810 velocity in subsurface SB and ‘t’ radar pulse travel time of radar pulses RP 810 and reflect radar pulses RRP 820 for D1 for cables C, D2 for mineral M, and D3 for oil and gas OG.

Referring now to FIG. 8C1, by way of example, and not limitation, there is illustrated subsurface capture module 830C integrated with a vehicle V, 400, such as a marine vessel, an image/diagnostic tool to capture subsurface or underwater (underwater) image files, datasets, or slices SL of the specimen, such as river, lake, ocean, tank, or specific water area (underwater) subsurface SB including but not limited to investigate underwater utilities such as concrete, metals, pipes, cables or masonry, substructure, topography of terrain T of scene, marine life ML, and mineral M, oil, and gas OG deposits and the like, shown in FIG. 4C, such as seismic waves, ultrasound waves, or radar waves 830B having elements, such as emitting waves from one or more wave generating devices 810 and detecting reflections via one or more sensors, antenna, or capture devices 820 uses high-frequency sound waves SW 810, which reflect high-frequency sound waves RS 820 off different subsurface materials to capture detailed image files, datasets, or slices SL of the specimen, such as images of underground utilities such as concrete, metals, pipes, cables or masonry, substructure, topography of terrain T of scene S, marine life ML, and mineral M, oil, and gas OG deposits and the like, shown in FIG. 4C. For example, transmitted and returned pulses measure the depth of material items, such as underwater utilities such as concrete, metals, pipes, cables or masonry, substructure, topography of terrain T of scene S, marine life ML, and mineral M, oil, and gas OG deposits and the like beneath the surface SF in the subsurface SB, shown in FIG. 4C.

Depth of material items D, such as underwater utilities such as concrete, metals, pipes, cables C (depth D1) or masonry, substructure, topography of terrain T of scene S, marine life ML, and mineral M (depth D1), oil, and gas OG (depth D2) deposits and the like beneath the surface SF in the subsurface SB is measured as a function of:

$$D = 1 / 2 * v * t$$

where ‘v’ is sound waves SW 810 velocity in subsurface SB and ‘t’ sound wave travel time of sound waves SW 810 and reflect radar pulses RRP 820 for D1 for cables C, D2 for mineral M, and D3 for oil and gas OG.

Vehicle 400 may utilize global positioning system (GPS) to identify coordinate reference data x-y-z position of vehicle 400. GPS satellites carry atomic clocks that provide extremely accurate time. The time information is placed in the codes/signals broadcast by the satellite. Because radio waves travel at a constant speed, the receiver can use the time measurements to calculate its distance from each satellite. The receiver (vehicle 400) uses at least four satellites to compute latitude, longitude, altitude, and time by measuring the time it takes for a signal to arrive at its location from at least four satellites.

It is contemplated herein that image capture module 830B and 830C may control or set the depth of image capture device 830, whether different depths in scene S, such as annotated key subjects, foreground objects, and background elements or foreground FG, and or object, background BG, such as closest point CP, key subject point KS, and a furthest point FP, shown in FIG. 4.

It is contemplated herein that capture module 830 may be mounted to vehicle 400 utilizing three axis x-y-z gimbal.

Referring again to FIG. 8C, by way of example, and not limitation, there is illustrated marine vehicle 400 having capture module 830, configured to capture images and dataset, such as 2D RGB high resolution digital camera (broad image of terrain or sets of image sections as tiles), LIDAR, IR, EM or other like spectrum formats images, files or datasets, labels (LIDAR) and identifies the datasets of the terrain T of scene S based on the source capture device along with coordinate reference data or geocoding information. Capture module 830 may include computer system 10 and may include one or more sensors 840 to measure distance between capture module 830 and selected depths in terrain T of scene S (depth).

Moreover, vehicle 400 may utilize global positioning system (GPS). GPS satellites carry atomic clocks that provide extremely accurate time. The time information is placed in the codes/signals broadcast by the satellite. Because radio waves travel at a constant speed, the receiver can use the time measurements to calculate its distance from each satellite. The receiver (vehicle 400) uses at least four satellites to compute latitude, longitude, altitude, and time by measuring the time it takes for a signal to arrive at its location from at least four satellites.

It is contemplated herein that image capture module 830 may include one or more sensors 840 may be configured as combinations of image capture device 830 and sensor 840 configured as an integrated unit or module where sensor 840 controls or sets the depth of image capture device 830, whether different depths in scene S, such as foreground, and person P or object, background, such as closest point CP, key subject point KS, and a furthest point FP, shown in FIG. 4.

It is contemplated herein that capture device(s) 830 may be utilized to capture LIDAR file format LAS, a file format designed for the interchange and archiving of LIDAR point cloud data 850 (capture device(s) 830 emits infrared pulses or laser and detects the reflection of objects to map the terrain T of scene S) and identifies the datasets of the terrain T of scene S based on the source capture device along with coordinate reference data or geocoding information via GPS of the vehicle 400 relative to the terrain T of scene S. It is an open, binary format specified by the American Society for Photogrammetry and Remote Sensing.

It is further contemplated herein that capture device(s) 830 may be utilized to capture a series or tracts of high resolution 2D images RGB and identifies the datasets of the terrain T of scene S based on the source capture device along with coordinate reference data or geocoding information via GPS of the vehicle 400 relative to the terrain T of scene S.

Referring now to FIG. 8C2, by way of example, and not limitation, there is illustrated subsurface capture module 830D integrated with an autonomous rover, such as vehicle V. Autonomous rover V for subterranean cavern C inspection and sinkhole precursor detection includes a ruggedized mobile robotic platform having a chassis supported by a plurality of independently driven wheels or tracks configured to navigate uneven, rocky, and inclined cavern surfaces with enhanced traction and stability. Mounted atop the chassis is an elevated sensor mast assembly supporting subsurface capture module 830D incorporating a primary high-resolution stereo camera system equipped with dual wide-angle lenses and integrated illumination sources for capturing detailed visual and stereoscopic image data of cavern C walls, ceilings, floors, and structural features under low-light conditions. Rover V may further include an array of auxiliary sensors, such as LIDAR scanners for three-dimensional mapping of subsurface voids and surface anomalies, ground-penetrating radar or acoustic sensors for detecting subsurface voids, fractures, or material density variations indicative of potential sinkhole formation, inclinometers and accelerometers for monitoring terrain instability and vehicle attitude, and environmental sensors (e.g., temperature, humidity, and gas detectors) to assess conditions contributing to geological degradation 830D. An onboard processing unit, powered by a rechargeable battery system and equipped with wireless communication modules, autonomously controls traversal along predetermined or adaptive paths while continuously collecting, processing, and analyzing multi-modal sensor data to identify early indicators of sinkhole risk, such as ceiling cracks, floor subsidence patterns, or anomalous void signatures, thereby enabling remote operators to receive real-time alerts and detailed imaging datasets for proactive hazard mitigation in karst terrains or other subsidence-prone environments.

Referring now to FIG. 8C3, by way of example, and not limitation, there is illustrated subsurface capture module 830D integrated with tethered lowering mechanism TH. Tethered monitoring device 830D for subterranean cavern C inspection and sinkhole precursor detection includes a compact, ruggedized sensor payload assembly 830D suspended by a high-strength, lightweight tether cable TH from a surface deployment unit, enabling controlled descent and retrieval into accessible sinkholes, boreholes, or natural caverns while maintaining real-time data transmission and power delivery through integrated electrical and optical conductors within the tether. The payload features a sealed, corrosion-resistant housing incorporating a primary high-resolution camera module with wide-angle or fisheye lens optics and integrated low-light LED illumination for capturing detailed visual and panoramic image data of cavern walls, ceilings, floors, voids, and geological features indicative of instability. Augmented by an array of auxiliary sensors-including LIDAR or structured-light scanners for three-dimensional volumetric mapping and void detection, acoustic or ultrasonic transducers for identifying fractures and material discontinuities, inclinometers and gyroscopic sensors for orientation and tilt monitoring during descent, and environmental probes (e.g., humidity, temperature, and gas detectors) to evaluate conditions conducive to karst degradation or subsidence 830D the device autonomously or semi-autonomously collects multi-modal datasets. An onboard microcontroller or processor manages sensor operation, preliminary data processing for anomaly detection (such as crack propagation, ceiling sagging, or anomalous void signatures suggestive of impending sinkhole formation), and compression/transmission of imaging and sensor outputs via the tether to a surface operator interface for real-time analysis, archival storage, and generation of hazard alerts, thereby facilitating non-invasive, low-risk evaluation of subsurface voids and structural integrity in karst terrains, mining sites, or infrastructure-adjacent environments prone to collapse.

Referring now to FIG. 8D1, there is illustrated process steps as a flow diagram 800 of a method of capturing subsurface images, files or datasets, labels and identifies the datasets of the of scene S based on capture module 830A, 830B, 830C and if relevant coordinate reference data or geocoding information of the vehicle 400 relative to the terrain T of scene S based on the source capture device, manipulating, reconfiguring, processing, storing a digital multi-dimensional image sequence and/or multi-dimensional images as performed by a computer system 10, and viewable on display 628.

Moreover, subsurface capturing such as 2D RGB high resolution digital camera (to capture a series of 2D images of terrain T, broad image of terrain or sets of image sections as tiles), LIDAR, IR, EM or other like spectrum formats (to capture a digital elevation model or depth or z-axis of terrain T, DEM capture device) images, files or datasets, labels and identifies the datasets of the terrain T of scene S based on the source capture device along with coordinate reference data or geocoding information of the vehicle 400 relative to the terrain T of scene S based on the source capture device along with coordinate reference data or geocoding information, manipulating, reconfiguring, processing, storing a digital multi-dimensional image sequence and/or multi-dimensional images as performed by a computer system 10, and viewable on display 628.

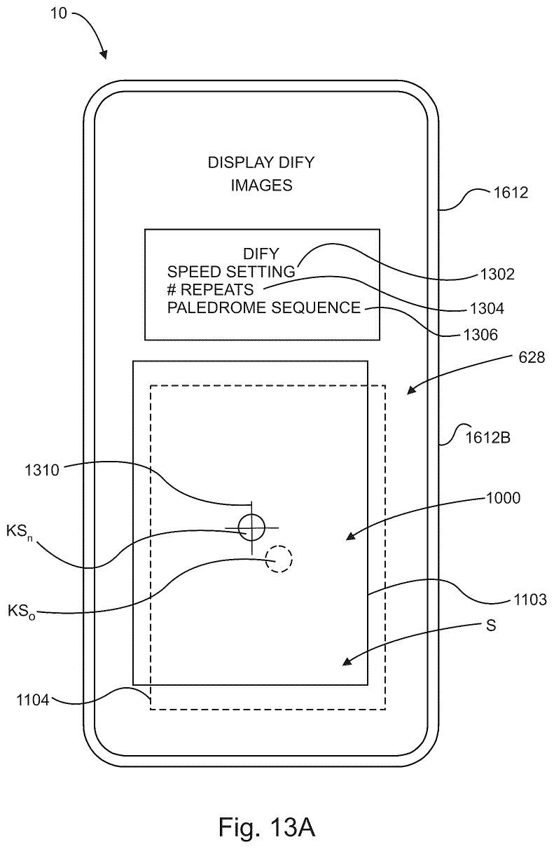

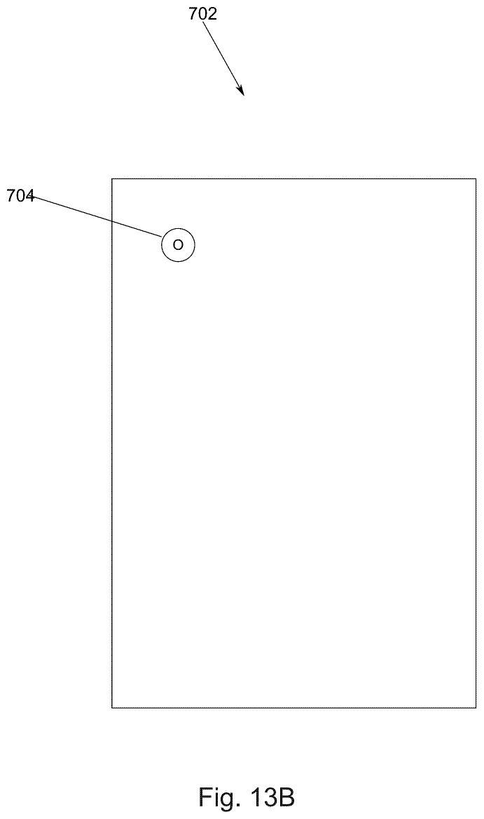

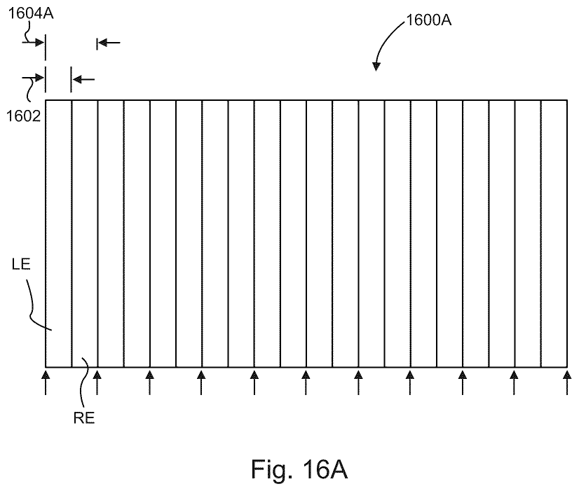

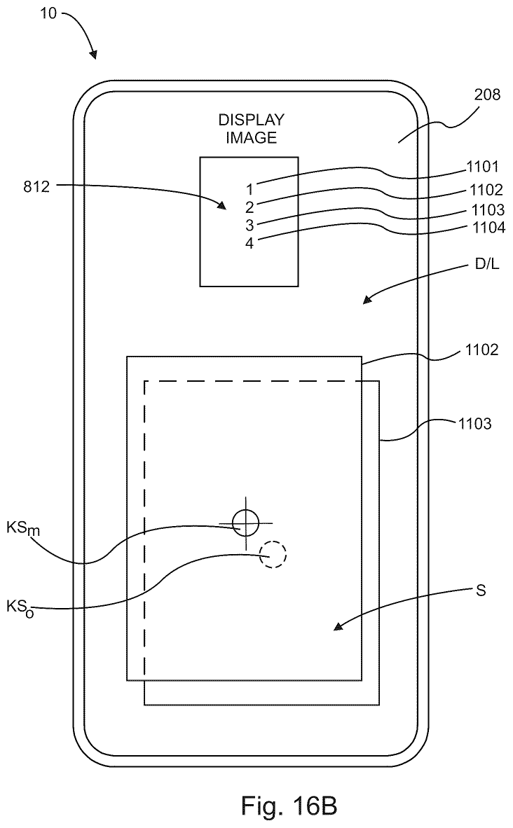

Note in FIG. 13 or 16B some steps designate a manual mode of operation may be performed by a user U, whereby the user is making selections and providing input to computer system 10 in the step whereas otherwise operation of computer system 10 is based on the steps performed by application program(s) 624 in an automatic mode.

In block or step 810, providing computer system 10 having capture device(s) 830, display 628, and applications 624 as described above in FIGS. 6-7, where capture module 830, is configured to capture subsurface images and dataset, such as image files, datasets, or slices SL of the specimen in an industry standard format of a Digital Imaging and Communications in Medicine (DICOM); capture subsurface image files, datasets, or slices SL of the specimen, such as earth or specific ground area sub-surfaces including but not limited to investigate underground; capture subsurface, or underwater image files, datasets, or slices SL of the specimen, such as river, lake, or ocean, or specific water area sub-surfaces including but not limited to investigate underwater, and files or datasets, labels and identifies the datasets of the terrain T of scene S based on the source capture device along with coordinate reference data or geocoding information; capture subsurface images, such as 2D RGB high resolution digital camera (to capture a series of 2D images of terrain T, broad image of terrain or sets of image sections as tiles) and/or LIDAR, IR, EM or other like spectrum formats (to capture a digital elevation model or depth or z-axis of terrain T of scene S, DEM capture device) images, files or datasets, labels and identifies the datasets of the terrain T of scene S. Capture module 830 may include computer system 10 and may include one or more sensors 840 to measure distance between Capture module 830 and selected depths in terrain T of scene S (depth). It is contemplated herein that other subsurface penetrating image capture devices 830 are included herein.

In block or step 815, mounting or positioning selected capture module 830, 830A, 830B, 830C on machine or vehicle 400 to capture to capture subsurface images and dataset, such as image files, datasets, or slices SL of the specimen.

In block or step 825, configuring computer system 10 having capture device(s) 830, display 628, and applications 624 as described above in FIGS. 6-7, where capture module 830, is configured to capture subsurface images and dataset, such as image files, datasets, or slices SL of the specimen or scene S based on the source capture device along with coordinate reference data or geocoding information and other attributes of specimen or scene S to maximize quality of subsurface images and dataset, such as image files, datasets, or slices SL of the specimen or scene S.

In block or step 835, maneuvering machine or vehicle 400 about a planned trajectory having selected capture module 830, configured to capture subsurface images and dataset, such as image files, datasets, or slices SL of the specimen or scene S or the like or other like spectrum formats.

For example, vehicle 400 is on a designated path and may capture images, files or datasets at designated intervals, labels and identifies the datasets of the subsurface terrain T of scene S via ground tracking position and coordinate reference data or geocoding information as well as x-y-z position or angle of capture device(s) 830. Moreover, machine or vehicle 400 may be on a scheduled or manual guidance plan over terrain T and may capture images, files or datasets at designated intervals, labels and identifies the datasets of the terrain T of scene S via coordinate reference data or geocoding information, such as GPS as well as x-y-z position or angle of capture device(s) 830 relative to machine or vehicle 400. Travel plan for vehicle 400 may consist of a switchback pattern with an overlap to enable full capture of terrain T or the travel plan may follow a linear path with an overlap to enable the capture of images, files, and dataset, via capture device(s) 830, such as underwater utilities such as concrete, metals, pipes, cables C or masonry, substructure, topography of terrain T of scene S, marine life ML, and mineral M, oil, and gas OG deposits and the like beneath the surface SF in the subsurface SB as shown in FIGS. 4B and 4C. Furthermore, autonomous vehicle 400 may be on a scheduled or manual guidance plan to traverse terrain T and may capture images, files or datasets at designated intervals or continuously capture images, files or datasets and guide autonomous vehicle 400.4 to traverse terrain T of scene S via coordinate reference data or geocoding information, such as GPS as well as x-y-z position or angle of capture device(s) 830 relative to drone 400.1 or ground tracking path of autonomous vehicle 400.4.

Travel plan for vehicle 400 may consist of an arc around the specimen, such as patient P with an overlap to enable the capture of image files, datasets, or slices SL of the specimen via capture device(s) 830, a series of cross-sections of the body including bones, blood vessels, and soft tissue as shown in FIGS. 4A1, 4A2, 4A3, and 4A4.

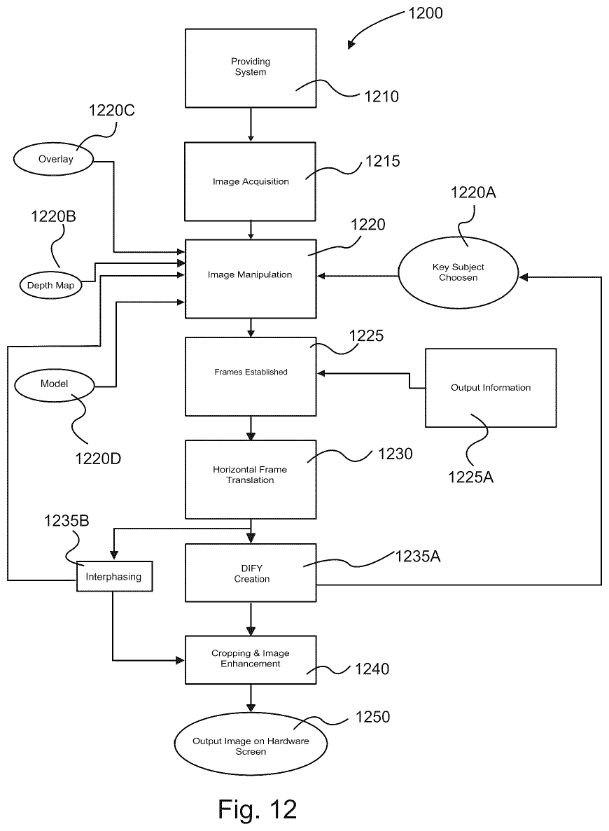

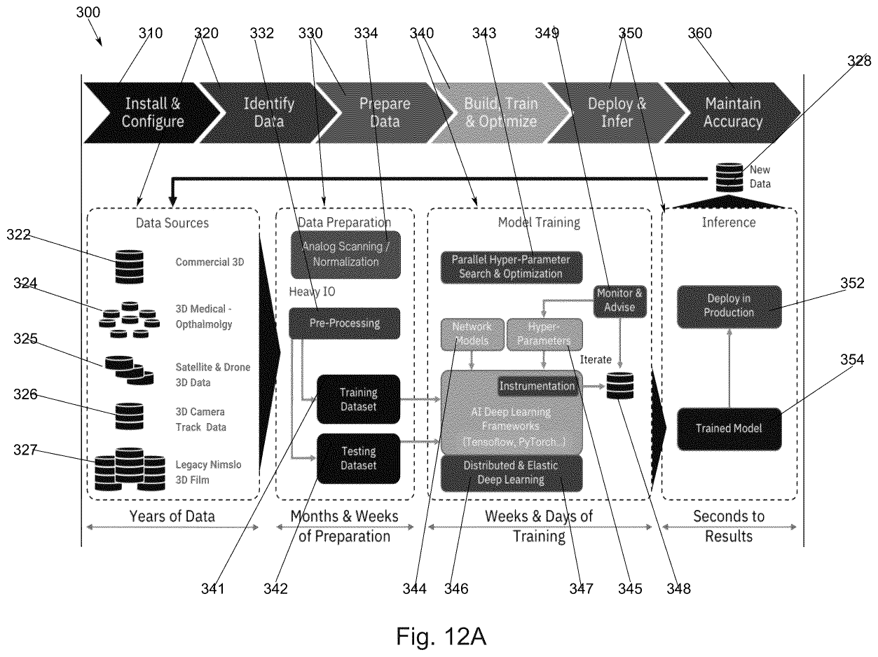

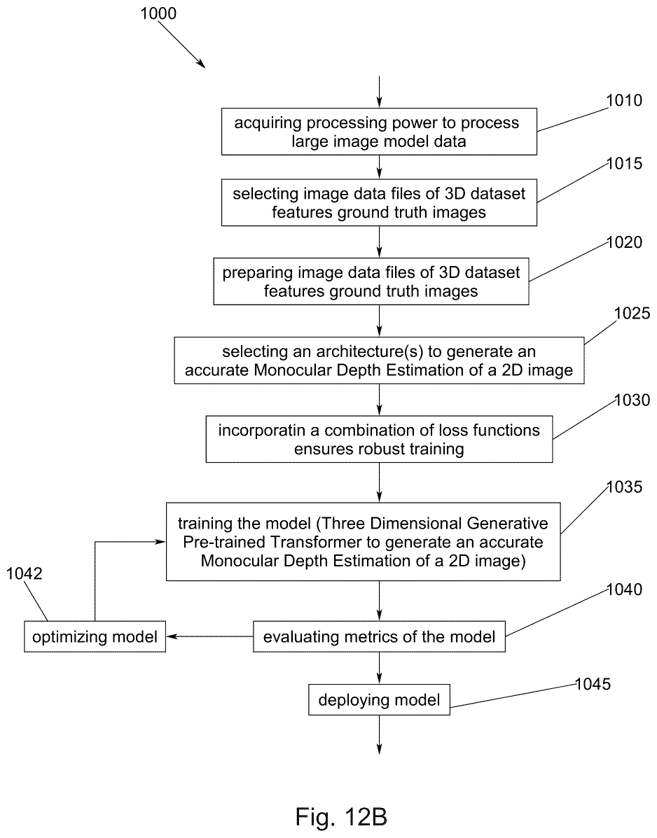

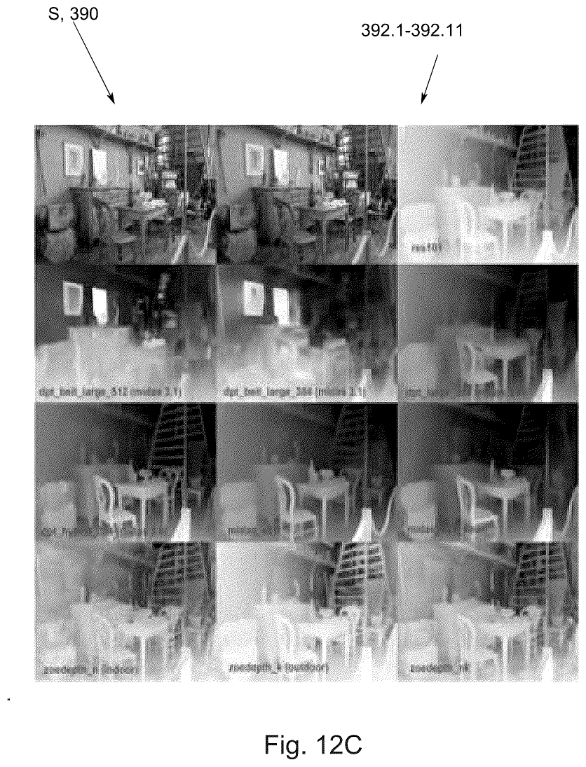

In block or step 845 and FIG. 12 step 1215, capturing images, files, and dataset, via capture device(s) 830, such as 2D RGB high resolution digital camera (to capture a series of 2D images of terrain T, broad image of terrain or sets of image sections as tiles), LIDAR, IR, EM images or other like spectrum formats (to capture a digital elevation model or depth or z-axis of terrain T, DEM capture device) images, files or datasets, labels and identifies the datasets of the terrain T of scene S based on the source capture device along with coordinate reference data or geocoding information of the vehicle 400 relative to the terrain T of scene S to obtain images, files or datasets, and to further label and identify images, files, and dataset of the terrain T of scene S based on the source capture device along with coordinate reference data or geocoding information, such as GPS.

Moreover, capturing detailed image files, datasets, or slices SL of the specimen via rotating R capture device(s) 830, a series of cross-sections of the body including bones, blood vessels, and soft tissue as shown in FIGS. 4A1, 4A2, 4A3, and 4A4.

Furthermore, capture of images, files, and dataset, via capture device(s) 830, such as underwater utilities such as concrete, metals, pipes, cables C or masonry, substructure, topography of terrain T of scene S, marine life ML, and mineral M, oil, and gas OG deposits and the like beneath the surface SF in the subsurface SB as shown in FIGS. 4B and 4C.

In block or step 855 and FIG. 12 step 1220, modifying images, files, and dataset, from capture device(s) 830, such as using selected 2D RGB high resolution digital camera (broad image of terrain or sets of image sections as tiles), LIDAR (dataset sections as model or map terrain), IR, EM as well as via computer system 10 having capture device(s) 830, display 628, and applications 624 as described above in FIGS. 6-7.

Moreover, modifying image files, datasets, or slices SL of the specimen via capture device(s) 830, a series of cross-sections of the body including bones, blood vessels, and soft tissue as shown in FIGS. 4A1, 4A2, 4A3, and 4A4.

Furthermore, modifying images, files, and dataset, via capture device(s) 830, such as underwater utilities such as concrete, metals, pipes, cables C or masonry, substructure, topography of terrain T of scene S, marine life ML, and mineral M, oil, and gas OG deposits and the like beneath the surface SF in the subsurface SB as shown in FIGS. 4B and 4C.

Moreover, in block or step 855 and FIG. 12 step 1220, modifying LIDAR (dataset sections as tiles). For example, computer system 10 having display 628, and applications 624 as described above in FIGS. 6-7, where application 624 may include a program called LASTOOLS-LASMERGE, which may be utilized to merge a series of 2D digital images or tiles into a single 2D digital image dataset and to merge LIDAR scans (digital elevation scans) into a LIDAR dataset (digital elevation scans) into a digital elevation model or map, step 855A. Once in a single dataset, a user may select an area of interest (AOI) within the single dataset of merged images, files, tiles, or datasets via application 624, such as LASTTOOLS-LASCLIP to clip out the LIDAR data for the specific AOI 855B. Note, LIDAR (dataset sections as tiles) as a single dataset contains all of the LIDAR returns, including but not limited to bare earth (Class 2), vegetation, buildings and the like, which may be included or removed or segmented based on class number of LIDAR via application 624, such as LASTTOOLS-LAS2LAS to into a LIDAR segmented returns with selected class number(s) as a second dataset 855C. Saved second dataset 855C AOI and its geocoding.

Moreover, in block or step 855 and FIG. 12 step 1220, modifying 2D RGB high resolution digital camera image base map layer, a multi-resolution true color image overlay via computer system 10 having display 628, and applications 624 as described above in FIGS. 6-7, where application 624 may include a program called ArcGIS Pro. Application 624, such as ArcGIS Pro may be utilized to zoom, fly through into area of interest (AOI) within 2D RGB high resolution digital camera image base map layer as a second image set 865B. Save second image set 865B AOI and its geocoding.

Moreover, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. First process, import image files, datasets, or slices SL into RADIANT, a DICOM viewer or other image viewer as shown in FIG. 4A2. Create three dimensional volumetric model MD from image files, datasets, or slices SL as shown in FIG. 4A3. Application 624, such as ArcGIS Pro may be utilized to zoom, fly through into area of interest (AOI) within three dimensional volumetric model MD. Save second image set 865B AOI and its geocoding.

Assign transfer function to three dimensional volumetric model MD from image files, datasets, or slices SL (texture, color) as shown in FIG. 4A3. Crop, slice, segment three dimensional volumetric model MD as required. Set zero point (facing) and Key Subject KS (point of rotation of three dimensional volumetric model MD on Z axis). Create for example, one degree (1°) sequence of frames from rotation of three dimensional volumetric model M, such as (16+1 or 32+1) plus zero point. For example, sequence for 16 may be −8 −7 −6 −5 −4 −3 −2 −1 0 1 2 3 4 5 6 7 8 (palindrome loop of frames).

Furthermore, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. Second process DIF 1235A, import frames, such as one degree (1°) sequence of frames from rotation of three dimensional volumetric model MD, such as −8 −7 −6 −5 −4 −3 −2 −1 0 1 2 3 4 5 6 7 8 (palindrome loop of frames) into PHOTOSHOP, an image editing tool, or the like. Note alignment points are already selected in the previous steps. Create animation timeline in PHOTOSHOP and add frames in sequence, such as one degree (1°) sequence of frames from rotation of three dimensional volumetric model MD, such as −8 −7 −6 −5 −4 −3 −2 −1 0 1 2 3 4 5 6 7 8 to time line. Set frame duration in PHOTOSHOP to approximately 0.08-0.12 seconds per frame, other time frames may be utilized to produce different speed DIF. Set repeat of frames in palindrome loop to forever or repeat (DIF).

Furthermore, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. Second process stereo pair 1235A, import frames, such as one degree (1°) sequence of frames from rotation of three dimensional volumetric model MD, such as −8 −7 −6 −5 −4 −3 −2 −1 0 1 2 3 4 5 6 7 8 (palindrome loop of frames) into PHOTOSHOP, an image editing tool, or the like. Note alignment points are already selected in the previous steps. Select stereo pair from Stereo Pair Frames column from, for example, −8 −7 −6 −5 −4 −3 −2 −1 0 1 2 3 4 5 6 7 8 based on chart in FIG. 8D2 for a body part identified in column ROI having parallax in column Parallax total.

Still furthermore, block or step 855 and FIG. 12 step 1240 a user U of computer system 10 via dataset editing application 624 may select body parts (via a slider on FIG. 16B) for viewing as DIF or stereo pair based on Hounsfeld units HU set forth in FIG. 8D3, where Substance of human body HB innards IN lying beneath the subsurface of the skin SK may include but not limited to body B, head H, organs, such as brain BR, Thyroid TY, lung LG, heart HT, skin SK, liver LV, stomach ST, kidney KD, large intestine LI, small intestine SI, spine SP, bone (pelvis PV), artery AT, blood vessels BV, muscle, tendon, and other human body parts, as shown FIG. 4A3 have different Hounsfeld units HU of density collected with DICOM image information.

In block or step 870, overlaying merged 2D RGB high resolution digital camera image base map layer, second image set 865B, as second image set 865B AOI and its geocoding images on LIDAR merged segmented returns with selected class number(s), second dataset 855C, as second dataset 855C AOI and its geocoding, and save as overlay 2D RGB and LIDAR segmented AOI. Saved overlay 2D RGB and LIDAR segmented AOI and its geocoding.

It is contemplated herein that specific software programs called out herein were used to do the work on the prototype datasets and other software programs may be utilized that perform the operations those tools perform or develop better software programs perform the operations those tools perform.

In block or step 875 and FIG. 12 step 1250, exporting overlay 2D RGB and LIDAR (Date Set) segmented AOI dataset, from capture device(s) 830. Export DIF as a GIF using guidelines for targeted display 208. Export stereo .JPS (jpeg stereo) as a .MPO (multi picture object). JPS files use half of the image area to represent the left and right views. MPO uses the full image area and stacks the left and right view. The left view is always the first in the sequence. The background should move from left to right and the foreground right to left. Create the .MPO file or .JPS file in the same way described above.

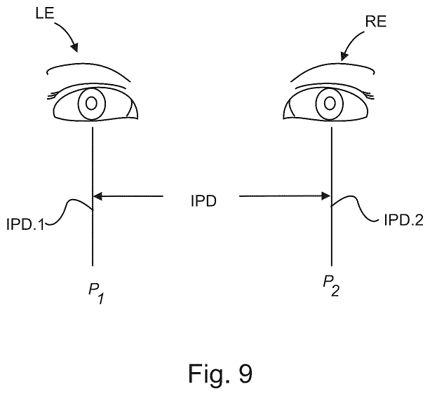

Referring now to FIG. 9, there is illustrated process steps as a flow diagram 900 of a method of modifying images, files, and dataset (Dataset), from capture device(s) 830 along with coordinate reference data or geocoding information, such as GPS, such as using selected 2D RGB high resolution digital camera (broad image of terrain or sets of image sections as tiles), LIDAR (dataset sections as tiles), IR, EM via computer system 10 having capture device(s) 830, display 628, and applications 624 as described above in FIGS. 6-7 of terrain T of scene S, the process of acquiring Data Set, manipulating, generating frames, reconfiguring, processing, storing a digital multi-dimensional image sequence and/or multi-dimensional image as performed by a computer system 10, and viewable on display 628. Note in FIGS. 13 and 16B some steps designate a manual mode of operation may be performed by a user U, whereby the user is making selections and providing input to computer system 10 in the step whereas otherwise operation of computer system 10 is based on the steps performed by application program(s) 624 in an automatic mode.

In block or step 1210, providing computer system 10 having vehicle 400, capture device(s) 830, display 628, and applications 624 as described above in FIGS. 6-8, to enable capture plurality of images, files, and dataset (Dataset) of terrain T of scene S while in motion via vehicle 400. Moreover, the display of digital image(s) on display 628 (DIFY or stereo 3D) where modifying images, files, and dataset (Dataset), from capture device(s) 830 along with coordinate reference data or geocoding information, such as GPS (n devices) to visualize on display 628 as a digital multi-dimensional image sequence (DIFY) or digital multi-dimensional image (stereo 3D).

In block or step 1215 and block or step 845 and FIG. 8, computer system 10 via dataset capture application 624 (via systems of capture as shown in FIG. 8) is configured to capture a plurality images, files, and dataset (Dataset) of terrain T of scene S while in motion via vehicle 400 via capture module 830 having plurality of capture device(s) 830 (n devices), or the like mounted thereon vehicle 400 and may utilize integrating I/O devices 852 with computer system 10, I/O devices 852 may include one or more sensors in communication with computer system 10 to measure distance between computer system 10 (capture device(s) 830) and selected depths in scene S (depth) such as Key Subject KS, Near Plane NP, N, Far Plane FP, B, and any plane therebetween and set the focal point of one or more plurality of dataset from capture device(s) 830 (n devices).

3D Stereo, user U may tap or other identification interaction with selection box 812 to select or identify key subject KS in the source images, left image 1102 and right image 1103 of scene S, as shown in FIG. 16. Additionally, in block or step 1215, utilizing computer system 10, display 628, and application program(s) 206 (via image capture application) settings to align(ing) or position(ing) an icon, such as cross hair 814, of FIG. 16B, on key subject KS of a scene S displayed thereon display 628, for example by touching or dragging image of scene S or pointing computer system 10 in a different direction to align cross hair 814, of FIG. 16, on key subject KS of a scene S. In block or step 1215, using, obtaining or capturing images(n) of scene S) focused on selected depths in an image or scene (depth) of scene S.

Alternatively, computer system 10 via dataset capture application 624 and display 628 may be configured to operate in auto mode wherein one or more sensors 852 may measure the distance between computer system 10 (capture device(s) 830) and selected depths in scene S (depth) such as Key Subject KS. Alternatively, in manual mode, a user may determine the correct distance between computer system 10 and selected depths in scene S (depth) such as Key Subject KS.

It is recognized herein that user U may be instructed on best practices for capturing images(n) of scene S via computer system 10 via dataset capture application 624 and display 628, such as frame the scene S to include the key subject KS in scene S, selection of the prominent foreground feature of scene S, and furthest point FP in scene S, may include identifying as annotated key subjects, foreground objects, and background elements or key subject(s)KS in scene S, selection of closest point CP, furthest point FP in scene S, the prominent background feature of scene S and the like. Moreover, position key subject(s) KS in scene S a specified distance from capture device(s) 830) (n devices). Furthermore, position vehicle 400 a specified distance from closest point CP in scene S or key subject(s) KS in scene S.

For example, vehicle 400 vantage or viewpoint of terrain T of scene S about the vehicle, wherein a vehicle may be configured with from capture device(s) 830 (n devices) from specific advantage points of vehicle 400. Computer system 10 (first processor) via image capture application 624 and plurality of capture device(s) 830 (n devices) may be utilized to capture multiple sets of plurality of images, files, and dataset (Dataset) of terrain T of scene S from different positions around vehicle 400, especially an auto piloted vehicle, autonomous driving, agriculture, warehouse, transportation, ship, craft, drone, and the like.

Alternatively, in block or step 1215, user U may utilize computer system 10, display 628, and application program(s) 624 to input plurality of images, files, and dataset (Dataset) of terrain T of scene S, such as via AirDrop, DROP BOX, or other application.

Moreover, in block or step 1215, computer system 10 via dataset capture application 624 (via systems of capture as shown in FIG. 8) is configured to capture a plurality images, files, and dataset (Dataset) of terrain T of scene S while in motion via vehicle 400 via capture module 830 having plurality of capture device(s) 830 (n devices). Vehicle 400 motion and positioning may include aerial vehicle 400 movement and capture, including: a) a switchback flight path or other coverage flight path of vehicle 400 over terrain T of scene S to capture plurality images, files, and dataset (Dataset) as tiles of terrain T of scene S to be stitched together via LASTTOOLS-LASMERGE to merge the tiles into a single dataset, such as such as 2D RGB high resolution digital camera (broad image of terrain or sets of image sections as tiles), LIDAR to generate a cloud point or digital elevation model of terrain T of scene S, IR, EM images, files or datasets, labels and identifies the datasets of the terrain T of scene S based on the source capture device along with coordinate reference data or geocoding information; b) an arcing flight path of vehicle 400 over terrain T of scene S to capture images, files, and dataset (Dataset) as tiles of terrain T of scene S, such as such as (left and right) 2D RGB high resolution digital camera (broad image of terrain or sets of image sections as tiles), and LIDAR cloud points digital elevation model, IR, EM images, files or datasets, labels and identifies the datasets of the terrain T of scene S based on the source capture device along with coordinate reference data or geocoding information, c) an arcing flight path of vehicle 400 over terrain T of scene S to capture a pair (sequence or a series of degree separated, such as such as 1 degree separated −5, −4, −3, −2, −1, 0, 1, 2, 3, 4, 5) images, files, and dataset (Dataset) as tiles of terrain T of scene S, such as such as (left and right) 2D RGB high resolution digital camera (broad image of terrain or sets of image sections as tiles), and LIDAR cloud points digital elevation model, IR, EM images, files or datasets, labels and identifies the datasets of the terrain T of scene S based on the source capture device along with coordinate reference data or geocoding information (acquisition Dataset). Note, 2D RGB high resolution image with coordinate reference data or geocoding information may be format, such as (.tiff) or other like format and digital elevation model (DEM) file with coordinate reference data or geocoding information may be format, such as LIDAR file format LAS.

Moreover, in block or step 1215, computer system 10 via dataset capture application 624 (via systems of capture as shown in FIG. 8) is configured to capture a plurality images, files, and dataset (Dataset), such as capturing detailed image files, datasets, or slices SL of the specimen via capture device(s) 830, a series of cross-sections of the body including bones, blood vessels, and soft tissue as shown in FIGS. 4A1, 4A2, 4A3, and 4A4. Furthermore, capture of images, files, and dataset, via capture device(s) 830, such as underwater utilities such as concrete, metals, pipes, cables C or masonry, substructure, topography of terrain T of scene S, marine life ML, and mineral M, oil, and gas OG deposits and the like beneath the surface SF in the subsurface SB as shown in FIGS. 4B and 4C. Moreover, modifying image files, datasets, or slices SL of the specimen via capture device(s) 830, a series of cross-sections of the body including bones, blood vessels, and soft tissue as shown in FIGS. 4A1, 4A2, 4A3, and 4A4. Furthermore, modifying images, files, and dataset, via capture device(s) 830, such as underwater utilities such as concrete, metals, pipes, cables C or masonry, substructure, topography of terrain T of scene S, marine life ML, and mineral M, oil, and gas OG deposits and the like beneath the surface SF in the subsurface SB as shown in FIGS. 4B and 4C.

Additionally, in block or step 1215, utilizing computer system 10, display 628, and application program(s) 624 (via dataset capture application) settings to align(ing) or position(ing) an icon, such as cross hair 814, of FIG. 13 or 16B, on key subject KS of a scene S displayed thereon display 628, for example by touching or dragging dataset of scene S, or touching and dragging key subject KS, or pointing computer system 10 in a different direction to align cross hair 1310, of FIG. 13 or 16B, on key subject KS of a scene S. In block or step 1215, obtaining or capturing plurality images, files, and dataset (Dataset) of terrain T of scene S from plurality of capture device(s) 830 (n devices) focused on selected depths in an image or scene (depth) of scene S.

Moreover, in block or step 1215, integrating I/O devices 632 with computer system 10, I/O devices 632 may include one or more sensors 852 in communication with computer system 10 to measure distance between computer system 10/capture device(s) 830 (n devices) and selected depths in scene S (depth) such as Key Subject KS and set the focal point of an arc or trajectory of vehicle 400 and capture device(s) 830. It is contemplated herein that computer system 10, display 628, and application program(s) 624, may operate in auto mode wherein one or more sensors 840 may measure the distance between capture device(s) 830 and selected depths in scene S (depth) such as Key Subject KS and set parameters of travel for vehicle 400 and capture device 830. Alternatively, in manual mode, a user may determine the correct distance between vehicle 400 and selected depths in scene S (depth) such as Key Subject KS. Or computer system 10, display 628 may utilize one or more sensors 852 to measure distance between vehicle 400/capture device 830 and selected depths in scene S (depth) such as Key Subject KS and provide on screen instructions or message (distance preference) to instruct user U to move vehicle 400 closer or father away from Key Subject KS or near plane NP to optimize capture device(s) 830 and images, files, and dataset (Dataset) of terrain T of scene S.

In block or step 1220 and, computer system 10 via dataset manipulation application 624 is configured to receive 2D RGB high resolution digital camera (broad image of terrain or sets of image sections as tiles or stitched tiles), and LIDAR cloud points digital elevation model, IR, EM images, files or datasets, labels and identifies the datasets of the terrain T of scene S based on the source capture device along with coordinate reference data or geocoding information as acquisition Dataset (acquisition Dataset) through dataset acquisition application, in block or step 1215.

Moreover, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. First process, import image files, datasets, or slices SL into RADIANT, a DICOM viewer or other image viewer as shown in FIG. 4A2. Create three dimensional volumetric model MD from image files, datasets, or slices SL as shown in FIG. 4A3. Application 624, such as ArcGIS Pro may be utilized to zoom, fly through into area of interest (AOI) within three dimensional volumetric model MD. Save second image set 865B AOI and its geocoding.

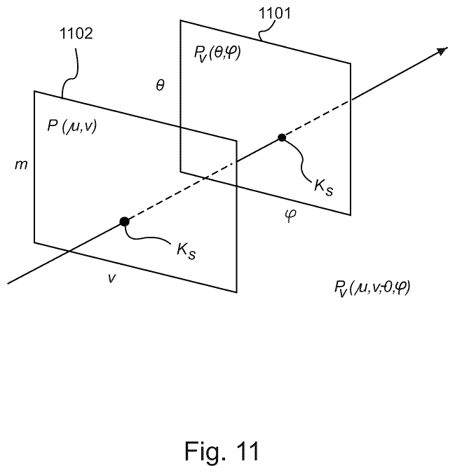

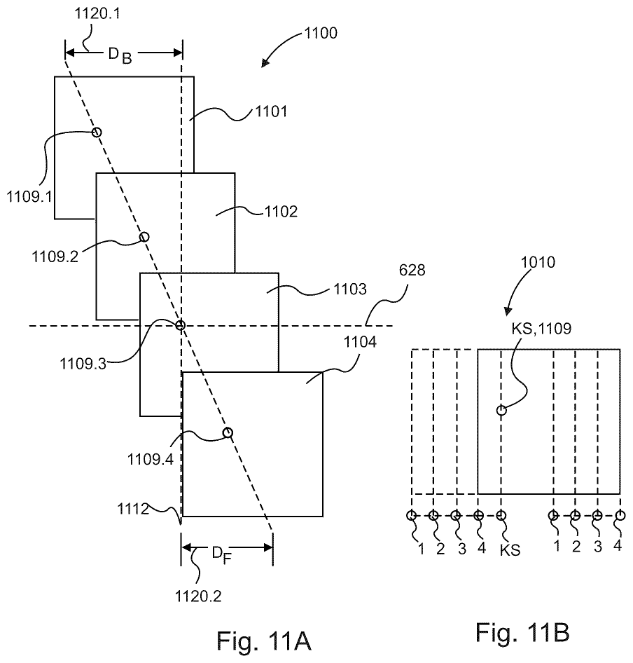

In one embodiment, dataset manipulation application 624 may be utilized to convert 2D RGB high resolution digital camera (broad image of terrain or sets of image sections as tiles or stitched tiles) to a digital source image, such as a JPEG, GIF, TIF format. Ideally, receive 2D RGB high resolution digital camera (broad image of terrain or sets of image sections as tiles or stitched tiles) includes a number of visible objects, subjects or points therein, such as foreground or closest point CP associated with near plane NP, far plane FP or furthest point associated with a far plane FP, and key subject KS with coordinate reference data or geocoding information as a coherent 3D model. The near plane NP, far plane FP point are the closest point and furthest point from vehicle 400 and capture device(s) 830. The depth of field is the depth or distance created within the object field (depicted distance between foreground to background). The principal axis is the line perpendicular to the scene passing through the key subject KS point, while the parallax is the displacement of the key subject KS point from the principal axis, see FIG. 11. In digital composition the displacement is always maintained as a whole integer number of pixels from the principal axis.

Alternatively, computer system 10 via image manipulation application and display 624 may be configured to enable user U to select or identify images of scene S as left image 1102 and right image 1103 of scene S. User U may tap or other identification interaction with selection box 812 to select or identify key subject KS in the source images, left image 1102 and right image 1103 of scene S, as shown in FIG. 16.

In block or step 1220D, computer system 10 via dataset manipulation application 624 (cloud ball algorithm) may be utilized to generate a 3D model MD or mesh surface (digital elevation coherent digital model 1220D) of terrain T of scene S from LIDAR digital elevation model or cloud points. If cloud points are sparse consisting of holes, dataset manipulation application 624 may be utilized to fill in or reconstruct missing data points, holes or surfaces with similar data points from proximate known or tangent plane or data points surrounding the hole to generate or reconstruct a more complete 3D model or mesh surface of terrain T of scene S with coordinate reference data or geocoding information.

Moreover, these two datasets 2D RGB high resolution digital camera (broad image of terrain or sets of image sections as tiles or stitched tiles), such as 16 bit uncompressed color RGB TIFF file format at 300 DPI and 3D model or mesh surface of terrain T of scene S from LIDAR digital elevation model or cloud points will need to match features, points, surfaces, and be registerable to each other with each having coordinate reference data or geocoding information.

Moreover, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. First process, import image files, datasets, or slices SL into RADIANT, a DICOM viewer or other image viewer as shown in FIG. 4A2. Create three dimensional volumetric model MD from image files, datasets, or slices SL as shown in FIG. 4A3. Application 624, such as ArcGIS Pro may be utilized to zoom, fly through into area of interest (AOI) within three dimensional volumetric model MD. Save second image set 865B AOI and its geocoding.

Assign transfer function to three dimensional volumetric model MD from image files, datasets, or slices SL (texture, color) as shown in FIG. 4A3. Crop, slice, segment three dimensional volumetric model MD as required. Set zero point (facing) and Key Subject KS (point of rotation of three dimensional volumetric model MD on Z axis). Create for example, one degree (1°) sequence of frames from rotation of three dimensional volumetric model MD, such as (16+1 or 32+1) plus zero point. For example, sequence for 16 may be −8 −7 −6 −5 −4 −3 −2 −1 0 1 2 3 4 5 6 7 8 (palindrome loop of frames).

In block or step 1220B, computer system 10 via depth map application program(s) 624 is configured to create(ing) depth map of 3D model dataset (Depth Map Grayscale Dataset, digital elevation model) or mesh surface of terrain T of scene S from LIDAR digital elevation model or cloud points and makes a matching grey scale digital elevation model of 2D RGB high resolution digital camera (broad image of terrain or sets of image sections as tiles or stitched tiles) with coordinate reference data or geocoding information, and aligning series of digital image datasets 1100 based on coordinate reference data or geocoding information to construct digital model 1220D. A depth map is an image or image channel that contains information relating to the distance of objects, surfaces, or points in terrain T scene S from a viewpoint, such as vehicle 400 and capture device(s) 830. For example, this provides more information as volume, texture and lighting are more fully defined. Once a depth map 1220B is generated then the displacement and parallax can be tightly controlled.

Computer system 10 via depth map application program(s) 624 may identify annotated key subjects, foreground objects, and background elements or foreground closest point CP, key subject point KS, and a furthest point FP, using Depth Map Grayscale Dataset). Moreover, gray scale 0-256 may be utilized to auto select a key subject KS point as a midpoint between 256 or 128 or thereabout with closest point in terrain T of scene S being white and furthest point being black. Alternatively in manual mode, computer system 10 via depth map application program(s) 624 and display 628 may be configured to enable user U to select or identify key subject KS point in Depth Map Grayscale Dataset. User U may tap, move a cursor or box or other identification to select or identify key subject KS in Depth Map Grayscale Dataset 1100, as shown in FIG. 13.

Depth Map configuration based on LVM for step 1220B.

Referring now to FIGS. 12A, 12B, and 12C, by way of example, and not limitation, there is illustrated an example embodiment of a block diagram of an exemplary embodiment of a Large Vision Model (LVM) AI Three Dimensional Generative Pre-trained Transformer 300, a flowchart diagram 1000 of an exemplary embodiment of steps of generating a Large Vision Model (LVM) AI Three Dimensional Generative Pre-trained Transformer, and picture 390 of scene S with various gray scale depth maps DM 392.1-392.11 of scene S.

The present disclosure relates to systems and methods for developing three-dimensional (3D) generative pre-trained transformer (3DGPT) model 300, specifically employs a transformer architecture tailored for high-accuracy, self-attention mechanisms monocular depth estimation model utilizing proprietary three-dimensional (3D) image datasets 321. Three-dimensional (3D) generative pre-trained transformer (3DGPT) model 300 leverages extensive private and public datasets 321, including, but not limited to, commercial 3D 322, 3D medical ophthalmology 324, satellite and drone 3D data 325, 3D camera data 326, legacy NIMSLO 3Dfilm data, camera track data, including ground truth images and legacy 3D captures, to train large vision models (LVMs) capable of recognizing and predicting dimensional disparities from single two-dimensional (2D) images. This facilitates applications in security printing, mobile devices, medical imaging, subsurface and overhead imaging, anti-counterfeiting, cybersecurity, and earth observation.

FIG. 12C illustrate exemplary embodiments of the monocular depth. FIG. 12C depicts a comparative visualization of monocular depth estimation outputs, showcasing high-accuracy depth maps generated by the 3DGPT model 300 trained on Treis D's extensive 3D ground truth datasets 321 of scene S. The figure includes a grid of gray scale depth maps DM 392.1-392.11 of scene S produced by various architectures and variants (e.g., “dpt_belt_large_512 (midas 3.1)”, “dpt_large_384 (midas 3.1)”, “zoedepth_n (indoor)”, “zoedepth_k (outdoor)”, and others), compared against baselines like “groundtruth”, “res101”, and “midas_v21”. These visualizations demonstrate the model's superior performance in estimating depth from a single RGB image of an indoor scene S (e.g., a room with furniture, ladders, and objects), highlighting smooth transitions, edge preservation, and accurate disparity recognition.

FIG. 12B provides a flowchart of an exemplary method for creating, training, evaluating, optimizing, and deploying the monocular depth estimation model 1000. Method 1000 having sequential steps (1010 through 1045) executed by one or more computing systems 100, 201, including processors, memory, storage devices, and access to cloud-based resources for handling large-scale data processing. Machine learning frameworks such as PyTorch or TensorFlow are employed to implement the neural networks. System 1000 may interface with databases, APIs, and cloud storage for data ingestion and model deployment.

The present disclosure overcomes the challenges above by employing TreisD's proprietary 3D datasets 321, accumulated over decades, which encompasses ground truth images from specialized systems such as legacy Nimslo 3D 327, Autotrak3D 326, Nidek 3D medical imaging 324, 3D earth observation platforms 325, and commercial 3D 322 collections.

The 3DGPT model 300 adapts principles from large language models (LLMs) to visual domains, forming an LVM specialized in dimensional disparity recognition. By training on current and legacy 3D images, the model generates high-accuracy grayscale depth maps, as exemplified in FIG. 12C, enabling real-time applications in AR/VR, robotics, medical diagnostics, and security systems where precise depth perception is essential. 3DGPT model 300 includes multi-objective optimization with supervised, regularization, and photometric losses for scale and bias adaptation.

As illustrated in FIGS. 3A and 3B, the method 1000 initiates with data selection (Step 1015, and block 320) and data preparation (Step 1020, and block 330), proceeds to resource acquisition (Step 1010) and architecture selection (Step 1025, and block 340), incorporates loss functions (Step 1030), involves training (Step 1035, and block 340), evaluation (Step 1040, and block 349), optimization (Step 1042, and block 343), and culminates in deployment (Step 1045, and step 352). These steps ensure the development of a robust 3DGPT model 300 capable of predicting depth maps with high fidelity, as demonstrated by the comparative outputs in FIG. 12C.

Step 1015: Selecting Image Data Files of 3D Dataset Featuring Ground Truth Images. Referring again to FIG. 12B, the process begins with selecting image data files from a comprehensive 3D dataset. This dataset includes TreisD's private collection of ground truth images, which serve as the foundation for training. Ground truth images are paired RGB-depth captures where depth values are accurately known, derived from custom 3D cameras and historical formats like Nimslo 3D 327 and Autotrak3D 326. Additional sources may include public datasets with depth maps such as NYU Depth v2, KITTI, and ETH3D for benchmarking, as well as synthetic data generated via tools like Blender or Unity to simulate diverse scenes. Analog data, such as photographic negatives 327 from multi-view captures derive depth from disparities (stereo data), are also selected and digitized. Selection criteria prioritize diversity in scenes (e.g., indoor medical environments, outdoor earth observations) to enhance model generalization.

Step 1020: Preparing Image Data Files of 3D Dataset Featuring Ground Truth Images. Data preparation 330 as shown in FIG. 12A, involves analog scanning/normalization 334, preprocessing 332, cleaning, and structuring the selected datasets for efficient model training. This step develops data pipelines and extract-transform-load (ETL) processes to handle structured and unstructured data from various sources, including databases, APIs, and cloud storage.

A. Collection and Organization: RGB images are paired with grayscale depth maps. For instances lacking direct depth, disparities from stereo or multi-view images are computed to derive depths. Synthetic scenes with known depths augment the dataset, while analog negatives are scanned and normalized for digital compatibility.

B. Preprocessing: RGB images are normalized by scaling pixel values to [0, 1] or [−1, 1]. Depth maps are scaled to [0, 1] for relative representation or retained in metric units (e.g., meters). Data augmentation applies transformations like cropping, resizing, flipping, and color jittering to increase diversity. Multi-view images are aligned using feature matching to ensure consistency.

C. Train/Test Split: The dataset is partitioned into training data set 341, validation dat sets, and test data sets 342 (e.g., 80%/10%/10%), with stratification to maintain scene diversity across splits. This preparation ensures the data is optimized for large-scale processing, directly supporting the high-accuracy outputs visualized in FIG. 12C.

Step 1010: Acquiring Processing Power to Process Large Image Model Data. To handle the computational demands of training on extensive datasets, this step acquires necessary processing resources, as depicted in block 346, 347, and FIG. 1. This may involve provisioning GPU clusters, cloud-based accelerators (e.g., via AWS, GCP, or Azure), or distributed computing frameworks deployed on a distributed computing system to process large image datasets, optimizing for real-time subsurface imaging for 3DGPT model. Resource allocation is scaled based on dataset size and model complexity, ensuring efficient handling of high-resolution images and batch processing without bottlenecks. As well as optimizing 3DGPT model for deployment by acquiring processing power sufficient to handle large-scale proprietary datasets during monocular depth estimation.

Step 1025: Selecting an Architecture(s) to Generate an Accurate Monocular Depth Estimation of a 2D Image. FIG. 12B highlights the selection of neural network architectures 346, 347, and FIG. 1 suited for monocular depth estimation, drawing from machine learning, deep learning, natural language processing (NLP), and computer vision techniques for 3D stereoscopic imaging.

Monocular depth map generation is performed utilizing different methods, however more specifically depth map estimate may be performed as set forth in René Ranftl et al., Towards Robust Monocular Depth Estimation: Mixing Datasets for Zero-shot Cross-dataset Transfer, 44 IEEE Trans. Pattern Analysis & Machine Intelligence 1623 (2022) incorporated herein in its entirety by reference.

Method 300 for robust monocular depth estimation from a single input image of scene S, comprising training 340 a deep neural network model 346 on a diverse mixture of datasets 321 to predict disparity maps that are invariant to variations in depth range, scale, and shift. In one embodiment, method 300 involves preprocessing multiple complementary training datasets 321, each providing RGB images paired with ground-truth depth annotations in varying forms, such as absolute depth from RGB-D sensors, relative depth from structure-from-motion (SfM) reconstructions, or disparity from stereo pairs with unknown calibrations, which encompasses ground truth images from specialized systems such as legacy Nimslo 3D 327, Autotrak3D 326, Nidek 3D medical imaging 324, 3D earth observation platforms 325, and commercial 3D 322 collections. To address incompatibilities among datasets, neural network 300 may be configured to output predictions in disparity space (inverse depth up to unknown scale and shift), enabling unified training across sources like indoor RGB-D collections (e.g., DIML Indoor), SfM-based outdoor scenes (e.g., MegaDepth), web-sourced stereo videos (e.g., WSVD), curated stereo datasets (e.g., ReDWeb), and a novel dataset derived from 3D stereoscopic films. The 3D movie dataset is extracted by selecting high-quality films shot with physical stereo cameras, preprocessing frames to remove artifacts, and computing disparity maps via optical flow algorithms with left-right consistency checks and sky region masking to ensure reliable relative depth ground truth.

The training process 354 employs a scale- and shift-invariant loss function to handle ambiguities in ground-truth representations, wherein predictions and ground truth are aligned using estimators for scale and translation, such as least-squares fitting for mean-squared error variants or robust median-based alignment for absolute error or trimmed residuals to mitigate outliers from imperfect annotations. A regularization term, adapted from multi-scale gradient matching in disparity space, is incorporated to enforce sharp discontinuities aligned with ground-truth edges. Dataset mixing is optimized via either a naive uniform sampling strategy or a principled multi-objective optimization approach that seeks Pareto-optimal solutions across tasks defined by each dataset, ensuring balanced learning without dominance by any single source's biases. The neural network 300 architecture utilizes a high-capacity encoder, such as a ResNet-based model pretrained on auxiliary tasks like ImageNet classification, coupled with a multi-scale decoder to regress dense disparity maps. Pretraining 332 enhances generalization, and the model is fine-tuned using stochastic optimization (e.g., Adam) on minibatches drawn from the mixed datasets. Encoder optimized loss functions invariant to depth range, scale, and biases, including supervised losses, regularization losses, and photometric losses.

In operation, for depth map estimation, the trained model 300 receives a monocular RGB image as input and directly regresses a disparity map, which can be converted to a depth map if metric scale is available or desired. The method 300 demonstrates superior zero-shot cross-dataset transfer, evaluating performance on unseen datasets (e.g., DIW, ETH3D, Sintel, KITTI, NYUDv2, TUM-RGBD) without fine-tuning, outperforming prior art in accuracy and robustness across diverse environments including indoor, outdoor, static, and dynamic scenes. This approach mitigates limitations of individual datasets, such as sparse annotations or environmental biases, by leveraging their complementary strengths, thereby providing a scalable and generalizable solution for applications in computer vision, robotics, security, and augmented reality.

A. Encoder-Decoder Architecture: The encoder (e.g., ResNet, EfficientNet, or MobileNet) extracts features from the input RGB image, while the decoder up-samples these to produce dense depth maps. Encoder-decoder optimized loss functions invariant to depth range, scale, and biases, including supervised losses, regularization losses, and photometric losses. Moreover, encoder-decoder neural network processes single 2D RGB image through transformer layers to infer depth disparities for the 3D depth map 1220B.

B. Variants: U-Net with skip connections preserves spatial details; attention mechanisms focus on relevant regions; multi-scale supervision predicts depths at varying resolutions for robust learning.

C. Multi-View Integration: Reprojection losses and epipolar geometry constraints enforce consistency across views, comparing predicted depths against ground truth disparities.

These architectures are chosen to optimize for pixel-wise accuracy, as evidenced by the refined depth maps in FIG. 12C (e.g., “dpt_hybrid_384 (Midas 3.0)” outperforming baselines).

Step 1030: Incorporating a Combination of Loss Functions to Ensure Robust Training. A multifaceted loss framework is incorporated, as shown in FIG. 12B, to guide training effectively.

Supervised Loss: L1/L2 differences between predicted and ground truth depths; scale-invariant losses for relative disparities.

Regularization Loss: Edge-aware smoothness encourages gradual transitions while preserving edges.

Photometric Loss: For multi-view data, minimizes differences between reprojected and original images.

This combination ensures the model's robustness, contributing to the high-accuracy estimations in FIG. 12C.

Step 1035: Training the Model (Three Dimensional Generative Pre-Trained Transformer 300 to generate an accurate monocular depth estimation of a 2D Image). Training 340 utilizes frameworks like PyTorch, TensorFlow, or Keras, as illustrated in FIG. 12A, 346 trained using a combination of loss functions, including mean absolute error and structural similarity index, and evaluating 3DGPT model using metrics such as absolute relative error and root mean squared error during training on proprietary datasets, to ensure robust monocular depth estimation.

Distributed and elastic deep learning, 347.

Iterate 348.

Hyperparameters 343, 345: Learning rate starts at 1e-4; batch size maximizes GPU capacity; optimizers include Adam or AdamW. Search and Optimization 343. Network models 343.

Training Strategy: Supervised on single images with depth losses; multi-view with reprojection and photometric losses.

Data Augmentation: Real-time applications of flipping, cropping, and brightness adjustments.

The 3DGPT model 300 may be iteratively refined to predict accurate depth maps from 2D inputs.

Step 1040: Evaluating Metrics of the Model. Evaluation, per FIG. 12B, assesses performance on test sets.

Depth Accuracy: RMSE, Absolute Relative Difference, Log 10 error.

Qualitative: Visualization of depth maps (as in FIG. 12C) for perceptual quality.

Robustness: Testing on unseen scenes for generalization.

Step 1042: Optimizing Model 354. Optimization fine-tunes for inference, as shown in FIG. 12B: quantization and pruning reduce model size; export to ONNX for portability. Domain-specific fine-tuning adapts for tasks like anti-counterfeit imaging.

Step 1045: Deploying Model 352. Deployment integrates the model into production, using cloud platforms, containerization (Docker, Kubernetes), and APIs for real-time systems in AR/VR, robotics, medical imaging, cybersecurity, or observation applications.

Tools and Resources. Datasets include TreisD ground truth images 321 featuring key subjects, foreground objects, and background elements to enhance accuracy in monocular depth estimation, NYU Depth v2, KITTI, ETH3D. Frameworks: PyTorch, TensorFlow, JAX. Libraries: OpenCV, torchvision, albumentations.

Embodiments may incorporate NLP for multimodal inputs. Hardware includes GPUs for training and edge devices for inference.

In block or step 1220C, computer system 10 via interlay(ing) application program(s) 624 is configured overlay 2D RGB high resolution digital camera (broad image of terrain or sets of image sections as tiles or stitched tiles) thereon 3D model or mesh surface of terrain T of scene S from LIDAR digital elevation model to generate 3D model or mesh surface of terrain T of scene S with RGB high resolution color (3D color mesh Dataset).

In block or step 1220A, computer system 10 via key subject, application program(s) 624 is configured to identify a key subject KS point in 3D color mesh Dataset. Moreover, computer system 10 via key subject, application program(s) 624 is configured to identify (ing) at least in part a pixel, set of pixels (finger point selection on display 628) in 3D color mesh Dataset as key subject KS having a subsurface anomaly, point of interest, or feature likely to change over time for monitoring purposes.

In block or step 1225, computer system 10 via frame establishment program(s) 624 is configured to create or generate frames, recording of images of 3D color mesh Dataset from a virtual camera shifting, rotation, or arcing position, such as such as 0.5 to 1 degree of separation or movement between frames, such as −5, −4, −3, −2, −1, 0, 1, 2, 3, 4, 5; for DIFY represented 1101, 1102, 1103, 1104 (set of frames, series of digital image datasets 1100) of 3D color mesh Dataset of terrain T of scene S to generate parallax; for 3D Stereo as left and right; 1102, 1103 images of 3D color mesh Dataset as digital model 1220D. Computer system 10 via key subject, application program(s) 624 may establish increments, of shift for example one (1) degree of total shift between the views (typically 10-70 pixel shift on display 628). This simply means a complete sensor (capture device) rotation of 360 degrees around key subject KS would have 360 views so we are only using/need view 1 and view 2, for 3D Stereo as left and right; 1102, 1103 images of 3D color mesh Dataset. This gives us 1 degree of separation/disparity for each view assuming rotational parallax orbiting around a key subject (zero parallax point). This will likely establish a minimum disparity/parallax that can be adjusted up as the sensor (image capture module 830) moves farther away from key subject KS.

For example, key subject KS point may be identified in 3D color mesh Dataset 3D space and virtual camera orbits or moves in an arcing direction about key subject KS point to generate images of 3D color mesh Dataset of terrain T of scene S at total distance or degree of rotation to generate frames of 3D color mesh Dataset of terrain T of scene S (set of frames, series of digital image datasets 1100). This creates parallax between any objects in the foreground or closest point CP associated with near plane NP and background or far plane FP or furthest point associated with a far plane FP of terrain T of scene S relative to key subject KS point. The objects closer to key subject KS point do not move as much as objects further away from key subject KS point (as virtual camera orbits or moves in an arcing direction about key subject KS). The degree separated for virtual camera correspond to the angles subtend by the human visual system, i.e., the interpupillary distance (IPD).

In block or step 1225A, computer system 10 via frame establishment program(s) 624 is configured to input or upload source images captured external from computer system 10.

In block or step 1230, computer system 10 via horizontal image translation (HIT) program(s) 624 is configured to align 3D frame Dataset horizontally about key subject KS point (digital pixel) (horizontal image translation (HIT) as shown in 11A and 11B with key Subject KS point within a Circle of Comfort relationship to optimize digital multi-dimensional image sequence 1010 or for the human visual system.

Moreover, a key subject KS point is identified in 3D frame dataset 1100, and each of the set of frames, series of digital image datasets 1100 is aligned to key subject KS point, and all other points in the set of frames 1100 shift based on a spacing of the virtual camera shifting, rotation, or arcing position.

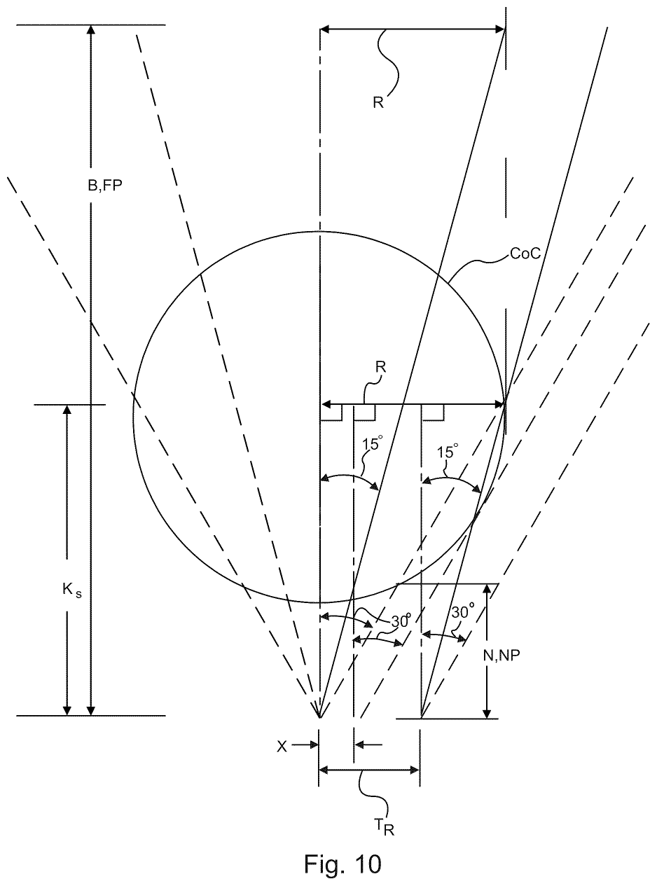

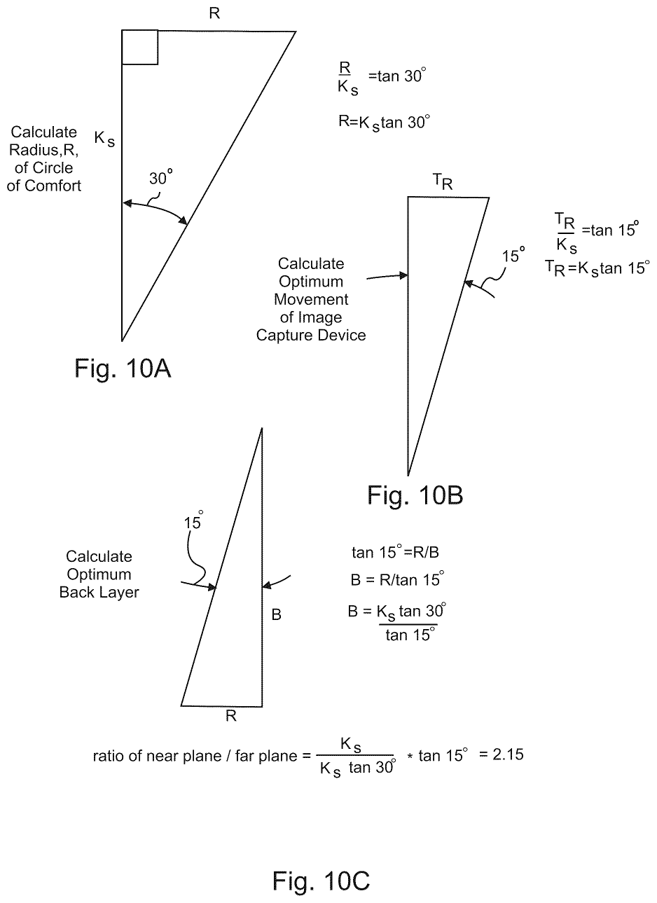

Referring now to FIG. 10, there is illustrated by way of example, and not limitation a representative illustration of Circle of Comfort (CoC) in scale with FIGS. 4 and 3. For the defined plane, the image captured on the lens plane will be comfortable and compatible with human visual system of user U viewing the final image displayed on display 628 if a substantial portion of the image(s) are captured within the Circle of Comfort (CoC) by a virtual camera. Any object, such as near plane N, key subject plane KSP, and far plane FP captured by virtual camera (interpupillary distance IPD) within the Circle of Comfort (CoC) will be in focus to the viewer when reproduced as digital multi-dimensional image sequence viewable on display 628. The back-object plane or far plane FP may be defined as the distance to the intersection of the 15 degree radial line to the perpendicular in the field of view to the 30 degree line or R the radius of the Circle of Comfort (CoC). Moreover, defining the Circle of Comfort (CoC) as the circle formed by passing the diameter of the circle along the perpendicular to Key Subject KS plane (KSP) with a width determined by the 30 degree radials from the center point on the lens plane, image capture module 830.

Linear positioning or spacing of virtual camera (interpupillary distance IPD) on lens plane within the 30 degree line just tangent to the Circle of Comfort (CoC) may be utilized to create motion parallax between the plurality of images when viewing digital multi-dimensional image sequence viewable on display 628, will be comfortable and compatible with human visual system of user U.

Referring now to FIGS. 10A, 10B, 10C, and 11, there is illustrated by way of example, and not limitation right triangles derived from FIG. 10. All the definitions are based on holding right triangles within the relationship of the scene to image capture. Thus, knowing the key subject KS distance (convergence point) we can calculate the following parameters.

FIG. 6A to calculate the radius R of Comfort (CoC).

$$R / KS = tan 30 degree$$

$$R = KS * tan 30 degree$$

FIG. 6B to calculate the optimum distance between virtual camera (interpupillary distance IPD).

$$TR / KS = tan 15 degree$$

$$TR = KS * tan 15 degree ; and IPD is 2 * TR$$

FIG. 6C calculate the optimum far plane FP

$$Tan 15 degree = R / B$$

$$B = ( KS * tan 30 degree ) / tan 15 degree$$

$$Ratio of near plane NP to far plane FP = ( ( KS / ( KS 8 tan 30 degree ) ) * tan 15 degree$$

In order to understand the meaning of TR, point on the linear image capture line of the lens plane that the 15 degree line hits/touches the Comfort (CoC). The images are arranged so the key subject KS point is the same in all images captured via virtual camera.

A user of virtual camera composes the scene S and moves the virtual camera in our case so the circle of confusion conveys the scene S. Since virtual camera is capturing images linearly spaced or arced there is a binocular disparity between the plurality of images or frames captured by virtual camera. This disparity can be changed by changing virtual camera settings or moving the key subject KS back or away from virtual camera to lessen the disparity or moving the key subject KS closer to virtual camera to increase the disparity. Our system is a virtual moving in linear or arc over model MD.

Key subject KS may be identified in each plurality of images of 3D frame dataset 1100 corresponds to the same key subject KS of terrain T of scene S as shown in FIGS. 11A, 11B, and 4. It is contemplated herein that a computer system 10, display 628, and application program(s) 624 may perform an algorithm or set of steps to automatically identify subject KS therein set of frames 1100. Alternatively, in block or step 1220A, utilizing computer system 10, (in manual mode), display 628, and application program(s) 624 settings to at least in part enable a user U to align(ing) or edit alignment of a pixel, set of pixels (finger point selection), key subject KS point of set of frames 1100.

It is recognized herein that step 1220, computer system 10 via dataset capture application 624, dataset manipulation application 624, dataset display application 624 may be performed utilizing distinct and separately located computer systems 10, such as one or more user systems 720, 722, 724 and application program(s) 624. For example, using a dataset manipulation system remote from dataset capture system, and remote from dataset viewing system, step 1220 may be performed remote from scene S via computer system 10 (third processor) and application program(s) 624 communicating between user systems 720, 222, 224 and application program(s) 624. Next, via communications link 740 and/or network 750, or 5G computer systems 10 (third processor) and application program(s) 624 via more user systems 720, 722, 724 may receive set of frames 1100 relative to key subject KS point and transmit a manipulated plurality of digital multi-dimensional image sequence (DIFY) and 3D stereo images of scene S to computer system 10 (first processor) and application program(s) 624.

Furthermore, in block or step 1230, computer system 10 via horizontal image translation (HIT) program(s) creates a point of certainty, key subject KS point by performing a horizontal image shift of set of frames 1100 as 3D HIT images, whereby set of frames 1100 overlap at this one point, as shown in FIG. 13. This image shift does two things, first it sets the depth of the image. All points in front of key subject KS point are closer to the observer and all points behind key subject KS point are further from the observer.

Moreover, in an auto mode computer system 10 via image manipulation application may identify the key subject KS based on a depth map dataset in step 1220B.

Horizontal image translation (HIT) sets the key subject plane KSP as the plane of the screen from which the scene emanates (first or proximal plane). This step also sets the motion of objects, such as near plane NP (third or near plane) and far plane FP (second or distal plane) relative to one another. Objects in front of key subject KS or key subject plane KSP move in one direction (left to right or right to left) while objects behind key subject KS or key subject plane KSP move in the opposite direction from objects in the front. Objects behind the key subject plane KSP will have less parallax for a given motion.

In the example of FIGS. 11, 11A and 111B, each layer of set of frames 1100 includes the primary image element of input file images of scene S, such as 3D image or frame 1101, 1102, 1103 and/or 1104. Horizontal image translation (HIT) program(s) 624, performs a process to translate image or frame 1101, 1102, 1103 and 1104 image or frame 1101, 1102, 1103 and 1104 is overlapping and offset from the principal axis 1112 by a calculated parallax value, (horizontal image translation (HIT). Parallax line 1107 represents the linear displacement of key subject KS points 1109.1-1109.4 (digital pixel point) from the principal axis 1112. Preferably delta 1120 between the parallax line 1107 represents a linear amount of the parallax 1120, such as front parallax 1120.2 and back parallax 1120.1.

Calculate parallax, minimum parallax and maximum parallax as a function of number of pixel, pixel density and number of frames, and closest and furthest points, and other parameters as set U.S. Pat. Nos. 9,992,473, 10,033,990, and 10,178,247, incorporated herein by reference in their entirety.

In block or step 1235, utilizing computer system 10 via horizontal and vertical frame DIF translation application 624 may be configured to perform a dimensional image format (DIF) transform of 3D HIT dataset to a 3D DIF images. The DIF transform is a geometric shift that does not change the information acquired at each point in the source image, D set of frames 1100 but can be viewed as a shift of all other points in the source image, D set of frames 1100, in Cartesian space (illustrated in FIG. 11). As a plenoptic function, the DIF transform is represented by the equation:

$${P}^{′} ( u , v ) \times {P}^{′} ( θ , φ ) = [ {P}_{u , v} + {Δ}_{u , v} ] \times [ {P}_{θ , φ} + {Δ}_{θ , φ} ]$$

Where Δ u, v=Δ θ, φ

In the case of a digital image source, the geometric shift corresponds to a geometric shift of pixels which contain the plenoptic information, the DIF transform then becomes:

$${( Pixel )}_{x , y} = {( Pixel )}_{x , y} + {Δ}_{x , y}$$

Moreover, computer system 10 via horizontal and vertical frame DIF translation application 624 may also apply a geometric shift to the background and or foreground using the DIF transform. The background and foreground may be geometrically shifted according to the depth of each relative to the depth of the key subject KS identified by the depth map 1220B of the source image, set of frames 1100. Controlling the geometrical shift of the background and foreground relative to the key subject KS controls the motion parallax of the key subject KS. As described, the apparent relative motion of the key subject KS against closest point CP, and furthest point FP provides the observer with hints about its relative distance. In this way, motion parallax is controlled to focus objects at different depths in a displayed scene to match vergence and stereoscopic retinal disparity demands to better simulate natural viewing conditions. By adjusting the focus of key subjects KS in a scene to match their stereoscopic retinal disparity (an intraocular or interpupillary distance width IPD (distance between pupils of human visual system), the cues to ocular accommodation and vergence are brought into agreement.

Referring again to FIG. 13, viewing a DIFY, multidimensional image sequence 1000 on display 628 requires two different eye actions of user U. The first is the eyes will track the closest item, point, or object (near plane NP) in multidimensional image sequence 1000 on display 628, which will have linear translation back and forth to the stationary key subject plane KSP due to image or frame 1101, 1102, 1103 and 1104 is overlapping and offset from the principal axis 1112 by a calculated parallax value, (horizontal image translation (HIT)). This tracking occurs through the eyeball moving to follow the motion. Second, the eyes will perceive depth due to the smooth motion change of any point or object relative to the key subject plane KSP and more specifically to the key subject KS point. Thus, DIFYs are composed of one mechanical step and two eye functions.

A mechanical step of translating of the frames so the Key Subject KS point overlaps on all frames. Linear translation back and forth to the stationary key subject plane KSP due to image or frame 1101, 1102, 1103 and 1104 may be overlapping and offset from the principal axis 1112 by a calculated parallax value, (horizontal image translation (HIT). Eye following motion of near plane NP object which exhibits greatest movement relative to the key subject KS (Eye Rotation). Difference in frame position along the key subject plane KSP (Smooth Eye Motion) which introduces binocular disparity. Comparison of any two points other than key subject KS also produces depth (binocular disparity). Points behind key subject plane KSP move in opposite direction than those points in front of key subject KS. Comparison of two points in front or back or across key subject KS plane shows depth.

In block or step 1235A, computer system 10 via palindrome application 626 is configured to create, generate, or produce multidimensional digital image sequence 1010 aligning sequentially each image of set of frames 1100 in a seamless palindrome loop (align sequentially), such as display in sequence a loop of first digital image, image or frame 1101. second digital image, image or frame 1102, third digital image, image or frame 1103, fourth digital image, image or frame 1104. Moreover, an alternate sequence a loop of first digital image, image or frame 1101, second digital image, image or frame 1102, third digital image, image or frame 1103, fourth digital image, image or frame 1104, third digital image, image or frame 1103, second digital image, image or frame 1102, of first digital image, image or frame 1101-1,2,3,4,3,2,1 (align sequentially). Preferred sequence is to follow the same sequence or order in which images were generated set of frames 1100 and an inverted or reverse sequence is added to create a seamless palindrome loop.

It is contemplated herein that other sequences may be configured herein, including but not limited to 1,2,3,4,4,3,2,1 (align sequentially) and the like.

It is contemplated herein that horizontally and vertically align(ing) of first proximal plane, such as key subject plane KSP of each set of frames 1100 and shifting second distal plane, such as such as foreground plane, Near Plane NP, or background plane, Far Plane FP of each subsequent image frame in the sequence based on the depth estimate of the second distal plane for series of 2D images of the scene to produce second modified sequence of 2D images.

Furthermore, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. Second process DIF 1235A, import frames, such as one degree (1°) sequence of frames from rotation of three dimensional volumetric model MD, such as −8 −7 −6 −5 −4 −3 −2 −1 0 1 2 3 4 5 6 7 8 (palindrome loop of frames) into PHOTOSHOP, an image editing tool, or the like. Note alignment points are already selected in the previous steps. Create animation timeline in PHOTOSHOP and add frames in sequence, such as one degree (1°) sequence of frames from rotation of three dimensional volumetric model MD, such as −8 −7 −6 −5 −4 −3 −2 −1 0 1 2 3 4 5 6 7 8 to time line. Set frame duration in PHOTOSHOP to approximately 0.08-0.12 seconds per frame, other time frames may be utilized to produce different speed DIF. Set repeat of frames in palindrome loop to forever or repeat (DIF).

In block or step 1235B, computer system 10 via interphasing application 626 may be configured to interphase columns of pixels of each set of frames 1100, specifically as left image 1102 and right image 1103 to generate a multidimensional digital image aligned to the key subject KS point and within a calculated parallax range. As shown in FIG. 16A, interphasing application 626 may be configured to takes sections, strips, rows, or columns of pixels from left image 1102 and right image 1103, such as column 1602A of the source images, left image 1102, and right image 1103 of terrain T of scene S and layer them alternating between column 1602A of left image 1102—LE, and column 1602A of right image 1103—RE and reconfigures or lays them out in series side-by-side interlaced, such as in repeating series 160A two columns wide, and repeats this configuration for all layers of the source images, left image 1102 and right image 1103 of terrain T of scene S to generate multidimensional image 1010 with column 1602A dimensioned to be one pixel 1550 wide.

It is contemplated herein that source images, plurality of images of scene S captured by capture device(s) 830 match size and configuration of display 628 aligned to the key subject KS point and within a calculated parallax range.

Furthermore, in block or step 855 and FIG. 12 step 1220, modifying industry standard format of a Digital Imaging and Communications in Medicine (DICOM) image files, datasets, or slices SL of the specimen via capture device(s) 830, a series of cross-sections of the body including bones, blood vessels, and soft tissue as shown in FIGS. 4A1, 4A2, 4A3, and 4A4. Second process stereo pair 1235A, import frames, such as one degree (1°) sequence of frames from rotation of three dimensional volumetric model MD, such as −8 −7 −6 −5 −4 −3 −2 −1 0 1 2 3 4 5 6 7 8 (palindrome loop of frames) into PHOTOSHOP, an image editing tool, or the like. Note alignment points are already selected in the previous steps. Select stereo pair from Stereo Pair Frames column from, for example, −8 −7 −6 −5 −4 −3 −2 −1 0 1 2 3 4 5 6 7 8 based on chart in FIG. 8D2 for a body part identified in column ROI having parallax in column Parallax total.

In block or step 1240, computer system 10 via dataset editing application 624 is configured to crop, zoom, align, enhance, select density layers, or perform edits thereto set of frames 1100.

Moreover, computer system 10 and editing application program(s) 624 may enable user U to perform frame enhancement, layer enrichment, animation, feathering (smooth), (Photoshop or Acorn photo or image tools), to smooth or fill in the images (n) together, or other software techniques for producing 3D effects on display 628. It is contemplated herein that a computer system 10 (auto mode), display 628, and application program(s) 624 may perform an algorithm or set of steps to automatically or enable automatic performance of align(ing) or edit(ing) alignment of a pixel, set of pixels of key subject KS point, crop, zoom, align, enhance, or perform edits of set of frames 1100 or edit multidimensional digital image or image sequence 1010.

Alternatively, in block or step 1240, utilizing computer system 10, (in manual mode), display 628, and editing application program(s) 624 settings to at least in part enable a user U to align(ing) or edit(ing) alignment of a pixel, set of pixels of key subject KS point, crop, zoom, align, enhance, or perform edits of set of frames 1100 or edit multidimensional digital image or image sequence 1010.

Furthermore DIFY, user U via display 628 and editing application program(s) 624 may set or chose the speed (time of view) for each frame and the number of view cycles or cycle forever as shown in FIG. 13. Time interval may be assigned to each frame in multidimensional digital image sequence 1010. Additionally, the time interval between frames may be adjusted at step 1240 to provide smooth motion and optimal 3D viewing of multidimensional digital image sequence 1010.

It is contemplated herein that a computer system 10, display 628, and application program(s) 624 may perform an algorithm or set of steps to automatically or manually edit or apply effects to set of frames 1100. Moreover, computer system 10 and editing application program(s) 206 may include edits, such as frame enhancement, layer enrichment, feathering, (Photoshop or Acorn photo or image tools), to smooth or fill in the images (n) together, and other software techniques for producing 3D effects to display 3-D multidimensional image of terrain T of scene S thereon display 628.

Now given the multidimensional image sequence 1010, we move to observe the viewing side of the device. Moreover, in block or step 735, computer system 10 via output application 730 (206) may be configured to display multidimensional image(s) 1010 on display 628 for one more user systems 220, 222, 224 via communications link 240 and/or network 250, or 5G computer systems 10 and application program(s) 206.

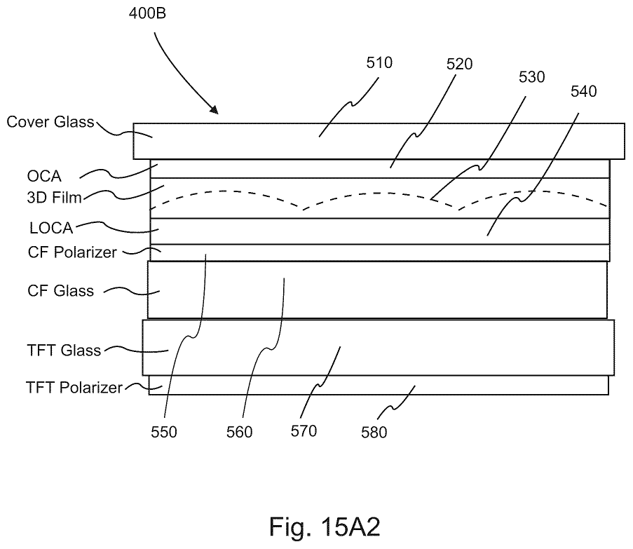

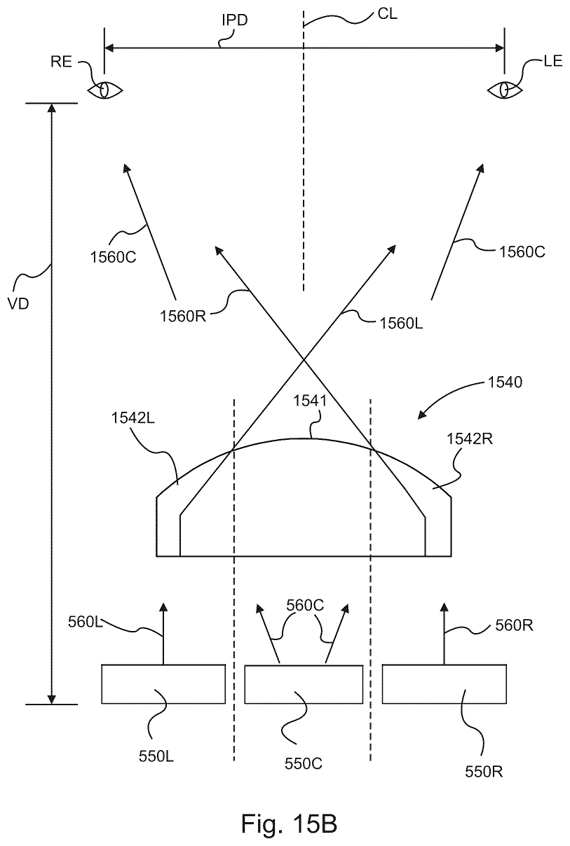

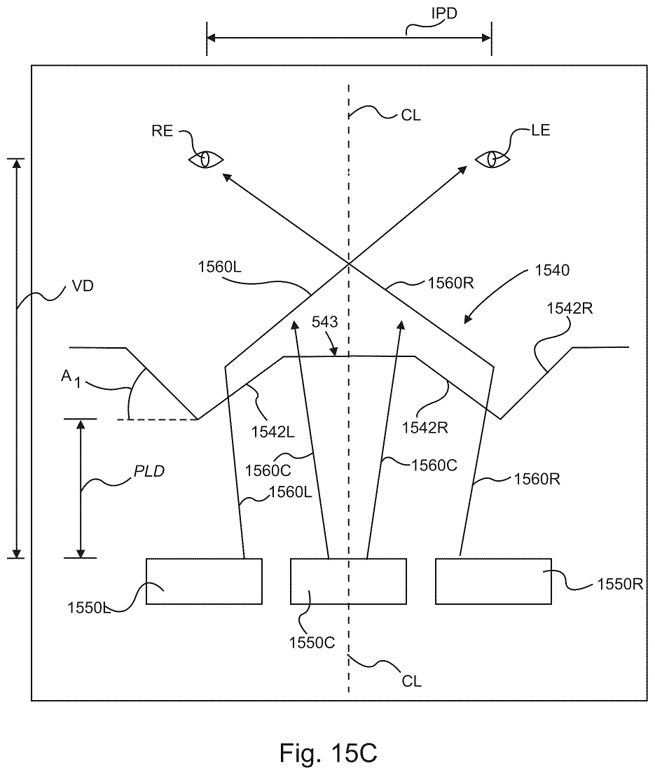

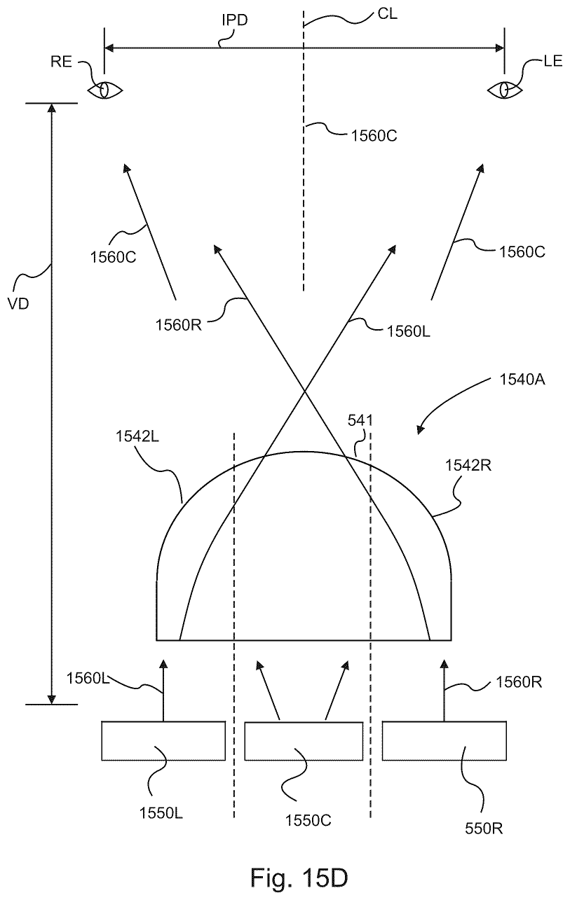

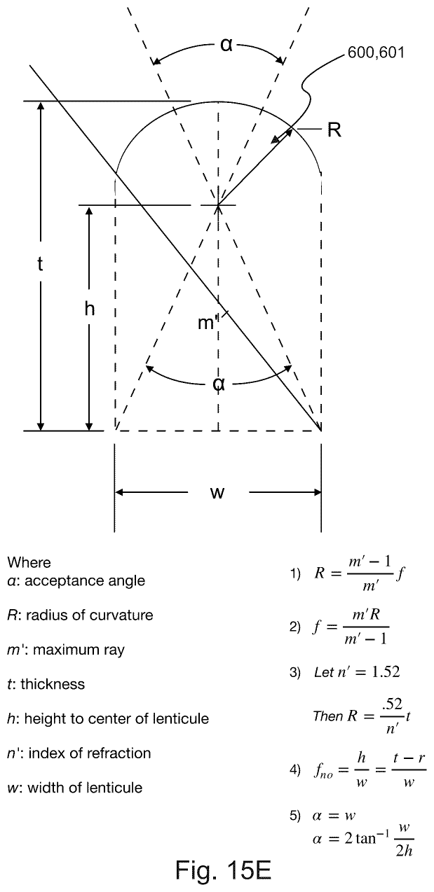

For 3D Stereo, referring now to FIG. 15A, there is illustrated by way of example, and not limitation a cross-sectional, layer, at least one layer view of an exemplary stack up of components of display 628. Display 628 may include an array of or plurality of pixels emitting light, such as LCD panel stack of components 1520 having electrodes, such as front electrodes and back electrodes, polarizers, such as horizontal polarizer and vertical polarizer, diffusers, such as gray diffuser, white diffuser, and backlight to emit red R, green G, and blue B light. Moreover, display 628 may include other standard LCD user U interaction components, such as top glass cover 1510 with capacitive touch screen glass 1512 positioned between top glass cover 1510 and LCD panel stack components 1520. It is contemplated herein that other forms of display 628 may be included herein other than LCD, such LED, ELED, PDP, QLED, and other types of display technologies. Furthermore, display 628 may include a lens array, such as lenticular lens 1514 preferably positioned between capacitive touch screen glass 1512 and LCD panel stack of components 1520, and configured to bend or refract light in a manner capable of displaying an interlaced stereo pair of left and right images as a 3D or multidimensional digital image(s) 1010 on display 628 and, thereby displaying a multidimensional digital image of scene S derived from 3D depth map on display 628 reducing mismatches in vergence and accommodation. Transparent adhesives 1530 may be utilized to bond elements in the stack, whether used as a horizontal adhesive or a vertical adhesive to hold multiple elements in the stack. For example, to produce a 3D view or produce a multidimensional digital image on display 628, a 1920×1200 pixel image via a plurality of pixels needs to be divided in half, 960×1200, and either half of the plurality of pixels may be utilized for a left image and right image.

It is contemplated herein that lens array may include other techniques to bend or refract light, such as barrier screen (black line), lenticular, parabolic, overlays, waveguides, black line and the like capable of separate into a left and right image.

It is further contemplated herein that lenticular lens 514 may be orientated in vertical columns when display 628 is held in a landscape view to produce a multidimensional digital image on display 628. However, when display 628 is held in a portrait view the 3D effect is unnoticeable enabling 2D and 3D viewing with the same display 628.

It is still further contemplated herein that smoothing, or other image noise reduction techniques, and foreground subject focus may be used to soften and enhance the 3D view or multidimensional digital image on display 628.

Referring now to FIG. 15B, there is illustrated by way of example, and not limitation a representative segment or section of one embodiment of exemplary refractive element, such as lenticular lens 1514 of display 628. Each sub-element of lenticular lens 1514 being arced or curved or arched segment or section 1540 (shaped as an arc) of lenticular lens 1514 may be configured having a repeating series of trapezoidal lens segments or plurality of sub-elements or refractive elements. For example, each arced or curved or arched segment 1540 may be configured having lens peak 1541 of lenticular lens 1540 and dimensioned to be one pixel 1550 (emitting red R, green G, and blue B light) wide such as having assigned center pixel 1550C thereto lens peak 1541. It is contemplated herein that center pixel 1550C light passes through lenticular lens 1540 as center light 1560C to provide 2D viewing of image on display 628 to left eye LE and right eye RE a viewing distance VD from pixel 1550 or trapezoidal segment or section 1540 of lenticular lens 1514. Moreover, each arced or curved segment 1540 may be configured having angled sections, such as lens angle AI of lens refractive element, such as lens sub-element 1542 (plurality of sub-elements) of lenticular lens 1540 and dimensioned to be one pixel wide, such as having left pixel 1550L and right pixel 1550R assigned thereto left lens, left lens sub-element 1542L having angle A1, and right lens sub-element 1542R having angle A1, for example an incline angle and a decline angle respectively to refract light across center line CL. It is contemplated herein that pixel 1550L/R light passes through lenticular lens 1540 and bends or refracts to provide left and right images to enable 3D viewing of image on display 628; via left pixel 1550L light passes through left lens angle 1542L and bends or refracts, such as light entering left lens angle 1542L bends or refracts to cross center line CL to the right R side, left image light 1560L toward left eye LE and right pixel 1550R light passes through right lens angle 1542R and bends or refracts, such as light entering right lens angle 1542R bends or refracts to cross center line CL to the left side L, right image light 1560R toward right eye RE, to produce a multidimensional digital image on display 628.

It is contemplated herein that left and right images may be produced as set forth in FIGS. 6.1-6.3 from U.S. Pat. Nos. 9,992,473, 10,033,990, and 10,178,247 and electrically communicated to left pixel 550L and right pixel 550R. Moreover, 2D image may be electrically communicated to center pixel 550C.

In this FIG. each lens peak 1541 has a corresponding left and right angled lens 1542, such as left angled lens 1542L and right angled lens 1542R on either side of lens peak 1541 and each assigned one pixel, center pixel 1550C, left pixel 1550L and right pixel 1550R, assigned respectively thereto.

In this FIG., the viewing angle AI is a function of viewing distance VD, size S of display 628, wherein A1=2 arctan (S/2VD).

In one embodiment, each pixel may be configured from a set of sub-pixels. For example, to produce a multidimensional digital image on display 628 each pixel may be configured as one or two 3×3 sub-pixels of LCD panel stack components 1520 emitting one or two red R light, one or two green G light, and one or two blue B light therethrough segments or sections of lenticular lens 1540 to produce a multidimensional digital image on display 628. Red R light, green G light, and blue B may be configured as vertical stacks of three horizontal sub-pixels.

It is recognized herein that trapezoid shaped lens 1540 bends or refracts light uniformly through its center C, left L side, and right R side, such as left angled lens 1542L and right angled lens 1542R, and lens peak 1541.

Referring now to FIG. 15C, there is illustrated by way of example, and not limitation a prototype segment or section of one embodiment of exemplary lenticular lens 1514 of display 628. Each segment or plurality of sub-elements or refractive elements being trapezoidal shaped segment or section 1540 of lenticular lens 1514 may be configured having a repeating series of trapezoidal lens segments (plurality of trapezoid sections). For example, each trapezoidal segment 1540 may be configured having lens peak 1541 of lenticular lens 1540 and dimensioned to be one or two pixel 1550 wide and flat section or straight lens, such as lens valley 1543 and dimensioned to be one or two pixel 1550 wide (emitting red R, green G, and blue B light). For example, lens valley 1543 may be assigned center pixel 1550C. It is contemplated herein that center pixel 1550C light passes through lenticular lens 1540 as center light 1560C to provide 2D viewing of image on display 628 to left eye LE and right eye RE a viewing distance VD from pixel 1550 or trapezoidal segment or section 1540 of lenticular lens 1514. Moreover, each trapezoidal segment 1540 may be configured having angled sections, such as lens angle 1542 of lenticular lens 1540 and dimensioned to be one or two pixel wide, such as having left pixel 1550L and right pixel 1550R assigned thereto left lens angle 1542L and right lens angle 1542R, respectively. It is contemplated herein that pixel 1550L/R light passes through lenticular lens 1540 and bends to provide left and right images to enable 3D viewing of image on display 628; via left pixel 1550L light passes through left lens angle 1542L and bends or refracts, such as light entering left lens angle 1542L bends or refracts to cross center line CL to the right R side, left image light 1560L toward left eye LE; and right pixel 1550R light passes through right lens angle 1542R and bends or refracts, such as light entering right lens angle 1542R bends or refracts to cross center line CL to the left side L, right image light 1560R toward right eye RE to produce a multidimensional digital image on display 628.

It is contemplated herein that angle AI of lens angle 1542 is a function of the pixel 1550 size, stack up of components of display 628, refractive properties of lenticular lens 514, and distance left eye LE and right eye RE are from pixel 1550, viewing distance VD.

In this FIG. 15C, the viewing angle AI is a function of viewing distance VD, size S of display 628, wherein A1=2 arctan (S/2VD).

Referring now to FIG. 15D, there is illustrated by way of example, and not limitation a representative segment or section of one embodiment of exemplary lenticular lens 1514 of display 628. Each segment or plurality of sub-elements or refractive elements being parabolic or dome shaped segment or section 1540A (parabolic lens or dome lens, shaped a dome) of lenticular lens 1514 may be configured having a repeating series of dome shaped, curved, semi-circular lens segments. For example, each dome segment 1540A may be configured having lens peak 1541 of lenticular lens 1540 and dimensioned to be one or two pixel 1550 wide (emitting red R, green G, and blue B light) such as having assigned center pixel 1550C thereto lens peak 1541. It is contemplated herein that center pixel 1550C light passes through lenticular lens 540 as center light 560C to provide 2D viewing of image on display 628 to left eye LE and right eye RE a viewing distance VD from pixel 1550 or trapezoidal segment or section 1540 of lenticular lens 1514. Moreover, each trapezoidal segment 1540 may be configured having angled sections, such as lens angle 1542 of lenticular lens 1540 and dimensioned to be one pixel wide, such as having left pixel 1550L and right pixel 1550R assigned thereto left lens angle 1542L and right lens angle 1542R, respectively. It is contemplated herein that pixel 1550L/R light passes through lenticular lens 1540 and bends to provide left and right images to enable 3D viewing of image on display 628; via left pixel 1550L light passes through left lens angle 1542L and bends or refracts, such as light entering left lens angle 1542L bends or refracts to cross center line CL to the right R side, left image light 1560L toward left eye LE and right pixel 1550R light passes through right lens angle 1542R and bends or refracts, such as light entering right lens angle 1542R bends or refracts to cross center line CL to the left side L, right image light 1560R toward right eye RE to produce a multidimensional digital image on display 628.

It is recognized herein that dome shaped lens 1540B bends or refracts light almost uniformly through its center C, left L side, and right R side.

It is recognized herein that representative segment or section of one embodiment of exemplary lenticular lens 1514 may be configured in a variety of other shapes and dimensions.

Moreover, to achieve highest quality two dimensional (2D) image viewing and multidimensional digital image viewing on the same display 628 simultaneously, a digital form of alternating black line or parallax barrier (alternating) may be utilized during multidimensional digital image viewing on display 628 without the addition of lenticular lens 1514 to the stack of display 628 and then digital form of digital form of alternating black line or parallax barrier (alternating) may be disabled during two dimensional (2D) image viewing on display 628.

A parallax barrier is a device placed in front of an image source, such as a liquid crystal display, to allow it to show a stereoscopic or multiscopic image without the need for the viewer to wear 3D glasses. Placed in front of the normal LCD, it consists of an opaque layer with a series of precisely spaced slits, allowing each eye to see a different set of pixels, so creating a sense of depth through parallax. A digital parallax barrier is a series of alternating black lines in front of an image source, such as a liquid crystal display (pixels), to allow it to show a stereoscopic or multiscopic image. In addition, face-tracking software functionality may be utilized to adjust the relative positions of the pixels and barrier slits according to the location of the user's eyes, allowing the user to experience the 3D from a wide range of positions. The book Design and Implementation of Autostereoscopic Displays by Keehoon Hong, Soon-gi Park, Jisoo Hong, Byoungho Lee incorporated herein by reference.

It is contemplated herein that parallax and key subject KS reference point calculations may be formulated for distance between virtual camera positions, interphasing spacing, display 628 distance from user U, lenticular lens 1514 configuration (lens angle A1, 1542, lens per millimeter and millimeter depth of the array), lens angle 1542 as a function of the stack up of components of display 628, refractive properties of lenticular lens 1514, and distance left eye LE and right eye RE are from pixel 1550, viewing distance VD, distance between virtual camera positions (interpupillary distance IPD), and the like to produce digital multi-dimensional images as related to the viewing devices or other viewing functionality, such as barrier screen (black line), lenticular, parabolic, overlays, waveguides, alternating digital black line and the like with an integrated LCD layer in an LED or OLED, LCD, OLED, and combinations thereof or other viewing devices.

Incorporated herein by reference is paper entitled Three-Dimensional Display Technology, pages 1-80, by Jason Geng of other display techniques or the like that may be utilized to produce display 628, incorporated herein by reference.

It is contemplated herein that number of lenses per mm or inch of lenticular lens 1540 is determined by the pixels per inch of display 628.

It is contemplated herein that other angles AI are contemplated herein, distance of pixels 1550C, 1550L, 1550R from of lens 1540 of a plurality of lenses (approximately 0.5 mm), and user U viewing distance from smart device display 628 from user's eyes (approximately fifteen (15) inches), and average human interpupilary spacing between eyes (approximately 2.5 inches) may be factored or calculated to produce digital multi-dimensional images. Governing rules of angles and spacing assure the viewed images thereon display 628 is within the comfort zone of the viewing device to produce digital multi-dimensional images, see FIGS. 5, 6, 11 below.

It is recognized herein that angle AI of lens 1541 may be calculated and set based on viewing distance VD between user U eyes, left eye LE and right eye RE, and pixels 550, such as pixels 1550C, 1550L, 1550R, a comfortable distance to hold display 628 from user's U eyes, such as ten (10) inches to arm/wrist length, or more preferably between approximately fifteen (15) inches to twenty-four (24) inches, and most preferably at approximately fifteen (15) inches.

In use, the user U moves the display 628 toward and away from user's eyes until the digital multi-dimensional images appear to user, this movement factor in user's U actual interpupilary distance IPD spacing and to match user's visual system (near sited and far sited discrepancies) as a function of width position of interlaced left and right images from distance between virtual camera positions (interpupilary distance IPD), key subject KS depth therein each of digital images(n) of scene S (key subject KS algorithm), horizontal image translation algorithm of two images (left and right image) about key subject KS, interphasing algorithm of two images (left and right image) about key subject KS, angles A1, distance of pixels 1550 from of lens 1540 of a plurality of lenses (pixel-lens distance (PLD) approximately 0.5 mm)) and refractive properties of lens array, such as trapezoid shaped lens 1540 all factored in to produce digital multi-dimensional images for user U viewing display 628. First known elements are number of pixels 1550 and number of images, two image, distance between virtual camera positions, or (interpupilary distance IPD). Images captured at or near interpupilary distance IPD matches the human visual system, simplifies the math, minimizes cross talk between the two images, fuzziness, image movement to produce digital multi-dimensional image viewable on display 628.

It is further contemplated herein that trapezoid shaped lens 1540 may be formed from polystyrene, polycarbonate or other transparent materials or similar materials, as these material offers a variety of forms and shapes, may be manufactured into different shapes and sizes, and provide strength with reduced weight; however, other suitable materials or the like, can be utilized, provided such material has transparency and is machinable or formable as would meet the purpose described herein to produce a left and right stereo image and specified index of refraction. It is further contemplated herein that trapezoid shaped lens 1541 may be configured with 4.5 lenticular lens per millimeter and approximately 0.33 mm depth.

Referring now to FIG. 15E, similar to lens 1540 in FIG. 15D, by way of example, and not limitation, there is illustrated an example embodiment of micro-optical materials (M.O.M.), and more particularly to lenticular lens 600 profile designed for use in such materials. Micro-optical materials encompass sheets, films, or substrates incorporating arrays of micro-lenses, such as lenticular arrays, which are employed in applications including, but not limited to, 3D imaging, autostereoscopic displays, directional lighting, optical security features, and high-resolution printing. Lenticular lens 600 profile disclosed herein provides optimized optical performance through specific geometric and material parameters that enhance light directionality, acceptance angle, and focusing efficiency.

FIG. 15E illustrates a cross-sectional view of single lenticule 601 in the lenticular lens array, representing the profile for the micro-optical material (M.O.M.). The lenticule 601 may be characterized by a convex curved surface interfacing with air and a flat base integrated into the substrate. Light typically propagates through the material from the flat base toward the curved surface, or vice versa, depending on the application. The design ensures that the focal point aligns approximately with the base plane for optimal interleaving of images or light control in M.O.M. applications.

Referring to FIG. 15E, the key parameters of lenticule 601 are defined as follows:
α: The acceptance angle, which represents the maximum angular range over which incident light rays can be effectively captured and refracted by lenticule 601 without significant aberration or loss. This angle is critical for determining the viewing zone in lenticular 600 displays or the beam steering capability in optical materials.
R: The radius of curvature of the convex lenticular 601 surface. This parameter governs the refractive power of the lens and is optimized to balance focal length with manufacturability in micro-scale arrays 600.
n′: The index of refraction of lens 601 material. For exemplary purposes, n′=1.52, corresponding to common optical polymers such as polycarbonate, acrylic (PMMA), or similar transparent resins suitable for M.O.M. fabrication via extrusion, embossing, or UV-curing processes. The choice of n′ influences the bending of light rays and allows for tuning the optical properties to specific wavelengths or environmental conditions.
t: The thickness of lenticule 601, measured from the flat base to the apex of the curved surface. This dimension is typically on the order of micrometers to millimeters in M.O.M., depending on the application, and is selected to approximate the focal length for in-plane focusing.
h: The height to the center of lenticule 601, defined as the distance from the flat base to the optical center or principal plane of the lens. This parameter relates to the effective focal positioning and is used in calculating the f-number and acceptance angle.
w: The width of lenticule 601, representing the lateral pitch of lens 601 in the array. In lenticular arrays, w determines the resolution and density of the micro-optics, with smaller w enabling higher-resolution effects but requiring precise manufacturing tolerances.
m′: The maximum ray parameter, which in the context of this profile corresponds to the refractive index n′ for ray tracing purposes. (Note: In some notations, m′ is interchangeably used with n′ for maximum marginal ray calculations in paraxial approximations.)

The relationships among these parameters are governed by the following equations, derived from paraxial optics and adapted for the thick-lens 601 behavior in M.O.M., where lens 601 thickness is comparable to the focal length:

$$R = \backslash frac \{ {n}^{′} - 1 \} \{ {n}^{′} \} f$$

This equation expresses the radius of curvature R in terms of the desired focal length f and the refractive index n′. It assumes a plano-convex configuration with the curved surface as the refracting interface, accounting for light propagation within the material of index n′ into air (index 1).

$$f = \backslash frac \{ {n}^{′} R \} \{ {n}^{′} - 1 \}$$

The inverse relation provides the effective focal length f based on R and n′. This formula deviates from the standard thin-lens approximation

$$f = ∖ frac \{ R \} \{ {n}^{′} - 1 \}$$

to incorporate the effects of the material immersion and thick-lens geometry, ensuring accurate focusing at the base plane in M.O.M. 413 applications.

For a specific material with n′=1.52 (e.g., acrylic), substitute to yield

$$R = ∖ frac \{ 0.52 \} \{ 1.52 \} t \backslash approx 0.342 t$$

assuming f≈t. This condition positions the focal plane at or near the flat base, ideal for lenticular printing where interleaved images are placed on the rear surface. The factor 0.52 arises from n′−1, and the division by n′ adjusts for the internal refraction.

$$f\_ \{ no \} = ∖ frac \{ h \} \{ w \}$$

The f-number (f_{no}), a measure of the lens's light-gathering ability and depth of field, is defined as the ratio of h to w. In this profile, it characterizes the numerical aperture, with lower values indicating wider acceptance and brighter imaging. Adjustments to h and w allow tailoring the f {no} for specific M.O.M. uses, such as high-contrast displays or efficient light diffusers.

$$∖ alpha = 2 ∖ {tan}^{∧} \{ - 1 \} ∖ left ( ∖ frac \{ w \} \{ 2 h \} ∖ right )$$

The acceptance angle α is calculated using the arctangent function, representing the full angular field from the marginal rays. This equation derives from geometric ray tracing, where the half-width w/2 and height h define the tangent of the half-angle. For small angles, it approximates α≈w/h (in radians), linking directly to the f-number since f_{no}≈h/w≈1/α.

Additionally, the width w may be related to other geometric constraints, such as w=t−r, where r represents a minor adjustment factor (e.g., base offset or sagitta correction) not exceeding a small fraction of t. The sagitta (curved height) can be further approximated as

$$s ∖ approx ∖ frac \{ {( w / 2 )}^{∧} 2 \} \{ 2 R \}$$

for shallow curves, ensuring the profile remains aspheric-free for ease of replication in M.O.M.

In practice, the lenticular array 600 is fabricated by replicating this profile across a substrate, with multiple lenticules arranged in parallel rows or cylindrical fashion. Materials with n′≈1.52 are preferred for their clarity, durability, and compatibility with roll-to-roll processing. The design minimizes crosstalk between adjacent lenticules 601 by optimizing a and w, enhancing the moiré-free performance in 3D visuals.

One skilled in the art will appreciate that variations in n′, t, and w can adapt this profile for diverse M.O.M. applications, such as flexible displays, optical films for solar concentration, or security holograms. For instance, increasing R relative to t widens a for broader viewing angles, while decreasing w boosts array density for finer resolution.

It is contemplated herein that lenticular 601 shape or configuration may be arc, angled, trapezoid or any other configuration, height, and thickness.

It is further contemplated herein that lenticular lens 600 may have varying lenticular 601 spacing, or groups of spacing derived by unique proprietary cylinder to create visually complex, frequency readable, tamper-resistant Micro Optical Materials (MOMs). Such cylinder 412 and its fabrication may be customer specific and held as confidential and proprietary trade secrets.

DIFY, in block or step 1250, computer system 10 via image display application 624 is configured to set of frames 1100 of terrain T of scene S to display, via sequential palindrome loop, multidimensional digital image sequence 1010 on display 628 for different dimensions of displays 628. Again, multidimensional digital image sequence 1010 of scene S, resultant 3D image sequence, may be output as a DIF sequence or .MPO file to display 628. It is contemplated herein that computer system 10, display 628, and application program(s) 624 may be responsive in that computer system 10 may execute an instruction to size each image (n) of scene S to fit the dimensions of a given display 628.

In block or step 1250, multidimensional image sequence 1010 on display 628, utilizes a difference in position of objects in each of images(n) of scene S from set of frames 1100 relative to key subject plane KSP, which introduces a parallax disparity between images in the sequence to display multidimensional image sequence 1010 on display 628 to enable user U, in block or step 1250 to view multidimensional image sequence 1010 on display 628.

Moreover, in block or step 1250, computer system 10 via output application 624 may be configured to display multidimensional image sequence 1010 on display 628 for one more user system 720, 722, 724 via communications link 740 and/or network 750, or 5G computer systems 10 and application program(s) 624.

3D Stereo, in block or step 1250, computer system 10 via output application 624 may be configured to display multidimensional image 1010 on display 628. Multidimensional image 1010 may be displayed via left and right pixel 1102L/1103R light passes through lenticular lens 1540 and bends or refracts to provide 3D viewing of multidimensional image 1010 on display 628 to left eye LE and right eye RE a viewing distance VD from pixel 1550.

In block or step 1250, utilizing computer system 10, display 628, and application program(s) 624 settings to configure each images(n) (L&R segments) of scene S from set of frames 1100 of terrain T of scene S simultaneously with Key Subject aligned between images for binocular disparity for display/view/save multi-dimensional digital image(s) 1010 on display 628, wherein a difference in position of each images(n) of scene S from virtual cameras relative to key subject KS plane introduces a (left and right) binocular disparity to display a multidimensional digital image 1010 on display 628 to enable user U, in block or step 1250 to view multidimensional digital image on display 208.

Moreover, user U may elect to return to block or step 1220 to choose a new key subject KS in each source image, set of frames 1100 of terrain T of scene S and progress through steps 1220-1250 to view on display 628, via creation of a new or second sequential loop, multidimensional digital image sequence 1010 of scene S for new key subject KS.

Display 628 may include display device (e.g., viewing screen whether implemented on a smart phone, PDA, monitor, TV, tablet or other viewing device, capable of projecting information in a pixel format) or printer (e.g., consumer printer, store kiosk, special printer or other hard copy device) to print multidimensional digital master image on, for example, lenticular or other physical viewing material.

It is recognized herein that steps 1220-1240, may be performed by computer system 10 via image manipulation application 626 utilizing distinct and separately located computer systems 10, such as one or more user systems 720, 722, 724 and application program(s) 626 performing steps herein. For example, using an image processing system remote from image capture system, and from image viewing system, steps 1220-1240 may be performed remote from scene S via computer system 10 or server 760 and application program(s) 624 and communicating between user systems 720, 722, 724 and application program(s) 626 via communications link 740 and/or network 750, or via wireless network, such as 5G, computer systems 10 and application program(s) 626 via more user systems 720, 722, 724. Here, computer system 10 via image manipulation application 624 may manipulate 24 settings to configure each images(n) (L&R segments) of scene S from of scene S from virtual camera to generate multidimensional digital image sequence 1010 aligned to the key subject KS point and transmit for display multidimensional digital image/sequence 1010 to one or more user systems 720, 722, 724 via communications link 740 and/or network 750, or via wireless network, such as 5G computer systems 10 or server 760 and application program(s) 624.

Moreover, it is recognized herein that steps 1220-1240, may be performed by computer system 10 via image manipulation application 624 utilizing distinct and separately located computer systems 10 positioned on the vehicle. For example, using an image processing system remote from image capture system, steps 1220-1240 via computer system 10 and application program(s) 624 computer systems 10 may manipulate 24 settings to configure each images(n) (L&R segments) of scene S from of scene S from capture device(s) 830 to generate a multidimensional digital image/sequence 1010 aligned to the key subject KS point. Here, computer system 10 via image manipulation application 626 may utilize multidimensional image/sequence 1010 to navigate vehicle V through terrain T of scene S. Alternatively, computer system 10 via image manipulation application 626 may enable user U remote from vehicle V to utilize multidimensional image/sequence 1010 to navigate the vehicle V through terrain T of scene S.

It is contemplated herein that computer system 10 via output application 624 may be configured to enable display of multidimensional image sequence 1010 on display 628 to enable a plurality of user U, in block or step 1250 to view multidimensional image sequence 1010 on display 628 live or as a replay/rebroadcast.

It is recognized herein that step 1250, may be performed by computer system 10 via output application 624 utilizing distinct and separately located computer systems 10, such as one or more user systems 720, 722, 724 and application program(s) 624 performing steps herein. For example, using an output or image viewing system, remote from scene S via computer system 10 and application program(s) 624 and communicating between user systems 720, 722, 724 and application program(s) 626 via communications link 740 and/or network 750, or via wireless network, such as 5G, computer systems 10 and application program(s) 624 via more user systems 720, 722, 724. Here, computer system 10 output application 624 may receive manipulated plurality of two digital images of scene S and display multidimensional image/sequence 1010 to one more user systems 720, 722, 724 via communications link 740 and/or network 750, or via wireless network, such as 5G computer systems 10 and application program(s) 624.

Moreover, via communications link 740 and/or network 750, wireless, such as 5G second computer system 10 and application program(s) 624 may transmit sets of images(n) of scene S configured relative to key subject plane KSP as multidimensional image sequence 1010 on display 628 to enable a plurality of user U, in block or step 1250 to view multidimensional image/sequence 1010 on display 628 live or as a replay/rebroadcast.

Referring now to FIG. 13A, there is illustrated by way of example, and not limitation, touch screen display 628 enabling user U to select photography options of computer system 10. A first exemplary option may be DIFY capture wherein user U may specify or select digital image(s) speed setting 1302 where user U may increase or decrease play back speed or frames (images) per second of the sequential display of digital image(s) on display 628 multidimensional image/sequence 1010. Furthermore, user U may specify or select digital image(s) number of loops or repeats 1304 to set the number of loops of images(n) of the plurality of 2D image(s) 1000 of scene S where images(n) of the plurality of 2D image(s) 1000 of scene S are displayed in a sequential order on display 628, similar to FIG. 11. Still furthermore, user U may specify or select order of playback of digital image(s) sequences for playback or palindrome sequence 1306 to set the order of display of images(n) of the multidimensional image/sequence 1010 of scene S. The timed sequence showing of the images produces the appropriate binocular disparity through the motion pursuit ratio effect. It is contemplated herein that computer system 10 and application program(s) 624 may utilize default or automatic setting herein.

Referring now to FIGS. 13B, by way of example, and not limitation, there is illustrated a front view of a single camera device to capture a single RGB image. Smartphone device 702, configured to interface with the device's camera 704 for capturing a single RGB image and other hardware (see FIGS. 1 and 2).

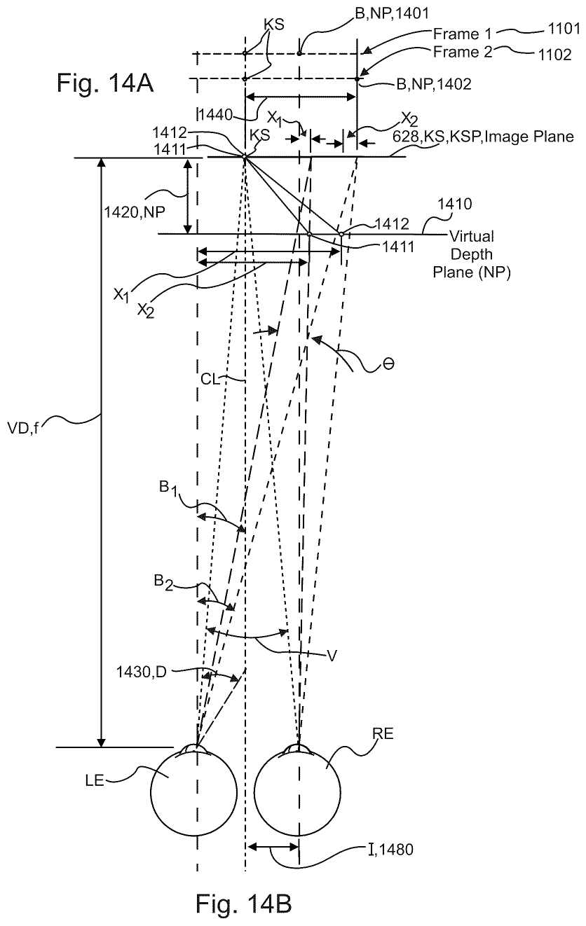

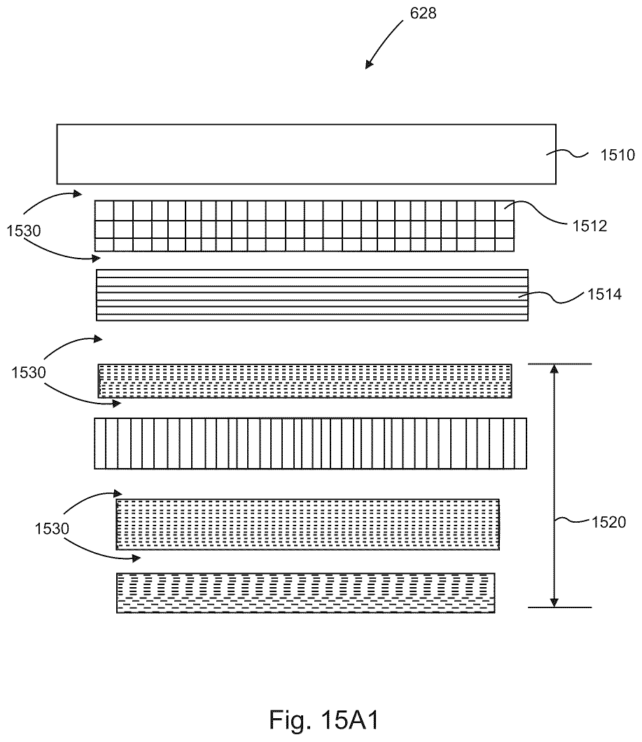

DIFY, referring to FIGS. 14A and 14B, there is illustrated by way of example, and not limitation, frames captured in a set sequence which are played back to the eye in a set sequence and a representation of what the human eyes perceives viewing the DIFY on display 628. Explanation of DIFY and its geometry to produce motion parallax. Motion parallax is the change in angle of a point relative to a stationary point. (Motion Pursuit). Note because we have set the key subject KS point all points in foreground will move to the right, while all points in the background will move to the left. The motion is reversed in a paledrone where the images reverse direction. The angular change of any point in different views relative to the key subject creates motion parallax.

A DIFY is a series of frames captured in a set sequence which are played back to the eye in the set sequence as a loop. For example, the play back of two frames (assume first and last frame, such as frame 1101 and 1104) is depicted in FIG. 14A. FIG. 14A represents the position of an object, such as a near plane NP object in FIG. 4 on the near plane NP and its relation to key subject KS point in frame 1101 and 1104 wherein key subject KS point is constant due to the image translation imposed on the frames, frame 1101, 1102, 1103 and 1104, series of digital image datasets 1100. Frames, frame 1101, 1102, 1103 and 1104 in FIGS. 11A and 11B may be overlapping and offset from the principal axis 1112 by a calculated parallax value, (horizontal image translation (HIT) and preset by the spacing of virtual camera. FIG. 14B there is illustrated by way of example, and not limitation what the human eye perceives from the viewing of the two frames (assume first and last frame, such as frame 1101 and 1104 having frame in near plane NP as point 1401 and frame 2 in near plane NP as point 1402) depicted in FIG. 14A on display 628 where image plane or screen plane is the same as key subject KS point and key subject plane KSP and user U viewing display 628 views virtual depth near plane NP 1410 in front of display 628 or between display 628 and user U eyes, left eye LE and right eye RE. Virtual depth near plane NP 1410 is near plane NP as it represents frame 1 in near plane NP as object in near plane point 1401 and frame 2 in near plane NP as object in near plane point 1402, the closest points user U eyes, left eye LE and right eye RE see when viewing multidimensional image sequence 1010 on display 628.

Virtual depth near plane NP 1410 simulates a visual depth between key subject KS and object in near plane point 1401 and object in near plane point 1402 as virtual depth 1420, depth between the near plane NP and key subject plane KSP. This depth is due to binocular disparity between the two views for the same point, object in near plane point 1401 and object in near plane point 1402. Object in near plane point 1401 and object in near plane point 1402 are preferably same point in scene S, at different views sequenced in time due to binocular disparity. Moreover, outer rays 1430 and more specifically user U eyes, left eye LE and right eye RE viewing angle 1440 is preferably approximately twenty-seven (27) degrees from the retinal or eye axis. (Similar to the depth of field for a cell phone or tablet utilizing display 628.) This depiction helps define the limits of the composition of scene S. Near plane point 1401 and near plane point 1402 preferably lie within the depth of field, outer rays 1430, and near plane NP has to be outside the inner cross over position 1450 of outer rays 1430.

The motion from X1 to X2 is the motion user U eyes, left eye LE and right eye RE will track. Xn is distance from eye lens, left eye LE or right eye RE to image point 1411, 1412 on virtual near image plane 1410. X′n is distance of leg formed from right triangle of Xn to from eye lens, left eye LE or right eye RE to image point 1411, 1412 on virtual near image plane 1410 to the image plane, 628, KS, KSP. The smooth motion is the binocular disparity caused by the offset relative to key subject KS at each of the points user U eyes, left eye LE and right eye RE observe.

For each eye, left eye LE or right eye RE, a coordinate system may be developed relative to the center of the eye CL and to the center of the intraocular spacing, half of interpupillary distance width IPD, 1440. Two angles β and α are the angles utilized to explain the DIFY motion pursuit. β is the angle formed when a line is passed from the eye lens, left eye LE and right eye RE, through the virtual near plane 1410 to the image on the image plane, 628, KS, KSP. Θ is β2−β1. While a is the angle from the fixed key subject KS of the two frames 1101, 1104 on the image plane 628, KS, KSP to the point 1411, 1412 on virtual near image plane 1410. The change in a represents the eye pursuit. Motion of the eyeball rotating, following the change in position of a point on the virtual near plane. While β is the angle responsible for smooth motion or binocular disparity when compared in the left and right eye. The outer ray 1430 emanating from the eye lens, left eye LE and right eye RE connecting to point 1440 represents the depth of field or edge of the image, half of the image. This line will change as the depth of field of the virtual camera changes.

$$\frac{di}{f} = Xi$$

If we define the pursuit motion as the difference in position of a point along the virtual near plane, then by utilizing the tangents we derive:

$$X 2 - X 1 = di / ( tan ∝ 1 - tan ∝ 2 )$$

These equations show us that the pursuit motion, X₂−X₁ is not a direct function of the viewing distance. As the viewing distance increases the perceived depth di will be smaller but because of the small angular difference the motion will remain approximately the same relative to the full width of the image.

Mathematically that the ratio of retinal motion over the rate of smooth eye pursuit determines depth relative to the fixation point in central human vision. The creation of the KSP provides the fixation point necessary to create the depth. Mathematically, then all points will move differently from any other point as the reference point is the same in all cases.

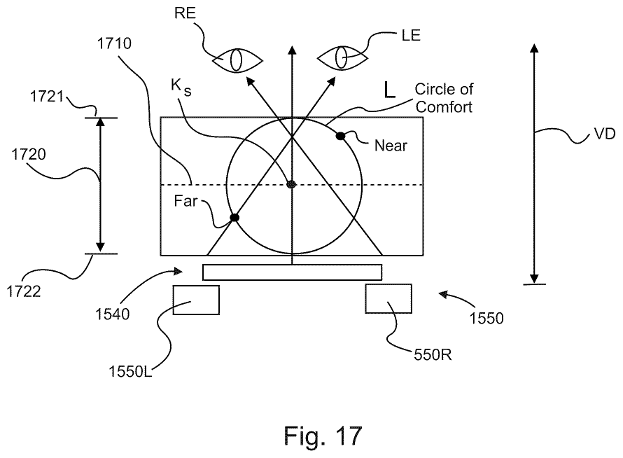

Referring now to FIG. 17, there is illustrated by way of example, and not limitation, a representative illustration of Circle of Comfort CoC fused with Horopter arc or points and Panum area. Horopter is the locus of points in space that have the same disparity as fixation, Horopter arc or points. Objects in the scene that fall proximate Horopter arc or points are sharp images and those outside (in front of or behind) Horopter arc or points are fuzzy or blurry. Panum is an area of space, Panum area 1720, surrounding the Horopter for a given degree of ocular convergence with inner limit 1721 and an outer limit 1722, within which different points projected on to the left and right eyes LE/RE result in binocular fusion, producing a sensation of visual depth, and points lying outside the area result in diplopia—double images. Moreover, fuse the images from the left and right eyes for objects that fall inside Panum's area, including proximate the Horopter, and user U will we see single clear images. Outside Panum's area, either in front or behind, user U will see double images.

It is recognized herein that computer system 10 via image capture application 624, image manipulation application 624, image display application 624 may be performed utilizing distinct and separately located computer systems 10, such as one or more user systems 220, 222, 224 and application program(s) 206. Next, via communications link 240 and/or network 250, wireless, such as 5G second computer system 10 and application program(s) 206 may transmit sets of images(n) of scene S relative to key subject plane introduces a (left and right) binocular disparity to display a multidimensional digital image on display 628 to enable a plurality of user U, in block or step 1250 to view multidimensional digital image on display 208 live or as a replay/rebroadcast.

Moreover, FIG. 17 illustrates display and viewing of multidimensional image 1010 on display 628 via left and right pixel 1550L/R light of multidimensional image 1010 passes through lenticular lens 1540 and bends or refracts to provide 3D viewing of multidimensional image 1010 on display 628 to left eye LE and right eye RE a viewing distance VD from pixel 1550 with near object, key subject KS, and far object within the Circle of Comfort CoC and Circle of Comfort CoC is proximate Horopter arc or points and within Panum area 1720 to enable sharp single image 3D viewing of multidimensional image 1010 on display 628 comfortable and compatible with human visual system of user U. 3D viewing of multidimensional image 1010 on display 628 includes refracting light through lenticular lenses to provide binocular disparity within a Panum area for comfortable 3D viewing.

With respect to the above description then, it is to be realized that the optimum dimensional relationships, to include variations in size, materials, shape, form, position, movement mechanisms, function and manner of operation, assembly and use, are intended to be encompassed by the present disclosure.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Moreover, the present disclosure has been described in detail, it should be understood that various changes, substitutions and alterations can be made thereto without departing from the spirit and scope of the disclosure as defined by the appended claims. Accordingly, the present disclosure is not limited to the specific embodiments illustrated herein but is limited only by the following claims.

1. A system for subsurface imaging and display of a subsurface below a surface, comprising:
a memory device storing instructions;
a processor in communication with said memory device, said processor configured to execute said instructions;
a subsurface image capture module in communication with said processor, said subsurface image capture module having one or more wave generating devices and one or more sensors affixed to a vehicle, configured to capture a series of digital image datasets of the subsurface below the surface, each said digital image dataset including coordinate reference data;
a Three Dimensional Generative Pre-trained Transformer (3DGPT) model configured to receive a single two-dimensional (2D) RGB image from said series of digital image datasets and generate a 3D depth map via monocular depth estimation, wherein said 3DGPT model comprises an encoder-decoder neural network trained on proprietary datasets including paired RGB images and ground truth depth maps with at least one of a key subject, a foreground, and a background element;
wherein said processor executes instructions to generate a digital model of said series of digital image datasets while maintaining said coordinate reference data, determine said 3D depth map of said digital model using said 3DGPT model, and identify a key subject point in said digital model; and
wherein said digital image datasets are selected from the group consisting of satellite, ground penetrating radar, LIDAR, topographical, hydrological, sinkhole susceptibility maps, USGS, USACE, and NOAA data and combinations thereof.

2. The system of claim 1, wherein said 3DGPT model is further configured to simulate at least one 3D image from said generated 3D depth map, compatible with a human visual system for glasses-free viewing.

3. The system of claim 1, wherein said proprietary datasets used for training said 3DGPT model having ground truth images featuring said key subject, said foreground, and said background elements to enhance accuracy in monocular depth estimation.

4. The system of claim 1, wherein said encoder-decoder neural network of said 3DGPT model employs a transformer architecture with self-attention mechanisms to process said single 2D RGB image and output said 3D depth map to infer depth disparities for said 3D depth map.

5. The system of claim 1, wherein said subsurface image capture module captures said series of digital image datasets using said one or more wave generating devices selected from a group consisting of seismic waves, ultrasound waves, radar waves, and combinations thereof.

6. The system of claim 1, wherein said processor executes instructions to align said series of digital image datasets based on said coordinate reference data to construct said digital model of the subsurface.

7. The system of claim 2, further comprising a display device in communication with said processor, configured to render a multidimensional digital image from said 3D depth map, reducing mismatches in vergence and accommodation in said human visual system.

8. The system of claim 7, wherein said display device utilizes a Micro Optical Material (MOM) layer integrated with said generated 3D depth map, said MOM layer comprising lenticular lenses and microstructures configured to produce parallax effects by refracting light from left and right pixels, enabling 3D viewing within a Circle of Comfort.

9. The system of claim 1, wherein said key subject point identified in said digital model corresponds to a subsurface anomaly resulting in a sinkhole.

10. The system of claim 1, wherein said 3DGPT model is evaluated using a combination of loss functions, including metrics of absolute relative error and root mean squared error.

11. A method for subsurface imaging and display of a subsurface below a surface, comprising:
capturing, via a subsurface image capture module affixed to a vehicle and including one or more wave generating devices and one or more sensors, a series of digital image datasets of the subsurface below the surface, each said digital image dataset including coordinate reference data;
receiving, by a Three Dimensional Generative Pre-trained Transformer (3DGPT) model, a single two-dimensional (2D) RGB image from said series of digital image datasets;
generating, by said 3DGPT model via monocular depth estimation, a 3D depth map, wherein said 3DGPT model comprises an encoder-decoder neural network trained on proprietary datasets including paired RGB images and ground truth depth maps with at least one of a key subject, a foreground, and a background element;
generating a digital model of said series of digital image datasets while maintaining said coordinate reference data;
determining said 3D depth map of said digital model using said 3DGPT model;
identifying a key subject point in said digital model; and
wherein said digital image datasets are selected from the group consisting of satellite, ground penetrating radar, LIDAR, topographical, hydrological, sinkhole susceptibility maps, USGS, USACE, and NOAA data and combinations thereof.

12. The method of claim 11, further comprising simulating a 3D image sequence from said generated 3D depth map using said 3DGPT model, for display compatible with a human visual system without specialized glasses.

13. The method of claim 11, wherein training said 3DGPT model on said proprietary datasets involves selecting architectures for accurate monocular depth estimation and incorporating ground truth images featuring said key subject, said foreground, and said background elements to enhance accuracy in monocular depth estimation.

14. The method of claim 11, wherein said encoder-decoder neural network of said 3DGPT model employs a transformer architecture with self-attention mechanisms to process said single 2D RGB image and output said 3D depth map to infer depth disparities for said 3D depth map.

15. The method of claim 11, wherein capturing said series of digital image datasets includes emitting waves from said one or more wave generating devices and detecting reflections via said one or more sensors, using said one or more wave generating devices selected from a group consisting of seismic waves, ultrasound waves, radar waves, and combinations thereof.

16. The method of claim 11, further comprising aligning said series of digital image datasets based on said coordinate reference data to construct said digital model of the subsurface.

17. The method of claim 12, further comprising displaying a multidimensional digital image derived from said 3D depth map on a display device, reducing mismatches in vergence and accommodation conflicts in said human visual system.

18. The method of claim 17, wherein displaying includes refracting light through a Micro Optical Material (MOM) layer integrated with said generated 3D depth map, said MOM layer comprising lenticular lenses and microstructures configured to produce parallax effects by refracting light from left and right pixels, enabling 3D viewing within a Circle of Comfort.

19. The method of claim 11, wherein identifying said key subject point includes detecting a subsurface anomaly resulting in sinkhole.

20. The method of claim 11, further comprising evaluating said 3DGPT model using a combination of loss functions, including metrics of absolute relative error and root mean squared error.

21. The system of claim 1, wherein said 3DGPT model is deployed on a distributed computing system to process large image datasets, optimizing for real-time subsurface imaging.

22. The method of claim 11, further comprising optimizing said 3DGPT model for deployment by acquiring processing power sufficient to handle large-scale proprietary datasets during monocular depth estimation.
